(19) United States
(12) Patent Application Publication
(10) Pub. No.: US 2021/0178329 A1
(43) Pub. Date: Jun. 17, 2021

(54) BATCH AND SEMI-BATCH MEMBRANE LIQUID SEPARATION USING A SWEEP STREAM

(71) Applicant: S.P. TEXTILE PROCESSORS PVT. LTD., Erode (IN)

(72) Inventor: Saravana Perumal SHANMUKHAM, Erode (IN)

(21) Appl. No.: 17/253,525

(22) PCT Filed: Jun. 18, 2019
(86) PCT No.: PCT/IN2019/050462

§ 371 Date: Dec. 17, 2020

(30) Foreign Application Priority Data
Jun. 18, 2018 (IN) 201841018716
Aug. 3, 2018 (IN) 201841029255

(51) Int. Cl. B01D 61/06; B01D 61/02; C02F 1/44; B01D 61/08

(52) U.S. Cl. CPC B01D 61/06; B01D 61/025; C02F 1/441; B01D 61/08; C02F 2301/046; B01D 2311/25; B01D 2313/246; C02F 2303/10; C02F 2301/08; B01D 2311/12

(57) ABSTRACT

Method and apparatus for batch and semi-batch operation of membrane system using a sweep stream with essentially repeating process flows is disclosed. The method and apparatus are used for separating a source liquid into its constituent solvents and solutes. The method includes circulating a feed stream and sweep stream in a feed side circulation loop and a sweep side circulation loop, respectively, in a counter-current, or co-current or cross-flow configuration. The pressure in the feed loop is gradually increased to initiate flow of solvent from the feed loop to the sweep loop. The concentrate and diluate streams obtained may be continuously removed. The applied feed loop pressure is continually increased until maximum desired operating pressure is reached or maximum concentration of a solute is reached in the feed solution. The method extends the maximum achievable salt concentration of RO process to at least about 300 g/L NaCl.

### CROSS-REFERENCES TO RELATED APPLICATIONS

This application claims benefit and priority to Indian Provisional Patent Application No. 201841018716, dated Jun. 18, 2018 and Indian Provisional Patent Application No. 201841029255, dated Aug. 3, 2018, the disclosures of which are incorporated herein by reference.

### FIELD OF THE INVENTION

The disclosure relates generally to water purification and in particular to operation of reverse osmosis type water purifier systems.

### DESCRIPTION OF THE RELATED ART

In a typical desalination setup using reverse osmosis (RO)-based purifiers there is a technical limitation of the maximum achievable salt concentration which is inherent to RO technology. This is estimated to be about 70 to 80 bar of osmotic pressure or about 55 grams per liter (g/L) of NaCl. Although research and development in RO technology to increase this upper limit for spiral modules is in progress, an efficient RO-based system operating at higher salt concentrations/osmotic pressure for separation of water and other solvents from their solutions has not been realized. There are specialised forms of RO such as a disc-type RO that may increase the range of maximum operating pressures to about 120 bar. However, operation of such specialized units is both energy intensive and requires specialised high pressure components. Despite such operation, there is still a limit of osmotic pressure of solutions practically separable by such systems. This still leaves gap in solution concentration range up to saturation. Presently separation in this concentration range is predominantly achieved by the use of thermal technologies. However, these processes have low efficiency and have high capital and operating expenditure.

The publication Lee et al. (Ethanol-Water Separation by Countercurrent Reverse Osmosis, Materials Science of Synthetic Membranes, 1985, 269: 19, P 409-428) describes a countercurrent reverse osmosis (CCRO) process for enriching ethanol by reverse osmosis using the high osmotic pressure of concentrated ethanol solutions. The osmotic pressure gradient across the membrane was reduced using a solution with intermediate concentration of ethanol on the permeate side at low ethanol concentrations.

U.S. Pat. No. 8,216,473 B2 is directed to a method for solution processing using a cascading reverse osmosis system with at least a solvent-generating RO unit, a concentrate-generating RO unit and an intermediate RO unit. A continuous steady state operation with various process flows is mentioned therein. However, typically RO system recoveries are limited by maximum desired operating pressure and precipitation of sparingly soluble salts. At high recoveries the tendency for precipitation by sparingly soluble salts is high. In continuous operation of RO at steady state, there is sufficient time for precipitation of these salts on the membrane. This adversely affects operation and equipment. Alternatively it may require additional pre-treatment steps. Further, continuous operation may lead to membrane compaction, and reduction in flux, lowering of equipment life, recovery and operational efficiency. There is therefore a continuing need for improved desalination systems and processes.

### SUMMARY OF THE INVENTION

The invention in its various embodiments includes a method, system and system array for pressure driven liquid separation.

In various aspects, a method for pressure-driven liquid separation is provided. The method includes the steps of receiving by a sweep reverse osmosis (SRO) system, a system level feed solution to a feed side of the SRO system and a system level sweep solution to a sweep side of the SRO system; receiving, by a semi-permeable membrane, a pass level feed solution from the system level feed solution to a first side of a semi-permeable membrane, wherein the pass level feed solution has a first osmotic pressure, receiving, by the semi-permeable membrane, a pass level sweep solution from the system level sweep solution to a second side of the semi-permeable membrane, wherein the pass level sweep solution has a second osmotic pressure; exerting, by a pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution, wherein the pressurizing unit includes at least one of an energy recovery device (ERD), a pressure pump, a booster pump, a piston, an hydraulic fluid and a pneumatic fluid, discharging, by the semipermeable membrane, a pass level concentrate solution from the first side of the semi-permeable membrane, on passing the permeate solution to the second side of the semipermeable membrane, wherein the discharged pass level concentrate solution acts as the pass level feed solution to any of its subsequent pass level feed solution until a system level concentrate solution is generated; discharging, by the semipermeable membrane, a pass level diluate solution from the second side of the semi-permeable membrane, on receiving the permeate solution from the first side of the semi permeable membrane, wherein the discharged pass level diluate solution acts as the pass level sweep solution to any of its subsequent pass level sweep solution until a system level diluate solution is generated; removing, by the SRO system, the system level concentrate solution and the system level diluate solution; and repeating by the SRO system steps (a-g) to continue with subsequent operation cycles.

In another aspect, the feed side solution flows across the first side of the semipermeable membrane and the sweep side solution flows across the second side of the semipermeable membrane are such that they are at least one of counter current, co-current and cross-current to each other. In another aspect, an energy recovery device (s) recovers energy exerted by the pressurizing unit. In another aspect, the method further comprises a circulation loop of the feed side solution flow and a circulation loop of the sweep side solution flow are hydraulically connected to transfer at least one of the feed side solution to the sweep side and the sweep side solution to the feed side to retain a desired solution composition. In another aspect, the method comprises adding an external process solution to at least one of the feed side solution and the sweep side solution, wherein the external solution comprises a system level feed and a system level sweep. In another aspect, the method comprises adding the external process solution to at least one of the feed side solution and the sweep side solution, wherein the external solution comprises the system level feed and the system level sweep.

In another aspect, the method includes receiving the system level feed solution to the feed side of the SRO system and the system level sweep solution to the sweep side of the SRO system by receiving, by at least one feed side tank, the system level feed solution and supplying the pass level feed solution to the first side of the semi-permeable membrane, wherein the at least one feed side tank is part of the feed side of the SRO system; and receiving by at least one sweep side tank, the system level sweep solution and supplying the pass level sweep solution to the second side of the semi-permeable membrane, wherein the at least one sweep side tank is part of the sweep side of the SRO system.

In one aspect, the method includes exerting pressure on the first side of the semipermeable membrane by: actuating a piston on a feed side solution that is hydraulically connected to the first side of the semipermeable membrane; applying pressure through a hydraulic fluid in a hydraulic chamber of the at least one feed tank with the feed side solution in a feed chamber of the feed tank, wherein the at least one feed tank comprises at least two chambers separated by at least one movable partition; actuating a piston on the feed side solution present in one of a chamber of the feed tank, wherein the feed tank comprises at least two chambers separated by at least one movable partition; applying pressure through a hydraulic fluid in direct hydraulic contact with the feed side solution in the at least one feed tank; applying pressure directly on the feed side solution by filling the at least one feed tank completely with the feed side solution; and applying pressure through the high-pressure pump, the ERD and the booster pump when using an unpressurized tank with at least one chamber and an unpressurized tank with at least one movable partition with at least two chambers.

In one aspect, the method includes receiving the system level feed solution to the feed side of the SRO system and the system level sweep solution to the sweep side of the SRO system, comprising: receiving a system level feed solution in at least one feed side holding chamber and supplying a pass level feed solution from the at least one feed side holding chamber to a feed side circulation loop; receiving a system level sweep solution in at least one sweep side holding chamber and supplying pass level sweep solution from the at least one sweep side holding chamber to a sweep side circulation loop; exerting, by the pressurizing unit, a pressure on the pass level feed solution on first side of the semipermeable membrane such that, the permeate solution from the pass level feed solution passes from the first side of the semipermeable membrane to the second side of the semipermeable membrane, wherein the permeate solution has a different osmotic pressure than the pass level feed solution; discharging, by the semipermeable membrane, the pass level concentrate solution from the first side of the semi-permeable membrane, on passing the permeate solution to the second side of the semipermeable membrane, wherein the discharged pass level concentrate solution acts as the pass level feed solution to the subsequent pass level feed until the system level concentrate solution is generated; discharging, by the semipermeable membrane, the pass level diluate solution from second side of the semi-permeable membrane, on receiving the permeate solution from the first side of the semi permeable membrane, wherein the discharged pass level diluate solution acts as the pass level sweep solution to the subsequent pass level sweep until the system level diluate solution is generated; adding an external process solution to the feed side circulation loop and removing a diluate solution from the sweep side circulation loop to maintain a required pressure in the feed side circulation loop and the sweep side circulation loop; supplying the system level feed solution to the at least one feed side holding chamber for a next operation cycle while simultaneously displacing the system level concentrate solution of a previous operation cycle from the at least one feed holding chamber to an external sink; supplying the system level sweep solution to the at least one sweep side holding chamber for the next operation cycle while simultaneously displacing the system level diluate solution of the previous operation cycle from the at least one sweep side holding chamber to the external sink; initiating a solution change over sequence on a feed side circulation loop by hydraulically connecting at least one feed side holding chamber and the feed side circulation loop, when the pass level concentration solution in the feed side circulation loop reaches concentration of the system level concentrate solution; transporting the system level concentrate solution from the feed side circulation loop into the at least one feed side holding chamber thereby displacing the system level feed solution from the at least one feed side holding chamber to the circulation loop, while achieving separation in a SRO unit during the entire solution change over sequence, wherein the SRO unit includes the semipermeable membrane; hydraulically disconnecting the at least one feed side holding chamber from the feed side circulation loop and initiating a next semi batch process; initiating a solution change over sequence on the sweep side circulation loop by hydraulically connecting the at least one sweep side holding chamber and the sweep side circulation loop, when the pass level diluate solution in the sweep side circulation loop reaches concentration of the system level diluate solution; transporting the system level diluate solution from the sweep side circulation loop into the at least one sweep side holding chamber thereby displacing the system level sweep solution from the at least one sweep side holding chamber to the circulation loop, while achieving separation in the SRO unit during the entire solution change over sequence; and hydraulically disconnecting the at least one sweep side holding chamber from the sweep side circulation loop and initiating the next semi batch process.

In one aspect, the method includes receiving the system level feed solution to the feed side of the SRO system and the system level sweep solution to the sweep side of the SRO system comprising: receiving by at least one feed side tank the system level feed solution and supplying the pass level feed solution to the first side of the semi-permeable membrane, wherein the at least one feed side tank is part of the feed side of the SRO system; receiving a system level sweep solution in at least one sweep side holding chamber and supplying pass level sweep solution from the at least one sweep side holding chamber to the sweep side circulation loop; exerting, by a pressurizing unit, a pressure on the pass level feed solution on the first side of the semipermeable membrane such that, the permeate solution from the pass level feed solution passes from the first side of the semipermeable membrane to the second side of the semipermeable membrane, wherein the permeate solution has a different osmotic pressure than the pass level feed solution; discharging, by the semipermeable membrane, a pass level concentrate solution from the first side of the semi-permeable membrane, on passing the permeate solution to the second side of the semipermeable membrane, wherein the discharged pass level concentrate solution acts as the pass level feed solution in a subsequent pass until a system level concentrate solution is generated; discharging, by the semipermeable membrane, a pass level diluate solution from second side of the semi-permeable membrane, on receiving the permeate solution from the first side of the semi permeable membrane, wherein the discharged pass level diluate solution acts as the pass level sweep solution in a subsequent pass until a system level diluate solution is generated; removing diluate solution from the sweep side circulation loop to maintain a required pressure in the feed side circulation loop and the sweep side circulation loop; supplying the system level sweep solution to the at least one sweep side holding chamber for the next operation cycle while simultaneously displacing the system level diluate solution of the previous operation cycle from the at least one sweep side holding chamber to the external sink; initiating a solution change over sequence on the sweep side circulation loop by hydraulically connecting the at least one sweep side holding chamber and the sweep side circulation loop, when the pass level diluate solution in the sweep side circulation loop reaches concentration of the system level diluate solution; transporting the system level diluate solution from the sweep side circulation loop into the at least one sweep side holding chamber thereby displacing the system level sweep solution from the at least one sweep side holding chamber to the circulation loop, while achieving separation in the SRO unit during the entire solution change over sequence; and hydraulically disconnecting the at least one sweep side holding chamber from the sweep side circulation loop and initiating a next semi batch process.

In one aspect, the method includes receiving the system level feed solution to the feed side of the SRO system and the system level sweep solution to the sweep side of the SRO system comprising: receiving the system level feed solution in the at least one feed side holding chamber and supplying pass level feed solution from the at least one feed side holding chamber to the feed side circulation loop; receiving by at least one sweep tank the system level sweep solution and supplying the pass level sweep solution to the second side of semi-permeable membrane, wherein the at least one sweep tank is part of the sweep side of the SRO system; exerting a pressure on the pass level feed solution on first side of the semipermeable membrane such that, the permeate solution from the pass level feed solution passes from the first side of the semipermeable membrane to the second side of the semipermeable membrane, wherein the permeate solution has a different osmotic pressure than the pass level feed solution; discharging the pass level concentrate solution from the first side of the semi-permeable membrane on passing the permeate solution to the second side of the semipermeable membrane, wherein the discharged pass level concentrate solution acts as the pass level feed solution in a subsequent pass until the system level concentrate solution is generated; discharging the pass level diluate solution from second side of the semi-permeable membrane on receiving the permeate solution from the first side of the semi permeable membrane, wherein the discharged pass level diluate solution acts as the pass level sweep solution in a subsequent pass until the system level diluate solution is generated; adding an external process solution to the feed side circulation loop to maintain a required pressure in the feed side circulation loop; supplying the system level feed solution to the at least one feed side holding chamber for the next operation cycle while simultaneously displacing the system level concentrate solution of a previous operation cycle from the at least one holding chamber to an external sink; initiating a solution change over sequence on the feed side circulation loop by hydraulically connecting at least one feed side holding chamber and the feed side circulation loop, when the pass level concentrate solution in the feed side circulation loop reaches concentration of the system level concentrate solution; transporting the system level concentrate solution from the feed side circulation loop into the at least one feed side holding chamber thereby displacing the system level feed solution from the at least one feed side holding tank to the feed side circulation loop, while achieving separation in the SRO unit during the entire solution change over sequence; and hydraulically disconnecting the at least one feed side holding chamber from the feed side circulation loop and initiating the next semi batch process.

In one aspect, the method includes receiving the system level feed solution to the feed side of the SRO system and the system level sweep solution to the sweep side of the SRO system comprising: receiving by at least one feed tank the system level feed solution and supplying the pass level feed solution to the first side of semi-permeable membrane, wherein the at least one feed tank is part of the feed side of the SRO system; receiving a system level sweep solution from an external source and supplying the pass level sweep solution to the sweep side circulation loop; exerting, by a pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution; discharging, by the semipermeable membrane, a pass level concentrate solution from the first side of the semi-permeable membrane on passing the permeate solution to the second side of the semipermeable membrane, wherein the discharged pass level concentrate solution acts as the pass level feed solution to any of its subsequent pass level feed until a system level concentrate solution is generated; discharging, by the semipermeable membrane, a pass level diluate solution from second side of the semi-permeable membrane on receiving the permeate solution from the first side of the semi permeable membrane, wherein the discharged pass level diluate solution acts as the pass level sweep solution to any of its subsequent pass level sweep until a system level diluate solution is generated; and discharging a portion of the pass level diluate as the system level diluate to an external sink.

In one aspect, the method includes receiving the system level feed solution to the feed side of the SRO system and the system level sweep solution to the sweep side of the SRO system comprising: receiving the system level feed solution from the external source and supplying the pass level feed solution to the feed side circulation loop; receiving by at least one sweep tank the system level sweep solution and supplying the pass level sweep solution to the second side of semi-permeable membrane, wherein the at least one sweep tank is part of the sweep side of the SRO system; exerting a pressure on the pass level feed solution on first side of the semipermeable membrane such that, the permeate solution from the pass level feed solution passes from the first side of the semipermeable membrane to the second side of the semipermeable membrane, wherein the permeate solution has a different osmotic pressure than the pass level feed solution; discharging the pass level concentrate solution from the first side of the semi-permeable membrane on passing the permeate solution to the second side of the semipermeable membrane, wherein the discharged pass level concentrate solution acts as the pass level feed solution in a subsequent pass until the system level concentrate solution is generated; discharging the pass level diluate solution from second side of the semi-permeable membrane on receiving the permeate solution from the first side of the semi permeable membrane, wherein the discharged pass level diluate solution acts as the pass level sweep solution in a subsequent pass until the system level diluate solution is generated; and discharging a portion of the pass level concentrate as the system level concentrate to the external sink.

In one aspect, the method includes receiving the system level feed solution to the feed side of the SRO system and the system level sweep solution to the sweep side of the SRO system comprising: receiving a system level feed solution in at least one feed side holding chamber and supplying the pass level feed solution from the holding chamber to a feed side circulation loop; receiving a system level sweep solution from the external source and supplying the pass level sweep solution to the sweep side circulation loop; exerting, by a pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution; discharging, by the semipermeable membrane, a pass level concentrate solution from the first side of the semi-permeable membrane on passing the permeate solution to the second side of the semipermeable membrane, wherein the discharged pass level concentrate solution acts as the pass level feed solution in a subsequent pass until a system level concentrate solution is generated; discharging, by the semipermeable membrane, a pass level diluate solution from second side of the semi-permeable membrane on receiving the permeate solution from the first side of the semi permeable membrane, wherein the discharged pass level diluate solution acts as the pass level sweep solution in a subsequent pass until a system level diluate solution is generated; adding an external process solution to the feed side circulation loop to maintain a required pressure in the feed side circulation loop and discharging a portion of the pass level diluate as the system level diluate to an external sink; supplying the system level feed solution to the feed side holding chamber for a next operation cycle while simultaneously displacing the system level concentrate solution of a previous operation cycle from the holding chamber to the external sink; initiating the solution change over sequence on feed side circulation loop by hydraulically connecting at least one feed side holding chamber and the feed side circulation loop, when the pass level concentration solution in the feed side circulation loop reaches concentration of the system level concentrate solution; transporting the system level concentrate solution from the feed side circulation loop into the feed side holding chamber thereby displacing the system level feed solution from the holding chamber to the circulation loop, while achieving separation in the SRO unit during the entire solution change over sequence; hydraulically disconnecting the holding chamber from the feed side circulation loop and initiating a next semi batch process; and discharging a portion of the pass level diluate solution as the system level diluate to an external sink.

In one aspect, the method includes receiving the system level feed solution to the feed side of the SRO system and the system level sweep solution to the sweep side of the SRO system comprising receiving the system level feed solution from the external source and supplying the pass level feed solution to the feed side circulation loop; receiving a system level sweep solution in at least one sweep side holding chamber and supplying the pass level sweep solution from the holding chamber to the sweep side circulation loop; exerting, by a pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution; discharging, by the semipermeable membrane, a pass level concentrate solution from the first side of the semi-permeable membrane on passing the permeate solution to the second side of the semipermeable membrane, wherein the discharged pass level concentrate solution acts as the pass level feed solution in a subsequent pass until a system level concentrate solution is generated; discharging, by the semipermeable membrane, a pass level diluate solution from second side of the semi-permeable membrane on receiving the permeate solution from the first side of the semi permeable membrane, wherein the discharged pass level diluate solution acts as the pass level sweep solution in a subsequent pass until a system level diluate solution is generated; discharging a portion of the pass level concentrate as the system level concentrate to the external sink and removing diluate solution from the sweep side circulation loop to maintain a required pressure in the feed side circulation loop and the sweep side circulation loop; supplying the system level sweep solution to the sweep side holding chamber for the next operation cycle while simultaneously displacing the system level diluate solution of the previous operation cycle from the sweep side holding chamber to the external sink; initiating a solution change over sequence on sweep side circulation loop by hydraulically connecting at least one sweep side holding chamber and the sweep side circulation loop, when the pass level diluate solution in the sweep side circulation loop reaches concentration of the system level diluate solution; transporting the system level diluate solution from the sweep side circulation loop into the sweep side holding chamber thereby displacing the system level sweep solution from the holding chamber to the circulation loop, while achieving separation in the SRO unit during the entire solution change over sequence; and hydraulically disconnecting the holding chamber from the sweep side circulation loop and initiating a next semi batch process.

In one aspect, the method includes supplying a stage level concentrate solution from a first separation stage as a stage level sweep solution to a second separation stage, wherein each of the separation stage comprises the SRO system, wherein the feed side and the sweep side of the SRO system is operated by at least one of at least one tank, at least one holding chamber, an external source and an external sink; supplying a stage level sweep solution to the first separation stage from an external source and discharging the stage level diluate solution from the first separation stage to an external sink, wherein each of the separation stage comprises the SRO system, wherein the feed side and the sweep side of the SRO system is operated by at least one of at least one tank, at least one holding chamber, an external source and an external sink; supplying a stage level diluate solution from the second separation stage as a stage level feed solution to the first separation stage; supplying a stage level concentrate solution from the second separation stage as a stage level sweep solution to the third separation stage; supplying a stage level diluate solution from the third separation as a stage level feed solution to the second separation stage; and repeating the steps (a-e) till nth separation stage, wherein the stage level feed solution to the nth separation stage is supplied from an external source and stage level concentrate solution from the nth separation stage is discharged to the external sink. In one aspect, the first separation stage, second separation stage, third separation stage to nth separation stage are arranged in an array. In another aspect, a plurality of separation stages arranged in the array such that the process solution is transported from one side of the semi permeable membrane to another side of the semi permeable membrane through a direct hydraulic connection or through a residual solution carryover. In yet another aspect, the method comprises: adding process solution from an external source to a separation stage other than the first and nth separation stage or removing the stage level process solution from the separation stage other than the first or the nth stage to the external sink. In yet another aspect, the method further comprises adding process solution from an external source to a separation stage other than the first and the nth separation stage or removing the stage level process solution from the separation stage other than the first or the nth separation stage to the external sink.

In one aspect, the method comprises: receiving by the first separation stage the stage level diluate from the second separation stage and receiving a process solution from an external source by the first separation stage, wherein each of the separation stage comprises the at least one SRO system; combining by the first separation stage the stage level diluate from the second separation stage and the process solution from the external source and used as a stage level feed and the stage level sweep for the first separation stage; discharging the stage level diluate from the first separation stage to an external sink and stage level concentrate from the first separation stage to the second separation stage; receiving by the second separation stage the stage level diluate from the third separation stage and the stage level concentrate from the first separation stage; combining by the second separation stage the stage level diluate from the third separation stage and the stage level concentrate from the first separation stage and used as a stage level feed and the stage level sweep for the second separation stage; discharging stage level concentrate and stage level diluate from the second separation stage; receiving by the third separation stage a stage level concentrate solution of the second separation stage and stage level diluate solution from the fourth separation stage and combining and supplying as a stage level feed and stage level sweep for the third separation stage; and discharging stage level concentrate and stage level diluate from the third separation stage; repeating the steps (a-h), till the nth separation stage, wherein receiving stage level concentrate from n−1 stage and process solution from the external source; combining the stage level concentrate from the n−1^{th} separation stage and the process solution from the external source, and supplied as a stage level feed and stage level sweep for the nth separation stage; and discharging stage level concentrate from the nth separation stage to an external sink and discharging the stage level diluate from the nth separation stage to the n−1 separation stage. In another aspect, the first separation stage, second separation stage, third separation stage to nth separation stage are arranged in an array. In another aspect, the method comprises: adding process solution from the external source to a separation stage other than the first stage or removing the stage level process solution from the separation stage other than the first or the nth separation stage to the external sink. In another aspect, the method comprises: supplying a stage level concentrate solution from a first separation stage as a stage level feed solution to a second separation stage, wherein each of the separation stage comprises the at least one SRO system; supplying a stage level feed solution to the first separation stage from an external source and discharging the stage level diluate solution from the first separation stage to an external sink, wherein each of the separation stage comprises at least one SRO system, wherein the feed side and the sweep side of the SRO system is operated by one of at least one tank, at least one holding chamber, an external source and an external sink; supplying a stage level diluate solution from the second separation stage as a stage level sweep solution to the first separation stage; supplying a stage level concentrate solution from the second separation stage as a stage level feed solution to the third separation stage; supplying a stage level diluate solution from the third separation as a stage level sweep solution to the second separation stage; and repeating the steps (a-e) till nth separation stage, wherein the stage level concentrate solution from the n−1 separation stage supplied as stage level feed solution to the nth separation stage and either a portion of the feed solution to the nth separation stage or a portion of the concentrate solution from the nth separation stage or both supplied as stage level sweep to the nth separation stage; further a portion of the concentrate from the nth separation stage is discharged to an external sink and the stage level diluate from the nth separation stage is supplied as stage level sweep to n−1 separation stage. In another aspect, the first separation stage, second separation stage, third separation stage to nth separation stage are arranged in an array. In another aspect, a plurality of separation stages arranged in the array such that the process solution is transported from one side of the semi permeable membrane to another side of the semi permeable membrane through a direct hydraulic connection or through a residual solution carryover. In another aspect, the method comprises: adding process solution from an external source to a separation stage other than the first stage or removing the stage level process solution from the separation stage other than the first or the nth stage to the external sink. In another aspect, the method comprises: adding process solution from an external source to a separation stage other than the first stage or removing the stage level process solution from the separation stage other than the first or the nth stage to the external sink.

In various aspects, a sweep reverse osmosis (SRO) system for pressure-driven liquid separation is included. The SRO system comprises: a feed side and a sweep side configured to: receive a system level feed solution to a feed side of the SRO system and a system level sweep solution to a sweep side of the SRO system; a semi-permeable membrane configured to: receive a pass level feed solution from the system level feed to a first side of the semi-permeable membrane, wherein the pass level feed has a first osmotic pressure; and receive a pass level sweep solution from the system level sweep to a second side of the semi-permeable membrane, wherein the pass level sweep has a second osmotic pressure; a pressurizing unit configured to: exert a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution, wherein the pressurizing unit includes at least one of an energy recovery device (ERD), a pressure pump and a booster pump; the semi-permeable membrane unit configured to: discharge a pass level concentrate solution from the first side of the semi-permeable membrane on passing the permeate solution to the second side of the semipermeable membrane, wherein the discharged pass level concentrate solution acts as the pass level feed solution to any of its subsequent pass level feed until a system level concentrate solution is generated; discharge a pass level diluate solution from second side of the semi-permeable membrane on receiving the permeate solution from the first side of the semi permeable membrane, wherein the discharged pass level diluate solution acts as the pass level sweep solution to any of its subsequent pass level sweep until a system level diluate solution is generated; a feed side circulation pump and a sweep side circulation pump configured to: remove the system level concentrate solution and the system level diluate solution; and the SRO system configured to: repeat steps (a-f) to continue with subsequent operation cycles.

In one aspect, the system further comprises at least one feed tank at and at least one sweep tank configured to: receive the system level feed solution, to store process solution, to supply the pass level feed solution to the first side of the semipermeable membrane to collect pass level concentrate solution from the first side of the semipermeable and to collect the sweep side solution from the second side of the semi permeable membrane; and receive the system level sweep solution, to store process solution, to supply the pass level sweep solution to the f second side of the semipermeable membrane to collect pass level diluate solution from the second side of the semipermeable and to collect the feed side solution from the first side of the semi permeable membrane.

In one aspect, the feed side unit comprises at least one holding chamber, configured to: receive the system level feed solution, to store process solution, to supply the pass level feed solution to the first side of the semipermeable membrane to collect pass level concentrate solution from the first side of the semipermeable and to collect the sweep side solution from the second side of the semi permeable membrane.

In one aspect, the system further comprises: at least one feed side holding chamber hydraulically connected to first side of the semipermeable membrane, configured to: establish intermittent hydraulic communication with the first side of the semi permeable membrane for exchanging process solution with a feed side circulation loop; receive system level feed solution from an external source; and discharge the system level concentrate solution to an external sink; at least one sweep side holding chamber hydraulically connected to the second side of the semipermeable membrane, configured to: establish intermittent hydraulic communication with second side of the semipermeable membrane for exchanging process solution with sweep side circulation loop; receive system level sweep solution from an external source; and discharge the system level diluate solution to an external sink.

In one aspect, the system includes a hydraulic connection to at least one external source containing a process solution supplying to at least one feed side holding chamber, a feed side circulation loop, at least one sweep side holding chamber and a sweep side circulation loop.

In one aspect, the system includes at least one feed side tank hydraulically connected to the first side of the semipermeable configured to: receive the system level feed side solution, to store the process solution, to supply the pass level feed side solution to the first side of the semi permeable membrane, to collect the pass level concentrate solution from the first side of the semi permeable membrane, to collect pass level sweep side solution and to collect pass level diluate solution; at least one sweep side tank hydraulically connected to the second side semi permeable membrane configured to: receive the system level sweep side solution, to store the process solution, to supply the pass level sweep side solution to the second side of the semi permeable membrane, to collect pass level diluate solution from the second side of the semi permeable membrane, to collect the feed side solution and to collect pass level concentrate solution; at least one external source configured to supply a process solution to the at least one feed side tank, at least one sweep side tank.

In one aspect, the system includes at least one feed side tank and the at least one sweep side tank comprises at least one of: an unpressurized tank; a piston pressurized tank; a piston pressurized tank with at least two chambers separated by at least one movable partition; an indirect hydraulically pressurized tank with at least two chambers separated by at least one movable partition; a direct hydraulically pressurized tank; a direct feed pressurized tank; and an unpressurized tank with at least two chambers separated by at least one movable partition.

In one aspect, the system includes at least one feed side tank hydraulically connected to the first side of the semi permeable membrane configured to: receive the system level feed side solution, to store the process solution, to supply the pass level feed side solution to the first side of the semi permeable membrane, to collect the pass level concentrate solution from the first side of the semi permeable membrane, to collect pass level sweep side solution and to collect pass level diluate solution; at least one sweep side holding chamber hydraulically connected to the second side of the semi permeable membrane configured to: establish intermittent hydraulic communication with second side of the semipermeable membrane for exchanging process solution with sweep side circulation loop; receive system level sweep solution from an external source; discharge the system level diluate solution to an external sink; and at least one external source configured to supply a process solution to the at least one feed side tank, the feed side circulation loop, at least one sweep side holding chamber and sweep side circulation loop.

In one aspect, the system includes at least one feed side holding chamber hydraulically connected to first side of the semipermeable membrane, configured to: establish intermittent hydraulic communication with the first side of the semi permeable membrane for exchanging process solution with a feed side circulation loop; receive system level feed solution from an external source; and discharge the system level concentrate solution to an external sink; at least one sweep side tank hydraulically connected to the second side semi permeable membrane configured to: receive the system level sweep side solution, to store the process solution, to supply the pass level sweep side solution to the second side of the semi permeable membrane, to collect pass level diluate solution from the second side of the semi permeable membrane, to collect the pass level feed side solution and to collect pass level concentrate solution; at least one external source configured to supply the process solution to the at least one feed side holding chamber, the feed side circulation loop and the at least one sweep side tank.

In one aspect, the system includes at least one feed side tank hydraulically connected to the first side of the semi permeable membrane configured to: receive the system level feed side solution, to store the process solution, to supply the pass level feed side solution to the first side of the semi permeable membrane, to collect the pass level concentrate solution from the first side of the semi permeable membrane, to collect pass level sweep side solution and to collect pass level diluate solution; at least one external source hydraulically connected to the second side of the semi permeable membrane configured to, supply system level sweep solution; at least one external sink hydraulically connected to the second side of the semi permeable membrane configured to, remove the system level diluate solution; and at least one external source configured to, supply the process solution to the at least one feed side tank and the sweep side circulation loop.

In one aspect, the system includes at least one external source hydraulically connected to the first side of the semi permeable membrane configured for, supplying the system level feed solution; at least one external sink hydraulically connected to first side of the semi permeable membrane configured for, removing the system level concentrate solution; at least one sweep side tank hydraulically connected to the second side semi permeable membrane configured to: receive the system level sweep side solution, to store the process solution, to supply the pass level sweep side solution to the second side of the semi permeable membrane, to collect pass level diluate solution from the second side of the semi permeable membrane, to collect the feed side solution and to collect pass level concentrate solution; and at least one external source configured to supply the process solution to the feed side circulation loop and the at least one sweep side tank.

In one aspect, the system includes at least one feed side holding chamber hydraulically connected to the first side of the semipermeable membrane, configured to: establish intermittent hydraulic communication with the first side of the semi permeable membrane for exchanging process solution with a feed side circulation loop; receive system level feed solution from an external source; and discharge the system level concentrate solution to an external sink.

In one aspect, the system includes at least one external source hydraulically connected to the second side of the semipermeable membrane for supplying system level sweep solution; at least one external sink hydraulically connected to the second side of the semipermeable membrane for removing system level diluate solution; and at least one external source configured to supply the process solution to the at least one feed side holding chamber, the feed side circulation loop and the sweep side circulation loop.

In one aspect, the system includes at least one external source hydraulically connected to the first side of the semipermeable membrane for supplying system level feed solution; at least one external sink hydraulically connected to the first side of the semipermeable membrane for removing system level concentrate solution; at least one sweep side holding chamber hydraulically connected to the second side of the semi permeable membrane configured to: establish intermittent hydraulic communication with second side of the semipermeable membrane for exchanging process solution with sweep side circulation loop; receive system level sweep solution from an external source; discharge the system level diluate solution to an external sink; and at least one external source configured to supply the process solution to the feed side circulation loop, the at least one sweep side holding chamber and the sweep side circulation loop.

In one aspect, the unpressurized tank with the at least two chambers separated by the at least one movable partition, configured to: supply from one of the at least two chambers the least one of the pass level feed and the pass level sweep to the first side of the semipermeable membrane and the second side of the semipermeable membrane respectively; and collect at least one of the pass level concentrate and the pass level diluate solution from the first side of the semipermeable membrane and the second side of the semipermeable membrane respectively in one of the at least two chambers.

In one aspect, the piston pressurized tank with at least two chambers separated by the at least one movable partition, configured to: supply form one of the at least two chamber the pass level feed solution to the first side of the semi permeable membrane; and collect the pass level concentrate solution from the first side of the semi permeable membrane in one of the a at least two chambers.

In one aspect, the indirect hydraulically pressurized tank with the at least two chambers separated by the at least one movable partition, configured to: supply form one of the at least two chamber the pass level feed solution to the first side of the semi permeable membrane; and collect the pass level concentrate solution from the first side of the semi permeable membrane in one of the a at least two chambers.

In various aspects, a system for pressured driven separation is includes. The system comprises a plurality of SRO systems. The system is configured to: supply a stage level concentrate solution from a first separation stage as a stage level sweep solution to a second separation stage, wherein the stage level concentrate solution is an output of at least one SRO system of the plurality of SRO system, wherein each of the separation stage comprises at least one SRO system of the plurality of the SRO systems; supply a stage level sweep solution to the first separation stage from an external source and discharging the stage level diluate solution from the first separation stage to an external sink, wherein the stage level sweep solution is an output of the at least one SRO system of the plurality of SRO system, wherein a feed side and a sweep side of the at least one SRO system is operated by at least one of at least one tank, at least one holding chamber, an external source and an external sink; supply a stage level diluate solution from the second separation stage as a stage level feed solution to the first separation stage; supply a stage level concentrate solution from the second separation stage as a stage level sweep solution to the third separation stage; supply a stage level diluate solution from the third separation as a stage level feed solution to the second separation stage; and repeat the steps (a-e) till nth separation stage, wherein the stage level feed solution to the nth separation stage is supplied from an external source and stage level concentrate solution from the nth separation stage is discharged to the external sink.

In one aspect, the system includes a first separation stage, second separation stage, third separation stage to nth separation stage arranged in an array. In one aspect, at least one SRO system of the plurality of SRO system configured to: transport the process solution from a first side of a semi permeable membrane to a second side of the semi permeable membrane through a direct hydraulic connection or through a residual solution carryover.

In one aspect, the system is further configured to: adding process solution from an external source to a separation stage other than the first and nth separation stage or removing the stage level process solution from the separation stage other than the first or the nth stage to the external sink.

In one aspect, at least one SRO system of the plurality of SRO system is further configured to: add process solution from an external source to a separation stage other than the first and the nth separation stage or removing the stage level process solution from the separation stage other than the first or the nth separation stage to the external sink.

In one aspect, the system is further configured to: receive by the first separation stage the stage level diluate from the second separation stage and receiving a process solution from an external source by the first separation stage; combine by the first separation stage the stage level diluate from the second separation stage and the process solution from the external source and used as a stage level feed and the stage level sweep for the first separation stage; discharge the stage level diluate from the first separation stage to an external sink and stage level concentrate from the first separation stage to the second separation stage; receive by the second separation stage the stage level diluate from the third separation stage and the stage level concentrate from the first separation stage; combine by the second separation stage, the stage level diluate from the third separation stage and the stage level concentrate from the first separation stage and used as a stage level feed and the stage level sweep for the second separation stage; discharge stage level concentrate and stage level diluate from the second separation stage; receive by the third separation stage a stage level concentrate solution from the second separation stage and a stage level diluate solution from the fourth separation stage; combine by the third separation stage, the stage level concentrate solution from the second separation stage and the stage level diluate solution from the fourth separation stage and used as a stage level feed and stage level sweep for the third separation stage; discharge stage level concentrate and stage level diluate from the third separation stage; repeat the steps (a-i), till the nth separation stage, wherein receiving stage level concentrate from n−1 stage and process solution from the external source; combine the stage level concentrate from the n−1^{th} separation stage and the process solution from the external source, and supplied as a stage level feed and stage level sweep for the nth separation stage; and discharge stage level concentrate from the nth separation stage to an external sink and discharging the stage level diluate from the nth separation stage to the n−1 separation stage. In another aspect, the first separation stage, second separation stage, third separation stage to nth separation stage are arranged in an array.

In another aspect, the system is further configured to: adding process solution from the external source to a separation stage other than the first stage or removing the stage level process solution from the separation stage other than the first or the nth separation stage to the external sink. In another aspect, the system includes at least one accumulator configured to store the stage level process solution and supply the stage level process solution.

In another aspect, the system is further configured to: supply a stage level concentrate solution from a first separation stage as a stage level feed solution to a second separation stage; supply a stage level feed solution to the first separation stage from an external source and discharging the stage level diluate solution from the first separation stage to an external sink, wherein each of the separation stage comprises at least one SRO system, wherein the feed side and the sweep side of the SRO system is operated by one of at least one tank, at least one holding chamber, an external source and an external sink; supply a stage level diluate solution from the second separation stage as a stage level sweep solution to the first separation stage; supply a stage level concentrate solution from the second separation stage as a stage level feed solution to the third separation stage; supply a stage level diluate solution from the third separation as a stage level sweep solution to the second separation stage; and repeat the steps (a-e) till nth separation stage, wherein the stage level concentrate solution from the n−1 separation stage supplied as stage level feed solution to the nth separation stage and either a portion of the feed solution to the nth separation stage or a portion of the concentrate solution from the nth separation stage or both supplied as stage level sweep to the nth separation stage; further a portion of the concentrate from the nth separation stage is discharged to an external sink and the stage level diluate from the nth separation stage is supplied as stage level sweep to n−1 separation stage.

In another aspect, the first separation stage, second separation stage, third separation stage to nth separation stage are arranged in an array. In another aspect, at least one SRO system of the plurality of SRO system configured to transport the process solution from one side of the semi permeable membrane to another side of the semi permeable membrane through a direct hydraulic connection or through a residual solution carryover. In another aspect, the system is further configured to perform operations comprising: adding process solution from an external source to a separation stage other than the first stage or removing the stage level process solution from the separation stage other than the first or the nth stage to the external sink.

In another aspect, the system is further configured to perform operations comprising: adding process solution from an external source to a separation stage other than the first stage or removing the stage level process solution from the separation stage other than the first or the nth stage to the external sink.

In another aspect, the system further comprises at least one accumulator configured to: store the stage level process solution and supply the stage level process solution. In another aspect, at least one holding chamber and the at least one tank is shared between any of the separation stages.

### BRIEF DESCRIPTION OF THE DRAWINGS

The invention has other advantages and features which will be more readily apparent from the following detailed description of the invention and the appended claims, when taken in conjunction with the accompanying drawings, in which

FIG. 1A illustrates the sweep reverse osmosis (SRO) unit used for batch and semi-batch operation with counter current flow arrangement.

FIG. 1B illustrates the SRO unit symbol used for batch and semi-batch operation with counter current flow arrangement.

FIG. 1C shows the batch and semi-batch operation of the SRO system with a counter-current setup.

FIG. 1D shows unpressurised tank.

FIG. 1E shows the unpressurized closed tank.

FIG. 1F shows the piston pressurized tank.

FIG. 1G shows the indirect hydraulically and pneumatically pressurized tank.

FIG. 1H illustrates the indirect hydraulically and piston pressurized feed tank.

FIG. 1I shows the direct hydraulically pressurized tank.

FIG. 1J shows the direct feed pressurized tank.

FIG. 1K shows the indirect pressurized tank.

FIG. 1L shows a generalized representation for all pressurized tanks used in all embodiments.

FIG. 1M shows the unpressurized tank with at least two chambers.

FIG. 1N shows the indirect pressurized tank with at least two chambers.

FIG. 2A illustrates the batch and semi-batch operation of SRO system with a counter-current setup and feed tank in feed loop.

FIG. 2B illustrates the batch and semi-batch operation of SRO system with a counter-current setup, a feed tank in feed loop and an unpressurised sweep tank in sweep loop.

FIG. 2C shows the batch and semi-batch operation of SRO system with a counter-current setup and pressurized feed tank in feed loop.

FIG. 2D shows the batch and semi-batch operation of SRO system with a counter-current setup, a pressurized feed tank in feed loop and an unpressurized sweep tank in sweep loop.

FIG. 3A shows the multiple unpressurised feed tank with multiple sweep tanks.

FIG. 3B shows the multiple piston pressurized feed tank with multiple unpressurized sweep tanks.

FIG. 3C illustrates multiple indirect hydraulically and piston pressurized feed tanks with multiple unpressurized sweep tanks.

FIG. 3D illustrates direct hydraulically pressurized feed tank with unpressurized sweep tanks.

FIG. 3E illustrates indirect hydraulically pressurized feed tank with unpressurized sweep tanks.

FIG. 3F illustrates the multiple direct feed pressurized feed tank with multiple sweep tanks.

FIG. 3G illustrates the sweep reverse osmosis system with a counter-current setup and holding chambers in feed and sweep loops.

FIG. 3H illustrates the sweep reverse osmosis system with holding chambers operated with bleed streams transferred from high pressure zone to low pressure zone via pressure reducing valve (PRV).

FIG. 3I illustrates the sweep reverse osmosis system with holding chambers operated with bleed streams exchanged between high pressure zone and low pressure zone via energy recovery device (ERD).

FIG. 4A illustrates a SRO system with a counter-current setup having unpressurized feed tank(s) in feed loop and holding chamber(s) in sweep loops.

FIG. 4B illustrated a SRO system with a counter-current setup, pressurised feed tank(s) in feed loop and holding chamber(s) in sweep loop.

FIG. 4C illustrates SRO with holding chamber(s) in feed loop and tank(s) in sweep loop.

FIG. 4D shows SRO with holding chambers(s) in feed loop and external source or external sink in the sweep loop.

FIG. 4E shows SRO with external source or external sink in feed loop and holding chamber(s) in sweep loop.

FIG. 4F shows the SRO with external source or external sink in feed loop and sweep tank in the sweep loop.

FIG. 5A illustrates the batch and semi-batch method of operating SRO system in a cascading array.

FIG. 5B illustrate the batch or semi-batch method of operating SRO system in a serial array.

FIG. 6A shows the symbolization of all types of SRO systems used in arrays embodiments operated with separate feed and sweep input streams.

FIG. 6B illustrates the symbolization of all types of SRO systems used in arrays embodiments operated with common feed and sweep input streams.

FIG. 6C illustrates cascading array of SRO systems representing embodiment with internally isolated and externally isolated/connected internal loops and embodiment with internally interconnected and externally isolated/connected internal loops.

FIG. 6D shows the cascading array of SRO systems representing embodiment with internally interconnected and externally isolated internal loops and embodiment with internally interconnected and externally connected internal loops.

FIG. 6E shows the cascading array of SRO systems with holding chambers representing embodiment with internally interconnected and externally isolated/connected internal loops and embodiment with internally interconnected and externally isolated/connected internal loops.

FIG. 6F illustrates the symbol for all externally isolated SRO arrays that include all SRO arrays that have their internal loops isolated from each other and isolated from external connections and all SRO arrays that have their internal loops connected to each other but isolated from external connections.

FIG. 6G illustrates the symbol for all externally connected SRO arrays that include all SRO arrays that has its internal loops isolated from each other and connected to external connections, all SRO arrays that have their internal loops connected to each other and connected to external connections.

FIG. 6H shows exemplary coupling for all externally isolated SRO arrays that symbolizes coupling of SRO arrays with other systems that has its internal loops isolated from external connections.

FIG. 6I illustrates exemplary coupling for all externally connected SRO arrays that symbolizes coupling of SRO arrays with other systems that has its internal loops connected to external connections.

FIG. 6J illustrates serial array of SRO systems arranged serially and operated with separate feed side and sweep side process solutions further operated as embodiment with internally isolated and externally isolated or internally isolated and externally connected internal loops and embodiment with internally connected and externally isolated or internally connected and externally connected internal loops.

FIG. 6K illustrates serial array of SRO systems with holding chambers operated with separate feed side and sweep side process solutions further operated as embodiment with internally isolated and externally isolated or internally isolated and externally connected internal loops and embodiment with internally connected and externally isolated or internally connected and externally connected internal loops.

FIG. 7A illustrates batch operation of osmotically assisted reverse osmosis system performed in Example 2.

FIG. 7B shows schematic illustration of cascading multi-staged osmotically assisted separation of sodium chloride solution without bleed streams performed in Example 3 and operated with different feed side and sweep side solutions.

FIG. 7C shows schematic illustration of cascading multi-staged osmotically assisted separation of sodium chloride solution with bleed streams performed in Example 4 and operated with common feed side and sweep side solutions.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

As referred to herein, SRO refers to a sweep reverse osmosis. Although reverse osmosis membranes are emphasized here, alternate membrane technologies with pressure driven separation of solutes from solution may be used. More specifically solute solution systems referred here exhibit osmotic pressure corresponding to solute concentration in solution. Further following abbreviations in the embodiments below have the meaning as given, RO—reverse osmosis, NF—nanofiltration, UF—ultrafiltration, MF—microfiltration, SRO—sweep reverse osmosis unit (it implies the use of any membrane including but not limited to RO, NF, UF, MF), CP—circulation pump; HPP—High pressure pump; BP—Booster pump; PRV—Pressure reducing valve; PX—pressure exchanger, ERD—energy recovery device; HPI—high pressure inlet to PX or ERD; HPO—high pressure outlet from PX or ERD; LPI—low pressure inlet to PX or ERD; LPO—low pressure outlet from PX or ERD. Since PX is a subset of ERD, ERD is predominantly used in following description. HPP may be used in combination with ERD and BP. HPP pressurizes make up solution to the system feed pressure. While BP makes up for irreversibilities in energy recovered by ERD and remaining system components, such as the pressure drop caused by circulation through membrane modules and piping.

It should be understood by a skilled artisan that a co-current, cross-current or counter-current flow is applicable for all the embodiments described herein.

Definitions and general preamble for the invention: In the following description the terms defined have the described meaning. A semi-permeable membrane that performs the separation in all embodiments may be considered as the core system component responsible for separation. It has a first and a second side. It is contained in an SRO unit comprising a feed side and a sweep side corresponding to first side and second side of the semi-permeable membrane respectively. Feed side solution defined below circulates on the feed side while sweep side solution defined below circulates on the sweep side of SRO unit and system. A SRO system comprises of SRO unit, feed side components which may contain process solution in contact with feed side of SRO unit and first side of semi-permeable membrane and sweep side components which may contain process solution in contact with sweep side of SRO unit and second side of semi-permeable membrane. Feed side components include feed tanks, feed side holding chambers, feed circulation pump and interconnecting conduits on feed side among other components that include control valves, instruments etc. Sweep side components include, sweep tanks, sweep side holding chambers, sweep circulation pump and interconnecting conduits on sweep side among other components that include control valves, instruments etc. The solutions on feed side and sweep side that undergoes separation at the SRO unit 100 is collectively referred as process solution. Feed side solution is defined as that portion of process solution in the SRO system 1000 that is contained within feed side components of SRO system 1000 and from which permeate solution is removed. Sweep side solution is defined as that portion of process solution in the SRO system 1000 that is contained within sweep side components of SRO system 1000 and to which permeate solution is added. In the art it is conventional to refer to a flowing solution as a stream.

In this invention, the term solution may be used to refer to solution that is stored as well as that is flowing. As such solution may also be used in place of stream. First or feed side circulation loop may be defined as comprising the part of feed side solution that is flowing through the SRO unit 100, is hydraulically continuous and is in hydraulic contact with first side 104-1 of SRO membrane 104 at a given time. Second or sweep side circulation loop may be defined as comprising the part of sweep side solution that is flowing through the SRO unit 100, is hydraulically continuous and is in hydraulic contact with second side 104-2 of SRO membrane 104 at a given time. The circulation loops are connected to at least one of supply tank, receive tank, holding chamber, external source, external sink among other components. Separation is performed by the semi-permeable membrane 104 contained in SRO unit 100 on solutions in the feed side and sweep side circulation loops. The SRO unit consists of at least one inlet connection 1.1 and at least one outlet connection 1.2 providing hydraulic communication to the first side 104-1 of semi-permeable membrane 104 and to feed side 100-1 of SRO unit 100. The SRO unit further consists of at least one inlet connection 2.1 and at least one outlet connection 2.2 providing hydraulic communication to the second side 104-2 of semi-permeable membrane 104 and to sweep side 100-2 of SRO unit 100. Batch and semi-batch separation processes described in all embodiments of this invention are achieved through multiple passes of solution through the SRO unit 100.

A term operation cycle is used to imply a separation process with multiple passes. This includes, bath, semi-batch and continuous process. A pass is defined as flow of solution through the SRO unit 100 once. For a given volume of solution, one pass starts when solution from that volume first enters the SRO unit and that pass ends when solution from that volume last exits from the SRO unit 100. The portion of feed side circulation loop entering the first inlet 1.1 of SRO unit 100 may be defined as pass level feed solution or feed stream having a first or feed concentration and a first or feed osmotic pressure while the portion of feed side circulation loop emerging from first outlet 1.2 of SRO unit 100 may be defined as pass level concentrate solution or concentrate stream having concentrate concentration and concentrate osmotic pressure. The part of sweep side circulation loop entering the second inlet 2.1 of SRO unit 100 may be defined as pass level sweep solution or sweep stream having a second or sweep concentration and a second or sweep osmotic pressure while the portion of sweep side circulation loop emerging from second outlet 2.2 of SRO unit 100 may be defined as pass level diluate stream having diluate concentration and diluate osmotic pressure.

Feed solution, concentrate solution, sweep solution and diluate solution are associated with the SRO unit 100 and the SRO system 1000. Prefix terms pass level or system level or stage level or array level may be used to differentiate between these associations. Pass level feed solution, pass level sweep solution, pass level concentrate solution and pass level diluate solution correspond to the respective streams at the pass level that are added to or removed from the SRO unit 100. System level feed solution, system level sweep solution, system level concentrate solution and system level diluate solution correspond to the respective streams at the system level that are added to or removed from the SRO system 1000. Stage level feed solution, stage level sweep solution, stage level concentrate solution and stage level diluate solution correspond to the respective streams at the stage level that are added to or removed from SRO separation stages. Array level feed solution, array level sweep solution, array level concentrate solution and array level diluate solution correspond to the respective streams at the array level that are added to or removed from SRO arrays. At the system the system level feed solution and system level sweep solution are processed in passes by the SRO systems described in this invention to produce system level concentrate solution and system level diluate solution. Permeate solution permeates through the SRO membrane from the feed side to the sweep side. Permeate solution is composed of solvent(s) and solute(s) the exact composition of which is determined by operating conditions, solvent-solute system and selectivity of the membrane towards solute(s) and solvent(s). The permeate solution has a third chemical composition and a third osmotic pressure which is different from the first chemical composition and first osmotic pressure corresponding to pass level feed solution. Bleed stream refers to the parts of the hydraulic circuit of SRO system 1000 that connects feed side circulation loop and sweep side circulation loop, permitting process solution transfer between them. Typical bleed streams used in this invention are,
(a) Feed bleed stream that originates from pass level feed solution entering the first inlet of SRO unit 100 and transfers pass level feed solution from feed side to sweep side of SRO unit 100.
(b) Concentrate bleed stream that originates from the pass level concentrate solution released from the first outlet of SRO unit 100 and transfers pass level concentrate solution from feed side to sweep side of SRO unit 100.
(c) Sweep bleed stream that originates from the pass level sweep solution entering the second inlet of SRO unit 100 and transfers pass level sweep solution from sweep side to feed side of SRO unit 100.
(d) Diluate bleed stream that originates from the pass level diluate solution released from the second outlet of SRO unit and transfers pass level diluate solution from sweep side to feed side of SRO unit 100.

Further, the bleed streams may remove solution from any point in a source circulation loop and when transferring to the other circulation loop may add solution to any point in a receiving circulation loop. In other words, process solution at any concentration between minimum and maximum values in a circulation loop may be removed and transferred to and mixed with process solution in the receiving circulation loop at any concentration between minimum and maximum values in that receiving circulation loop. In various system embodiments, preferred bleed stream removal and addition are shown to occur hydraulically adjacent to connections of SRO unit 100. For instance feed bleed stream is removed immediately before first inlet 1.1 of SRO unit 100 such that there is no other addition or removal occurring to feed stream between the point of removal and first inlet 1.1 and/or there is no change in concentration of feed stream after bleed stream removal. Essentially concentration of feed bleed stream removed and feed stream entering first inlet 1.1 of SRO unit 100 are same. Likewise, concentrate, diluate and sweep bleed streams are removed immediately after first outlet 1.2, after second outlet 2.2 and before second inlet 2.1 respectively of SRO unit 100. In addition system level concentrate and system level diluate streams are also removed from the system using bleed streams. Alternatively the SRO system 1000 may be operated without bleed streams whereby there is no exchange of process solution between feed and sweep sides. The invention in its various embodiments relates to systems and methods to stage the sweep reverse osmosis units in arrays to achieve large separation duties.

During separation process permeate solution permeates through the membrane from the feed side to sweep side. As a result, quantity of concentrate is less than the corresponding quantity of feed stream while quantity of diluate is greater than the corresponding quantity of sweep stream. The change in concentration or osmotic pressure in solutions on either side depends on the selectivity of the membrane. Selectivity of the membrane for transferring a unit may be defined by the following equation well known in prior art,

$$S = 1 - \frac{{C}_{P}}{{C}_{F}}$$

where, S is membrane selectivity towards the solute, C_{P} is concentration of solute in the permeate solution and C_{F} is the concentration of solute in the feed solution. Membrane used in this invention exhibit selectivity values in the range 1≥S>0>S. This range is explained as follows. When the membrane does not allow passage of solutes or solution components of interest to any extent such that C_{P}=0, the membrane exhibits complete rejection of solution components of interest, then selectivity becomes S=1. When the membrane permits passage of solutes or solution components of interest such that C_{P}<C_{F}, the membrane exhibits partial rejection of solution components of interest then selectivity becomes 1>S>0. When the membrane permits passage of solutes or solution components of interest such that C_{P}>C_{F}, the membrane exhibits negative rejection of solution components of interest then selectivity becomes S<0. The concept of selectivity is further explained for an exemplary solution of NaCl in water as follows. For a simple sodium chloride in water process solution, semi-permeable membranes used for desalination typically possess a positive value of salt rejection, where salt concentration in the permeate solution is lower than that in feed solution. If the SRO membrane has such a selectivity, then concentration and osmotic pressure of the concentrate stream shall be greater than the feed stream. On the other hand there are other semi-permeable membranes which exhibit negative salt rejection whereby salt concentration in the permeate solution is greater than that in feed solution. If SRO membrane has such a selectivity, then concentration and osmotic pressure of concentrate stream shall be lower than the feed stream. In either scenario as long as permeate solution flows from feed side solution to sweep side solution, quantity of feed side solution decreases by the amount of permeate solution while quantity of sweep side solution increases by the amount of permeate solution. This holds true for all cases of membrane selectivity for this invention. The semi-permeable through which the permeate solution passes could be any physical barrier capable of any degree of separation of solute from the solvent under consideration. This includes positive or negative rejection of solutes and complete or partial rejection of solutes. Examples of this includes reverse osmosis membranes, loose or leaky reverse osmosis membranes, nano-filtration membranes, ultra-filtration membranes, micro-filtration membranes, oxidized graphene frameworks and any membrane with rejection characteristic mentioned above.

For embodiments using tanks, supply tank refers to the fluid reservoir from where a solution entering the SRO unit 100 originates. Likewise, receiving tank refers to the fluid reservoir where a solution released from SRO unit is collected. The feed side solution originates from a feed side supply tank and is collected in a feed side receiving tank. The sweep side solution originates from a sweep side supply tank and is collected in a sweep side receiving tank. A tank may operate as a supply tank in one pass and the same tank may operate as a receiving tank in a subsequent pass. Alternatively the same tank may operate as a supply and a receiving tank in the same pass. When the supply tanks and receiving tanks for a pass is the same, the process is said to operate in re-circulation mode. When the supply tanks and receiving tanks for a pass are different, the process is said to operate in non-recirculation mode. When using tanks with multiple chambers a pass may be operated between the chambers in a similar method wherein supply chambers and receiving chambers supply to and receive from the SRO unit respectively, the pass level process solution. Holding chambers used in some embodiments refer to temporary solution storage devices hydraulically connected to the feed side and/or sweep side of SRO unit 100 intermittently. For these embodiments, volume of process solution in feed side and sweep side circulation loops are fixed. One pass for these embodiments may be defined as transporting this entire volume of process solution in the circulation loop once from inlet to outlet on a given side across a semi-permeable membrane. This definition of pass also applies to embodiments operating with external source and external sink of process solution with re-circulation from outlet to inlet on a given side of SRO unit 100. External source refers to external source of process solution that supplies process solution to a system while external sink refers to external sink of process solution that receives process solution discharges from the system.

Energy recovery device (ERD) 501 is a device with a broader meaning of recovering energy from a high energy fluid stream such as the membrane reject stream into a low energy fluid stream such as incoming feed stream. ERD 501 may be used interchangeably with pressure exchanger PX which is a preferred ERD in all of the embodiments. The chemical composition of feed, concentrate, sweep and diluate streams may be precisely defined by the mole fractions of solute(s) and solvent(s). As a result of certain or all solute solvent interactions in a given solution, the solution exhibits osmotic pressure. The osmotic pressure of solutions may change as a result of separation achieved in the SRO unit 100. This change in osmotic pressure may be used to specify separation duty performed by SRO unit 100. For the purposes of this disclosure, a separation is considered performed when the feed side and/or the sweep side solution experiences a change in at least one of osmotic pressure or chemical composition as a result of permeate solution flow through semi-permeable membrane in the SRO unit 100. Change in chemical composition includes change in concentration of any chemical entity such as ions, molecules, colloids, suspended solids, polymers and other macromolecules. In summary process solution may comprise of multiple solvents, solutes and chemical entities mentioned above, all of them might be collectively referred as solution components.

Separation process implies any part or duration of the process where separation is performed by an SRO unit 100. A term separation duty shall be used to imply a separation process wherein final solutions having defined chemical compositions and/or possessing defined osmotic pressures are obtained from initial solutions having defined chemical compositions and/or possessing defined osmotic pressures fed to that separation process. The final solutions could be pass level or system level or stage level concentrate solution and pass level or system level or stage level diluate solution while the initial solutions could be pass level or system level or stage level feed solution and pass level or system level or stage level sweep solution. Pass level separation duty defines the concentrations and quantities of concentrate solution and diluate solution produced in that pass corresponding to concentrations and quantities of initial solutions fed to that pass. System level separation duty defines the concentrations and quantities of system level solutions produced from that system corresponding to concentrations and quantities of system level solutions fed to that system. Array level separation duty defines the concentrations and quantities of array level solutions produced from that array corresponding to concentrations and quantities of array level solutions fed to that array.

The embodiments disclosed in this invention operate in batch or semi-batch mode through multiple passes through the SRO physical unit 100. In each pass through the SRO module, separation duty is performed which may be referred to as pass level separation duty. Aggregation of pass level separation duties from multiple passes results in system level separation duty. Aggregation of system level separation duties results in stage level separation duty. Aggregation of stage level separation duties results in array level separation duty. In certain embodiments, system level and stage level separation duties may be equal.

An integral working feature of batch and semi-batch mode of operation of embodiments in this invention is the replacement of a solution in feed and sweep side circulation loops with another solution at different concentration while simultaneously achieving separation in the SRO unit 100. For instance such operation is performed in embodiments with tanks between passes when the supply tank or receiving tank is changed followed by replacement of solution in the corresponding hydraulic circuit and in embodiments with holding chambers during solution changeover sequence where solution in a feed side or sweep side circulation loop is replaced by solution in the respective holding chambers. Further important feature is that the hydraulic design of system components is such that mixing between solutions at different concentration is avoided or minimized during solution replacement.

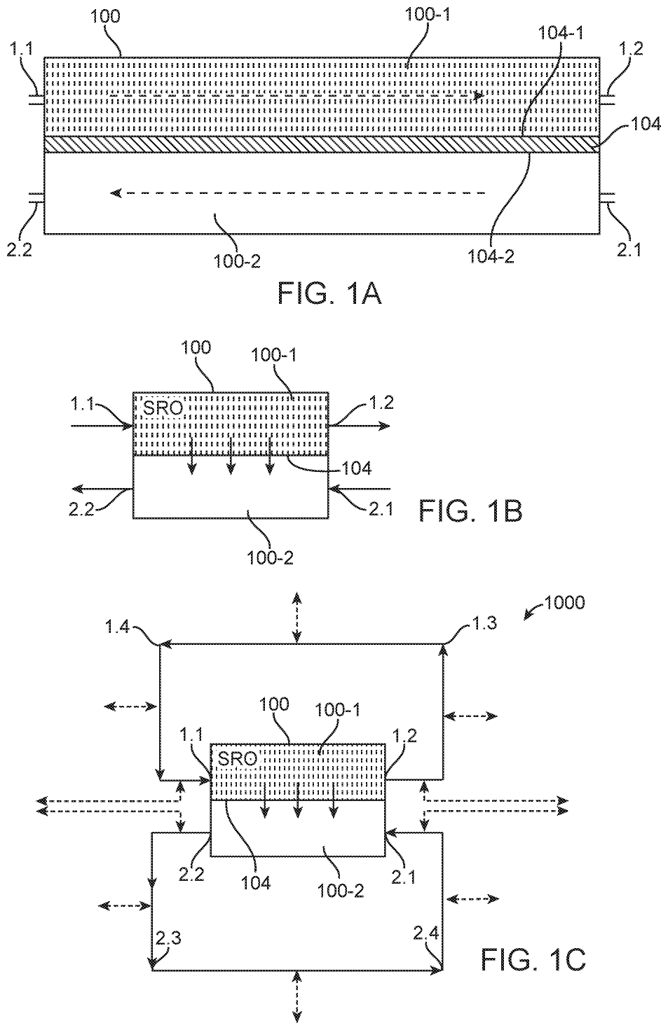

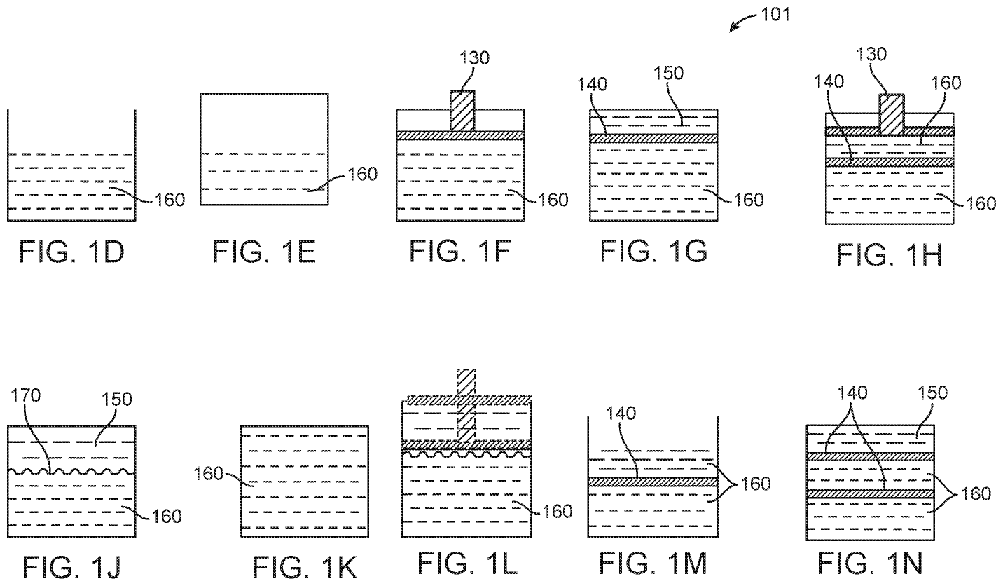

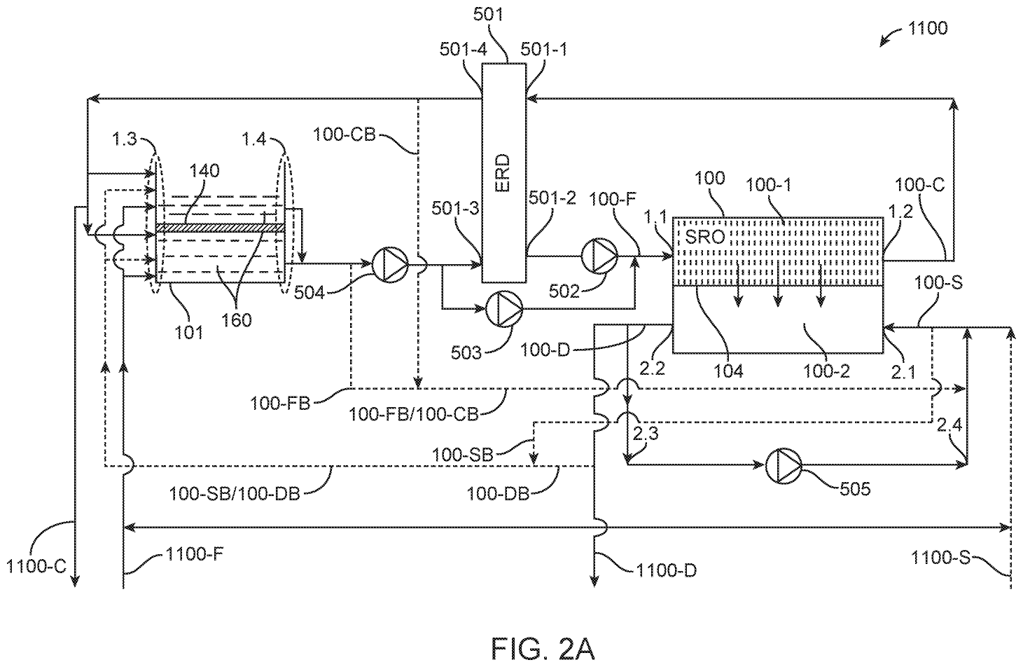

The invention in its various embodiments proposes a pressure-driven liquid sweep reverse osmosis (SRO) system 1000 that includes one or more SRO units 100 as illustrated in FIG. 1C. The SRO unit 100 as shown in FIG. 1A includes a feed side 100-1 and sweep side 100-2 separated by a semi-permeable membrane barrier 104. Membrane 104 is capable of selectively permeating solution components that contribute towards osmotic pressure of process solution. The membrane may be configured to pass the solvent alone or solution of solvent(s) with solute(s) from the first side to the second side of the SRO unit 100. Its selective permeation during operation results in change of concentration of solution components responsible for osmotic pressure of process solution thereby changing osmotic pressures of feed side and sweep side solutions. FIG. 1B represents the SRO unit 100 as used in subsequent embodiments. In an SRO system 1000, the SRO unit 100 is connected to other components such as tanks and pumps to perform separation. Feed side 100-1 of SRO unit 100 is supplied with feed stream via inlet 1.1 and releases concentrate stream via outlet 1.2. The feed side solution comes into hydraulic contact with feed side of membrane 104-1. Sweep side 100-2 of SRO unit 100 is supplied with sweep stream via inlet 2.1 and releases diluate stream via outlet 2.2. The sweep side solution comes into hydraulic contact with sweep side of membrane 104-2. Counter-current flow is illustrated for the SRO unit 100 in FIGS. 1A, 1B, 1C and in all following embodiments. Alternatively, the system 1000 may be set up for a co-current, cross-current or any other flow arrangement by changing the inlet and outlet connections and/or their relative orientation to each other.

FIG. 1C represents operation of SRO unit 100 described in FIG. 1B in an SRO system 1000. The system includes a first or feed side circulation loop (1.1-1.2-1.3-1.4-1.1) and a second or sweep side circulation loop (2.1-2.2-2.3-2.4) as illustrated in FIG. 1C. The first or feed side circulation loop includes at least one first inlet (1.1) of the SRO unit 100 that receives the feed stream having a first solute concentration, at least one first outlet (1.2) of the SRO unit 100 that is configured to release a volume of concentrate stream.

The feed side circulation loop is in hydraulic contact with the feed side of the membrane 104-1 as illustrated in FIG. 1A. This hydraulic circuit may change hydraulic connections with system components such as tanks 101/110, holding chamber 601/602, external feed source/concentrate sink 1100-F/1100-S.

In some embodiments the hydraulic circuit is closed and the system operates in re-circulation mode. The feed may originate from a tank flow through the SRO module 100 and flow back to the same tank. Another instance is during a semi-batch process in SRO systems 1000 without feed side tanks, when concentrate stream from second outlet 1.2 is re-circulated as feed stream to first inlet 1.1 in a closed hydraulic circuit. In some embodiments the hydraulic loop is not a closed circuit and the system operates in once through without re-circulation mode. The feed may originate from one tank, flow through the SRO module 100 and flow to another tank. Another instance is when the feed solution is fed from an external feed stream source and returned to an external feed stream sink.

The sweep side circulation loop is in hydraulic contact with the sweep side of the membrane 104-2 as explained earlier and illustrated in FIG. 1A. This circuit may change hydraulic connections with system components such as tanks, holding chamber, accumulators, external sweep source/diluate sink, or feed loop during operation.

In some embodiments the hydraulic loop is a closed circuit and the system operates in re-circulation mode. The sweep may originate from one tank, flow through the SRO module 100 and flow back to the same tank. Another instance is during a semi-batch process in SRO systems 1000 without sweep side tanks, when diluate stream from second outlet 2.2 is re-circulated as sweep stream to second inlet 2.1 in a closed hydraulic circuit. In some embodiments the hydraulic loop is not a closed circuit and the system operates in once through without re-circulation mode. The sweep may originate from one sweep side tank, flow through the SRO module 100 and flow to another tank. Another instance is when the sweep solution is fed from an external sweep stream source and returned to an external sweep stream sink.

The feed loop and sweep loop may receive external streams, may have streams removed at any stage and/or may be interconnected to each other and/or may be connected to volume accumulators such as tanks or holding chambers or accumulators.

Further part of feed and/or concentrate stream from feed side solution and sweep and/or diluate stream from sweep side solution may be removed as bleed streams. Fundamentally these bleed streams transfer process solution from one side of the SRO unit 100 to the other and may also be used for removing solutions from the SRO system 1000 when the predetermined separation duty is achieved.

For SRO system 1000 operated using one or more tanks 101, different types of tanks may be used. The types of tanks 101 used are shown in FIG. 1D-1N. In these embodiments the feed tank may be pressurized by a variety of means. These include the following,
a. Unpressurized tank (FIG. 1D-1E)—These tanks are not pressurized. Fluid pressure in these tanks is equilibrated with ambient or surrounding pressure. When used in SRO systems 1000 the process solution 160 is stored at ambient pressure. The tank may be open on top (FIG. 1D) for non-critical applications such as industrial wastewater desalination. Alternatively the tanks may be closed and isolated from surrounding environment however provision is provided to equilibrating pressure with that of surroundings. These tanks may be used for critical applications such as potable water production or water production for sanitary needs. These tanks may be used on feed and sweep side of SRO systems.
b. Piston pressurized feed tank (FIG. 1F)—A movable piston 130 is used to apply pressure on process solution 160. In SRO systems 1000, the piston 130 may be moved up or down to compensate for volume changes without pressurizing the solution. This includes filling and emptying of process solution. Further the piston may be moved up to depressurize the solution or moved down to pressurize the solution.
c. Indirect hydraulically and pneumatically pressurized feed tank (FIG. 1G)—a movable partition 140 separates the feed tank into two chambers. One chamber contains the feed side process solution 160 while the other chamber contains a hydraulic fluid 150 used to regulate system pressure. Total of fluid holding volume of both chambers is constant. Overall tank boundary is fixed. The hydraulic fluid may fill or empty its chamber without changing system pressure to compensate for volume changes of process solution. The hydraulic fluid may pressurize or depressurize while filling, emptying or remaining static in the chamber, to regulate process solution pressure. The hydraulic fluid 150 may be a process solution, in which case, it may also be processed in the same SRO system 1000. In such instance, process solution 160 in the other chamber may be used as hydraulic fluid. Alternatively a gas or air may be used to pneumatically pressurize the SRO system 1000. Each chamber contains only one fluid. Importantly the hydraulic fluid and process fluid may be in either of the chambers. The movable partition separating the chambers might be a solid material, a hydraulic fluid immiscible with fluids in both the chambers or any other material. Further variations of this tank configuration may include more than two chambers, for e.g. four chambers, three containing feed side solution and one with hydraulic fluid. When using such tank, each chamber may approximate a single tank. Thus a single hydraulic fluid pressurized tank with four chambers may replace three pressurized (e.g. piston) tanks with a single chamber for process solution.
d. Piston assisted indirect hydraulic fluid pressurized feed tank (FIG. 1H)—This tank is similar to indirect hydraulically and pneumatically pressurized feed tank, a movable partition 140 separates process 160 and hydraulic fluids 150. The movable partition separating the chambers might be a solid material, a hydraulic fluid immiscible with fluids in both the chambers or any other material. Further a piston 130 is provided on one end of the tank. The piston may move during a process to compensate for volume changes and/or to regulate system pressure. As a result total of fluid holding volume of both chambers may be varied. The tank boundary at the piston segment may be varied. Alternatively fluids in both the chambers might be process solutions. In this arrangement it is possible to achieve batch mode of operation in non-recirculation mode using a single tank. Overall it minimizes tank requirements for batch operation. Further variations of this tank configuration may include more than two chambers, for e.g. three chambers. When using such tank, each chamber may approximate a single tank. Thus a single piston assisted indirect hydraulic fluid pressurized tank with three chambers may replace three pressurized (e.g. piston pressurized) tanks with a single chamber.
e. Direct hydraulically and pneumatically pressurized feed tank (FIG. 1J)—the feed tank is separated into two chambers by the volume occupied by process solution and hydraulic fluid. Here the hydraulic fluid is in direct contact with the process solution and is immiscible with the process solution. Depending upon the relative density the position of hydraulic fluid and process solution in the tanks may be determined. Alternatively a gas or air in direct contact with the process solution may be used in one chamber to pneumatically pressurize the SRO system 1000.
f. Direct feed pressurized feed tank (FIG. 1K)—the feed tank containing a single chamber is fully occupied by feed side process solution and the SRO system 1000 is pressurized directly by feed solution added to the system.
g. Symbol for pressurized feed tanks (FIG. 1L)—symbol representing all pressurized feed tanks FIG. 1F to FIG. 1H, FIG. 1J, FIG. 1K and FIG. 1N. This is used in general embodiment of SRO systems 1000 with pressurized feed tanks.
h. Unpressurized tank with at least two chambers (FIG. 1M)—the tank is divided into at least two chambers separated by at least one movable partition. The movable partition separating the chambers might be a solid material, a hydraulic fluid immiscible with fluids in both the chambers or any other material. Further variations of this tank configuration may include more than two chambers, for e.g. three chambers, all of them containing a process solution. When using such a tank, each chamber may approximate a single unpressurized tank. Thus a single unpressurized tank with three chambers may replace three unpressurized tanks with a single chamber. These tanks may be used on feed and sweep side of SRO systems.
i. Indirect pressurized tank with at least two chambers (FIG. 1N)—the feed tank may comprise supplying feed solution to SRO unit from one chamber and returning the concentrate solution to the other chamber, thereby keeping the feed and concentrate solutions separate.

All tanks 101 and all chambers in the tanks (for tanks with partition) are designed to permit filling them completely with hydraulic solution/fluid 150 or process solution/fluid 160. Further the design is such that fluid in all tanks and all chambers in the tanks may be emptied completely leaving minimal to no residual solution. This is an essential feature of this invention and especially important for process solution when operating in non-recirculation modes. This may be explained for an exemplary system operation as follows: Non-recirculation mode of operation is considered, wherein concentrate of a pass is not mixed with feed to that pass. For a given feed side tank/feed chamber of a feed side tank, between a pass where the tank/chamber operates as supply tank/chamber and a pass where the same tank/chamber operates as receiving tank/chamber any residual solution if present in between will contribute to mixing of solutions at different osmotic pressures. This may affect process efficiency adversely by generating mixing entropy.

Relation between hydraulic pressures and osmotic pressures of the process solutions on either side may be explained as follows. In the absence of a separation process, the osmotic pressure of feed side solution (Π_{F}) and osmotic pressure of sweep side solution (Π_{S}) are such that,

Π_{F}≥Π_{S}

Π_{F} and Π_{S} represent bulk osmotic pressures of feed and sweep solutions. Due to mass transfer limitations, osmotic pressure of feed solution at the interface (Π_{F,I}) between the feed solution and the membrane is greater than Π_{F}. Similarly, osmotic pressure of sweep solution at the interface (Π_{S,I}) between the sweep solution and the membrane is less than Π_{S}. The difference in interfacial osmotic pressures between process solutions on the two sides represents the effective osmotic pressure (ΔΠ_{EEF}) defined as follows,

ΔΠ_{EEF}=Π_{F,I}−Π_{S,I}

During a separation process, hydraulic pressures P_{F} and P_{S} may be applied on feed and sweep side solutions respectively such that,

P_{F}≥P_{S}

The difference in hydraulic pressures of process solutions on the two sides represents the net hydraulic pressure (ΔP_{NET}) and may be defined as follows,

P_{NET}=P_{F}−P_{S}

Then for separation to occur whereby permeate solution flows from feed side to sweep side,

P_{F}−P_{S}≥Π_{F,I}−Π_{S,I}

ΔP_{NET}≥ΔΠ_{EFF}

Effective hydraulic pressure driving permeate flow (ΔP_{EFF,D}) may be defined as follows,

ΔP_{EFF,D}=(P_{F}−P_{S})−(Π_{F}−Π_{S})

ΔP_{EFF,D}=ΔP_{NET}−ΔΠ_{NET}

Direction of change in osmotic pressure of process solution in the circulation loops depends on the membrane rejection characteristics towards solution components of interest. For an SRO membrane 104 with positive rejection characteristics, during the batch or semi-batch process in an SRO system 1000, the osmotic pressure of process solution in feed circulation loop (1.1-1.2-1.3-1.4-1.1) increases while osmotic pressure of process solution in sweep circulation loop (2.1-2.2-2.3-2.4-2.1) decreases. The difference in osmotic pressures between the solutions in two loops across the membrane (Π_{F}−Π_{S}) increases with the progress of passes. If the SRO system 1000 is to maintain the earlier permeate flux, applied pressure on the feed loop solution may be increased corresponding to the increased difference in osmotic pressure and accounting for changes in concentration polarization effects. Alternatively for an SRO membrane 104 with negative rejection characteristics, the osmotic pressure of process solution in feed loop (1.1-1.2-1.3-1.4-1.1) decreases while osmotic pressure of process solution in sweep loop (2.1-2.2-2.3-2.4-2.1) increases. As a result the difference in osmotic pressures between the solutions in two loops across the membrane (H_{F}−H_{S}) decreases with the progress of passes. In order to maintain the earlier permeate flux the applied pressure on the feed loop solution may be decreased corresponding to the decreased difference in osmotic pressure and accounting for changes in concentration polarization effects.

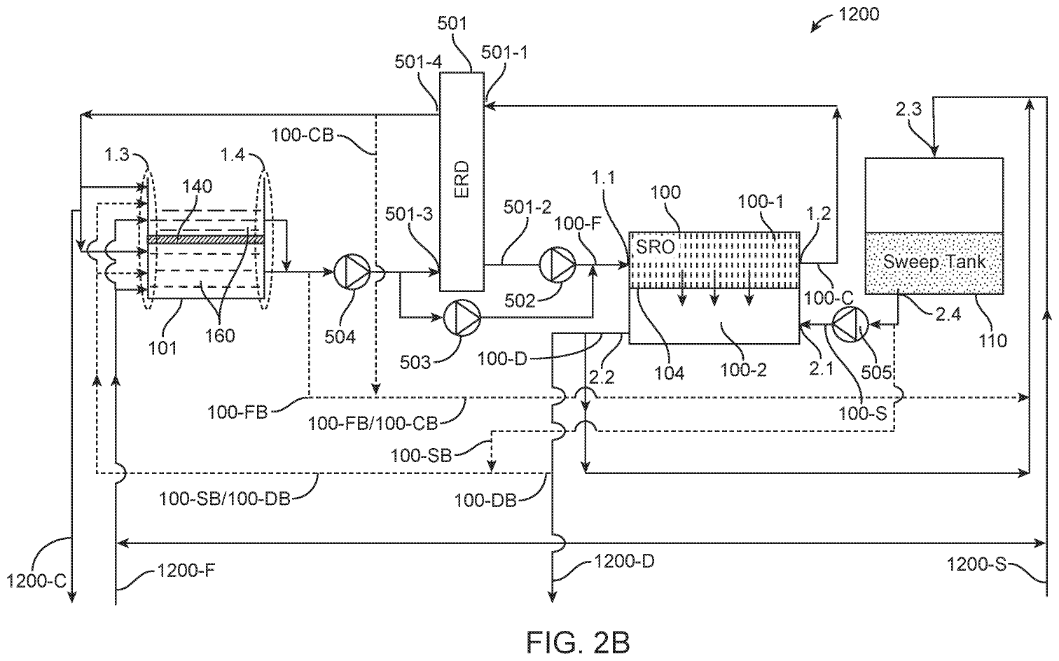

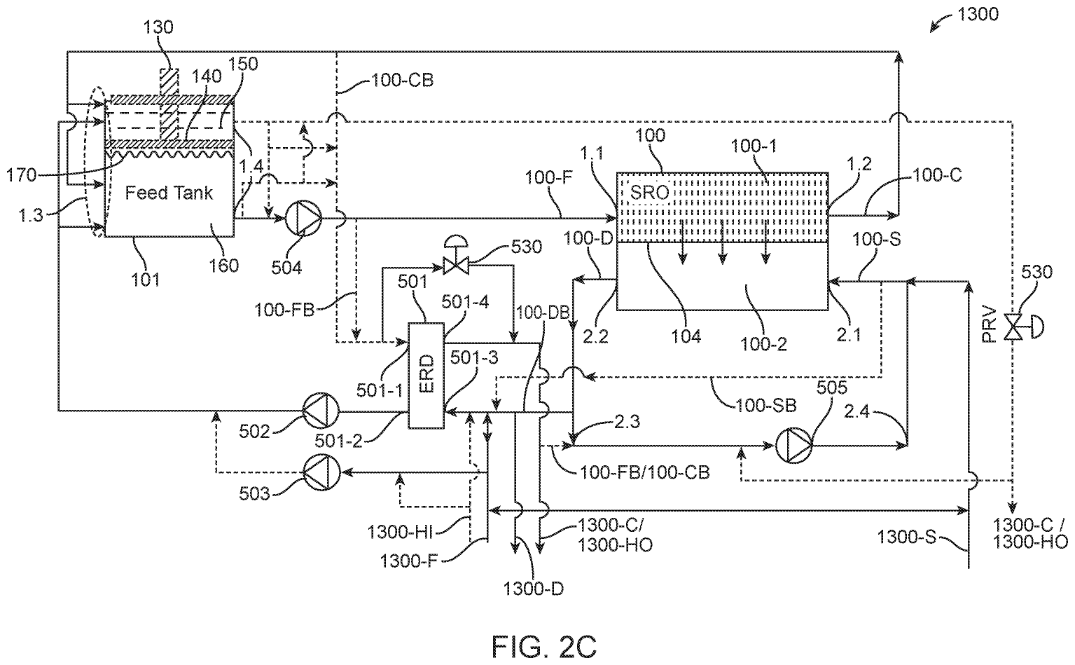

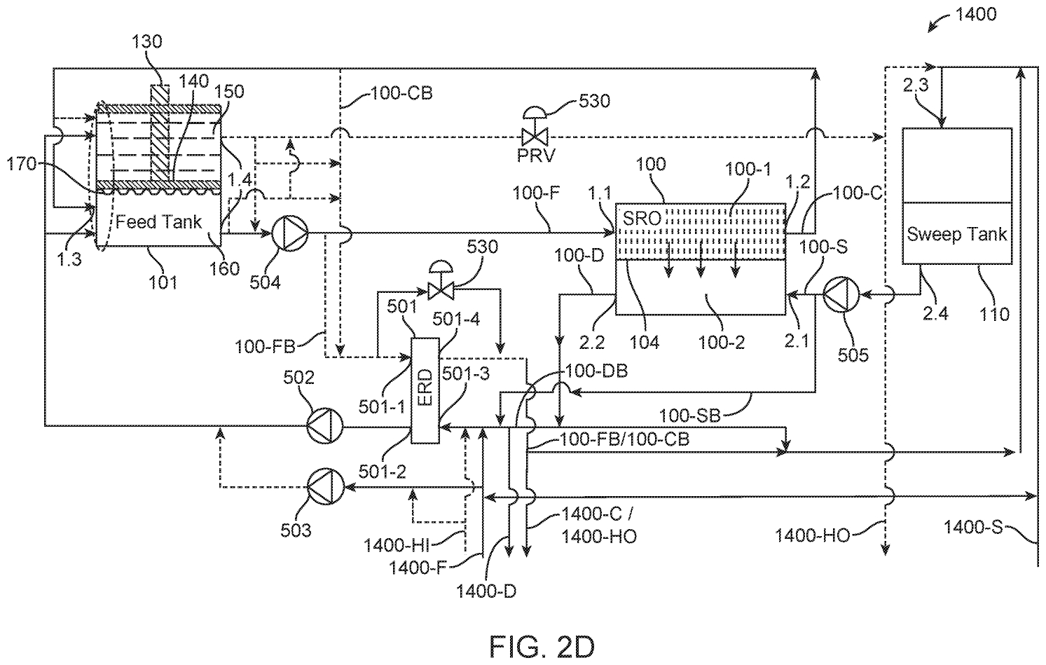

FIG. 2A-to FIG. 2D represent general embodiments of SRO systems 1000 with feed tank(s) 101 and/or sweep tank(s) 110 of this invention. Specific embodiments of SRO systems 1000 with tanks that follow may be derived from these general embodiments. Description and features of these embodiments apply to the specific embodiments. Major components of the SRO system 1000 include SRO unit 100 with membrane 104, feed side tank(s) 101, sweep side tank(s) 110, feed side circulation pump 504, sweep side circulation pump 505, energy recovery device 501, high pressure pump 503 and booster pump 502. Other components include pressure reducing valves, interconnecting conduits and flow control valves. The embodiments in FIG. 2A to 2D are shown to contain one feed tank 101 and optionally one sweep tank 110. However it must be understood that multiple feed 101 and sweep tanks 110 are also implied. In some embodiments, use of multiple tanks is an essential and an enabling feature of this invention. Further, in these embodiments of SRO systems 1000 with tanks, an energy recovery device (ERD) 501 is included in the systems as shown in FIGS. 2A, 2B, 2C and 2D. The energy recovery device 501 consists of high pressure inlet (HPI) 501-1, high pressure outlet (HPO) 501-2, low pressure inlet (LPI) 501-3 and low pressure outlet (LPO) 501-4. The incoming fluid stream with high energy is sent to the HPI 501-1 where energy is recovered from it and after which it emerges from LPO 501-4 at a relatively lower energy. While the incoming fluid stream with low energy is sent to the LPI 501-3 where energy recovered from the high energy stream is transferred to it and after which it emerges from HPO 501-2 at a relatively higher energy. In unpressurized feed tank embodiments, the ERD 501 is used to recover energy from the concentrate stream 100-C from first outlet 1.2 of SRO unit 100 into the feed stream 100-F entering first inlet 1.1 of SRO unit 100. Feed stream 100-F may be fed to the LPI 501-3 of the ERD 501 while 100-C may be fed to the HPI 501-1 of the ERD 501. In pressurized feed tank embodiments, the ERD 501 is used to recover energy from the feed bleed stream 100-FB and concentrate 100-CB. Bleed streams 100-FB and 100-CB may be fed to the HPI 501-1 of the ERD 501 while feed stream 100-F, hydraulic fluid stream 100-H, diluate bleed stream 100-DB and sweep bleed stream 100-SB may be fed to the LPI 501-3 of the ERD 501. In both unpressurised and pressurized feed tank embodiments, ERD 501 recovers energy (e.g. pressure) from the stream entering HPI 501-1 into the stream entering the LPI 501-3 and produces a low pressure outlet stream emerging from LPO 501-4 of the ERD 501 corresponding to stream entering HPI and high pressure outlet stream emerging from HPO 501-2 of the ERD 501 corresponding to stream entering LPI. Since ERD may have some inherent inefficiency, the energy recovered into stream emerging from HPO shall be less than energy of stream entering HPI. A booster pump (BP) 502 shall be used after the ERD 501 to pump the high pressure stream emerging from HPO to the desired operating pressure requirements. BP 502 makes up for energy lost due to solution circulation from HPO of ERD through SRO unit, interconnecting conduits and other components, to HPI 501-4 of the ERD and energy lost due to irreversibilities in energy recovery by the ERD 501. A high pressure pump (HPP) 503 is included parallel to an ERD 501 and BP 502, to add additional fluid into the system beyond that added by ERD. Further HPP in combination with ERD or PRV 530, is used to regulate SRO unit operating pressure. For example, when systems in FIG. 2C and FIG. 2D (pressurized feed tanks) are operated in semi-batch mode with bleed streams, HPP 503 may be used to add pressurized process solution in addition to solution added by ERD to the system in order to make up for feed side solution volume removed as permeate. In certain operations, for example when systems in FIG. 2C and FIG. 2D (pressurized feed tanks) are operated in semi-batch mode without bleed stream, HPP alone may be used to add feed stream 100-F to the system. Here ERD shall not have any input of high pressure streams and hence may not be used. In some operations the components ERD, BP and HPP may be used in tandem as known in the art. In various embodiments ERD 501 as shown in FIG. 2A to FIG. 2D, may be a pressure exchanger (PX) a Pelton wheel, turbine based ERD, recuperator, turbocharger or reverse running pumps. Some energy recovery technologies combine the function of at least two of an ERD (501), a booster pump (502) and a high pressure pump (503) into a single device. Such devices may be used to perform the separation methods described in embodiments of this invention instead of the separate devices shown. In some pressurized tank embodiments, ERD recovers pressure from the feed and concentrate bleed streams into the incoming hydraulic fluid stream. This hydraulic fluid may be used to pressurize feed side tanks. In these embodiments circulation pumps 504 and 505 are included in the first circulation loop and the second circulation loop respectively. During a separation process, it may be necessary to transfer process solution from feed side to sweep side and vice versa without the need to pass through SRO unit. For such purposes separate transfer pumps (not shown) may be used to transfer process solutions along dedicated conduits (not shown).

The SRO system with feed tanks may be partitioned overall into high pressure region and low pressure region separated by an interface of components permitting direct hydraulic exchange of process solution (and hydraulic fluid in some embodiments) between them.

For un-pressurized feed tank embodiments in FIGS. 2A and 2B, low pressure region of the system is bound by low pressure inlet (LPI) 501-3 of ERD 501, low pressure outlet (LPO) 501-4 of ERD 501, inlet of HPP 503 and sweep side of membrane 104-2 of SRO unit 100. It comprises feed side tank(s) 101, sweep side tank(s) 110, all interconnecting conduits, part of feed side and sweep side process solutions, feed side circulation pump 504, sweep side circulation pump 505 and sweep side 100-2 of SRO unit 100 among other components. The high pressure region of the system is contained between outlet of HPP 503, high pressure outlet 501-2 of ERD 501, high pressure inlet 501-1 of ERD 501 and feed side of membrane 104-1 of SRO unit 100. The high pressure region comprises booster pump (BP) 502, part of feed side solution, feed side of SRO unit and all interconnecting conduits among other components. The system components HPP 503 and ERD 501 form an interface of direct hydraulic contact between low and high pressure regions. This interface may be considered as a boundary allowing direct hydraulic movement of process solution between high and low pressure regions of SRO system while maintaining required pressures in the respective zones. All direct hydraulic movement of process solutions between the two zones in all unpressurised feed tank embodiments occur at this interface.

For pressurized feed tank embodiments in FIGS. 2C and 2D, low pressure region of the system is bound by inlet of HPP 503, low pressure inlet 501-3 of ERD 501, low pressure outlet 501-4 of ERD 501, low pressure side of pressure reducing valve (PRV) 530 and sweep side of membrane 104-2 of SRO unit 100. This region further comprises sweep side tank(s) 110, sweep side circulation pump 505, sweep side solution, sweep side 100-2 of SRO unit 100 and all interconnecting conduits among other components. The high pressure region of the system is contained between feed side tank(s) walls (and pistons for embodiments with piston pressurized feed tanks), outlet of HPP 503, high pressure outlet 501-2 of ERD 501, high pressure inlet 501-1 of ERD 501, high pressure side of pressure reducing valve PRV 530 and feed side of membrane 104-1 of SRO unit 102. The high pressure region comprises feed side tank(s) 101, feed side solution, feed side 100-2 of SRO unit 100, all interconnecting conduits, booster pump (BP) 502 and feed side circulation pump 504 among other components. The system components HPP 503, ERD 501 and PRV 530 form an interface of direct hydraulic contact between low and high pressure regions. This interface may be considered as a boundary allowing direct hydraulic movement of process solution between high and low pressure regions of SRO system while maintaining required pressures in the respective zones. All direct hydraulic movement of process solutions between the two zones in all pressurized feed tank embodiments occur at this interface. Preferably the system components ERD 501 and BP 502 is used for direct hydraulic movement of solutions between the high pressure and low pressure zones during a process. Use of system components PRV 530 and HPP 503 for hydraulic exchange of solutions between the two pressure zones, results in loss of system pressure without energy recovery and is preferably not be used in isolation during the batch or semi-batch. While depressurizing the system, concentrate stream may be removed from the system via PRV 530.

The invention in various embodiments shown in FIG. 2A to FIG. 2D proposes a batch or semi-batch pressure-driven osmotically assisted membrane separation. Unpressurized tanks FIG. 1D, FIG. 1E and FIG. 1M with one or more chambers may be used as at least one of feed tanks, sweep tanks. Certain methods of achieving separation common to these embodiments are as follows. In one embodiment feed stream is supplied from feed side tank 101 and concentrate stream is shown to return to the same feed side tank 101. The feed side tank 101 is used as feed side solution supply and receiving tank. This corresponds to recirculation mode of operation on feed side. Other variation of SRO system may in addition include another feed side tank to receive concentrate stream from the first outlet 1.2 of SRO unit 100. This corresponds to non-recirculation mode of operation on feed side. For embodiments with sweep side tanks, likewise on sweep side the sweep stream is supplied from sweep side tank 110 and diluate stream is shown to return to the same sweep side tank 110. The sweep side tank 110 is used as sweep side solution supply and receiving tank. This corresponds to recirculation mode of operation on sweep side. In some embodiments the SRO system may further include a second sweep side receiving tank that is configured to receive the diluate stream from the second outlet 2.2 of SRO unit 100. This corresponds to non-recirculation mode of operation on sweep side. Bleed streams are shown in all embodiments and are an essential and an enabling feature of the invention. Bleed streams permit certain time variant SRO operation specifically for embodiments with tanks/holding chambers on one side only. Also bleed streams allow certain array configurations (internally connected SRO arrays) described later to be realized. For an SRO system ZZZZ described in following embodiments, feed side solution is supplied to the system as stream ZZZZ-F and sweep side solution is supplied to the system as stream ZZZZ-S. The two streams may be interconnected. It shall be understood that the system may be operated on two different process solutions each for feed side and sweep side or same process solution for both sides. Concentrate ZZZZ-C and diluate ZZZZ-D streams are used to remove concentrate and diluate solutions respectively from the system at the end of the process. Further these systems consist an SRO unit 100 having a first side 100-1 configured to receive a first solution having a first solute concentration, a second side 100-2 configured to receive a sweep solution having a second solute concentration and a semi-permeable membrane 104.

For systems with feed tanks or sweep tanks, at least one tank inlet 1.3 and at least one tank outlet 1.4 are connected to feed side circulation loop as shown in FIG. 2A-D and at least one tank inlet 2.3 and at least one outlet 2.4 are connected to the sweep side circulation loop as shown in FIGS. 2B and 2D.

For systems with feed holding chamber(s), and for system with external source and external sink of process solution on feed side operated with recirculation from SRO unit outlet 1.2 to SRO unit inlet 1.1, sections 1.3 and 1.4 refer to junctions in the loop that are connected to the holding chamber(s) or to external source and external sink. For systems with holding chambers, circulation flow path in the feed side circulation loop is determined at these junctions. The second or sweep side circulation loop includes at least one second inlet (2.1) of the SRO unit 100 that receives the sweep stream having a second solute concentration, at least one second outlet (2.2) of the SRO unit 100 that releases a volume of diluate stream. For systems with holding chambers, circulation flow path in the sweep side circulation loop is determined at these junctions. First circulation loop may be connected to one or more feed side tank(s) or feed side holding chamber(s) or external feed source and external concentrate sink. The second circulation loop may be connected to an external sweep source and external diluate sink, one or more sweep side tank(s) or sweep side holding chamber(s).

For system with sweep holding chamber(s), and for system with external source and sink of process solution on sweep side operated with recirculation from 2.2 to 2.1, sections 2.3 and 2.4 refer to junctions in the loop that are connected to the holding chamber(s).

The invention in various embodiments proposes a batch or semi-batch pressure-driven osmotically assisted membrane separation systems 1300 and 1400 with pressurized feed tanks as shown in FIG. 2C and FIG. 2D respectively. Features common to both the embodiments are described here. This is then followed by description specific to the different systems.

In embodiments FIGS. 2C and 2D, pressure in the feed tanks may be applied by a piston, hydraulic or pneumatic fluid. When operating this system in batch mode, ERD 501 recovers energy from the streams 100-FB and 100-CB and transfers it into incoming hydraulic fluid stream 1300-HI and 1400-HI. Hydraulic streams 1300-HI and 1400-HI streams may be added via HPP 504 and/or ERD 501 and removed from the systems as streams 1300-HO and 1400-HO via ERD 501 or via PRV 530. For semi-batch mode of operation, system feed stream 1300-F and 1400-F may be added to feed side tanks during a separation process. Here streams 1300-F and 1400-F may be used to regulate system pressure instead of streams 1300-HI and 1400-HI. In these embodiments the pressurizing/depressurizing components ERD 501, BP 503, HPP 504, PRV 530 and conduits conveying these streams are shown to be common for process solution and hydraulic fluid streams. However separate set of pressurizing/depressurizing components and conduits may be used for the two streams such that there is no hydraulic contact between the two streams. The system may operate as a batch or semi-batch and may switch between the two modes during operation.

All means of pressurizing the feed tanks mentioned in FIG. 1L, FIG. 1F to FIG. 1H, FIG. 1J, FIG. 1K and FIG. 1N, are implied in systems 1300 and 1400 shown in FIG. 2C and FIG. 2D respectively. In some embodiments pressurized by a hydraulic fluid, the hydraulic fluid could be the process solution. In such instances, the hydraulic fluid in a pass may be used as feed to SRO unit in a subsequent pass while the solution, which was processed in the SRO unit may be used as a hydraulic fluid. In some embodiments, the hydraulic fluid is not processible in SRO unit. In such instances, the hydraulic fluid may be used only to regulate pressure on the feed side process solution and may not be processed in the SRO unit 100. Provision is provided for supplying feed solution 100-F from either of the chambers via connections 1.4 and returning the concentrate 100-C to either of the chambers via connections 1.3. Also the incoming hydraulic and/or process solution may be added to either of the chambers via connections 1.3. Yet another variation of non-recirculation mode of operation of SRO system specific to indirect hydraulically pressurized feed tanks (FIG. 1L) may comprise supplying feed solution to SRO unit from one chamber and returning the concentrate solution to the other chamber, thereby keeping the feed and concentrate solutions separate.

In various embodiments, pressure is applied by using sweep side bleed streams 100-DB and 100-SB from sweep side as hydraulic fluids in the hydraulic chamber. Energy recovery device recovers pressure from streams 100-FB and 100-CB into stream 100-DB and 100-SB. HPP 503 and/or BP 502 may be used to regulate the final pressure of hydraulic fluid applied on the system. Subsequently system feed solution 1300 F/1400 F may be added to the feed side chamber for semi-batch operation. All SRO systems are designed in such a way to minimize mixing of process solutions of different concentrations in piping and in equipment.

Further aspects of embodiment in FIG. 2C is explained as follows. FIG. 2C represents SRO systems with one or more pressurized feed tank(s). Further it consists of SRO unit 100 with membrane 104, ERD 501, HPP 503 and BP 502.

Further aspects of embodiment in FIG. 2D is explained as follows. FIG. 2D represents SRO systems with one or more pressurized feed tank(s) 101 and one or more unpressurized sweep tank(s) 110. Further it consists of SRO unit 100 with membrane 104, ERD 501, HPP 503 and BP 502.

Specific embodiments using feed and sweep tanks are described below. The features common with general embodiments described above apply to the specific embodiments in that group. In order to better explain the working of the embodiments, exemplary processes are explained. The same embodiments may be operated in different manner from the exemplary processes. The processing methods described below are for better understanding of the embodiments and are not meant to be limiting their operability. Specific embodiments are shown only for general embodiments with feed side and sweep side tanks (FIG. 2B and FIG. 2D). Specific embodiments with only feed side tanks and externally fed sweep side may be derived from the respective general embodiments with tanks on one side and specific embodiments with tanks on both side. During operation of following systems, if feed solution is added to any of the feed tanks during the separation process described below where it mixes with process solution already present in the tank and the combined solution is processed in the same separation process, then the process becomes semi-batch. Alternatively, if a feed solution is added to an empty tank and is processed in a subsequent separation process, then the current process and subsequent process where this solution is processed are considered as batch processes. If the feed solution is added to a tank with another solution, mixed with it and processed in a subsequent separation process, the current separation process shall be considered a batch while the subsequent separation process which processes this mixed solution shall be considered a semi-batch.

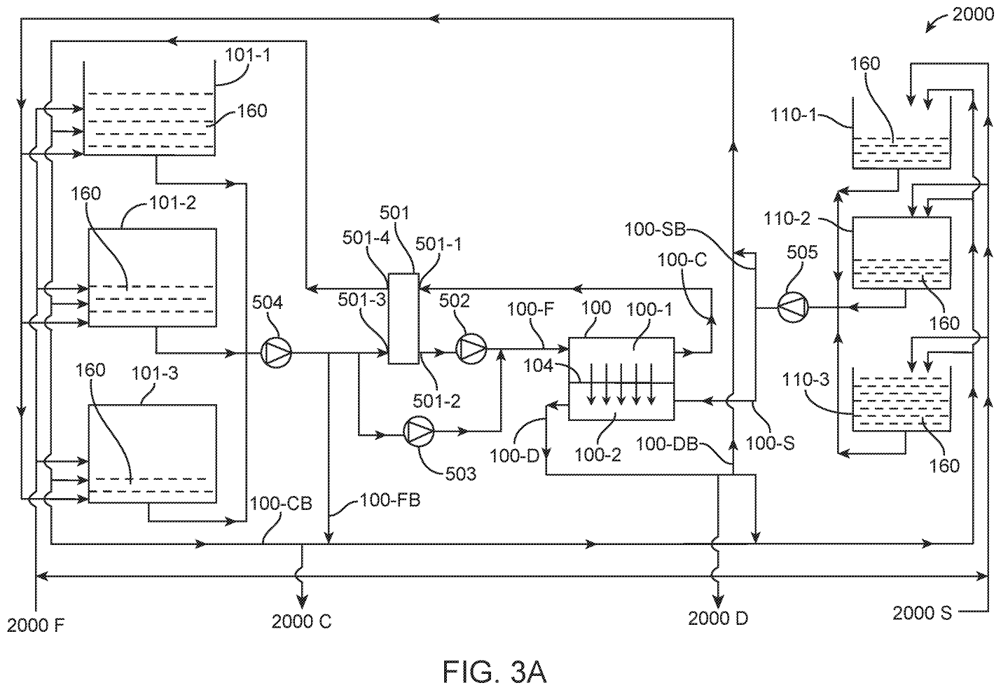

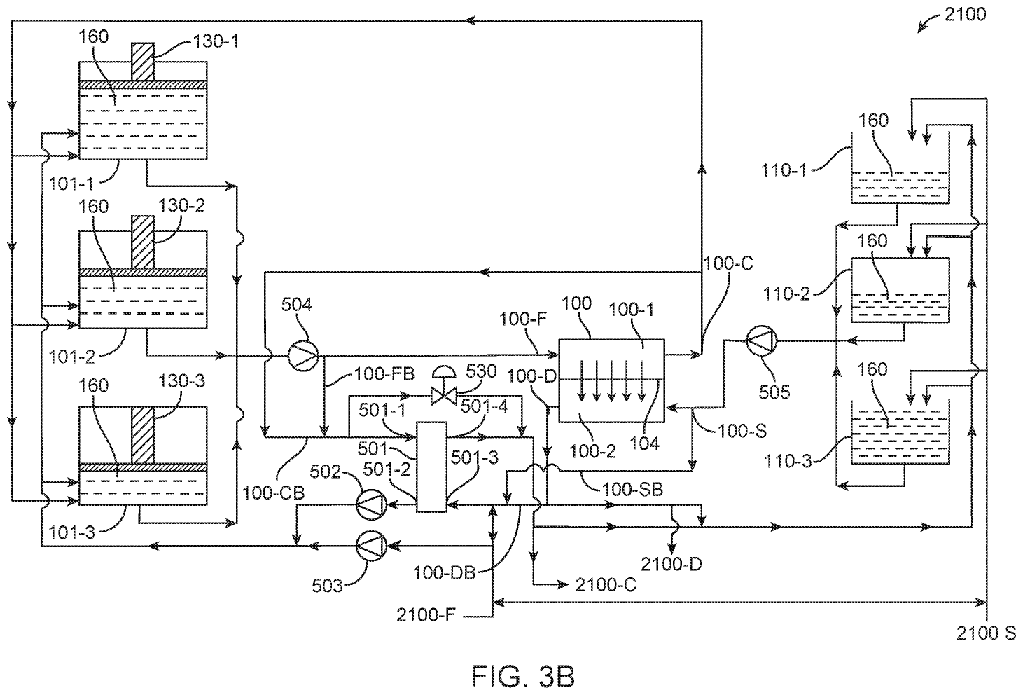

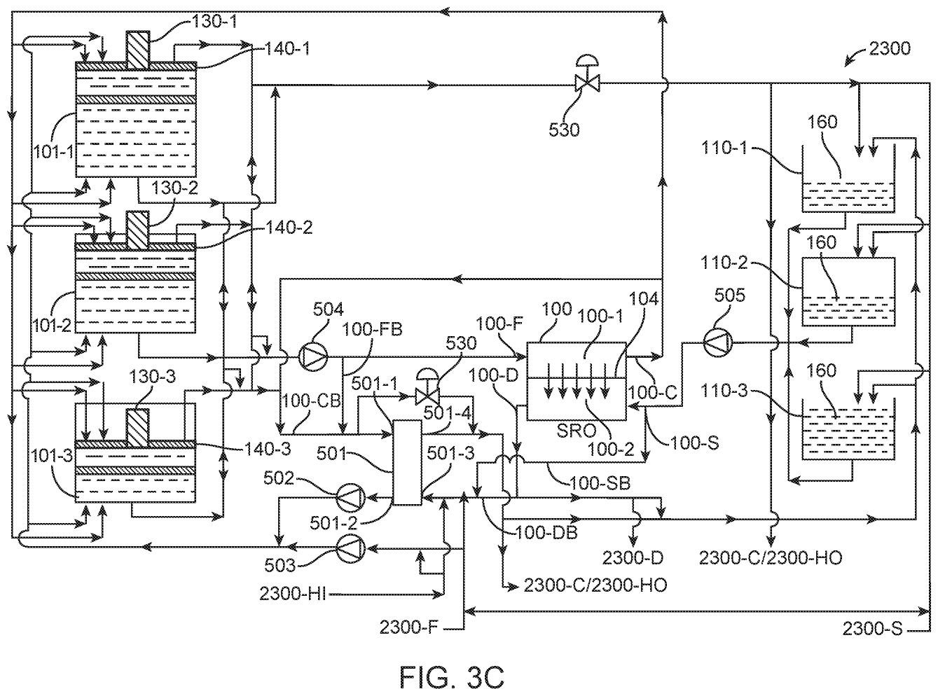

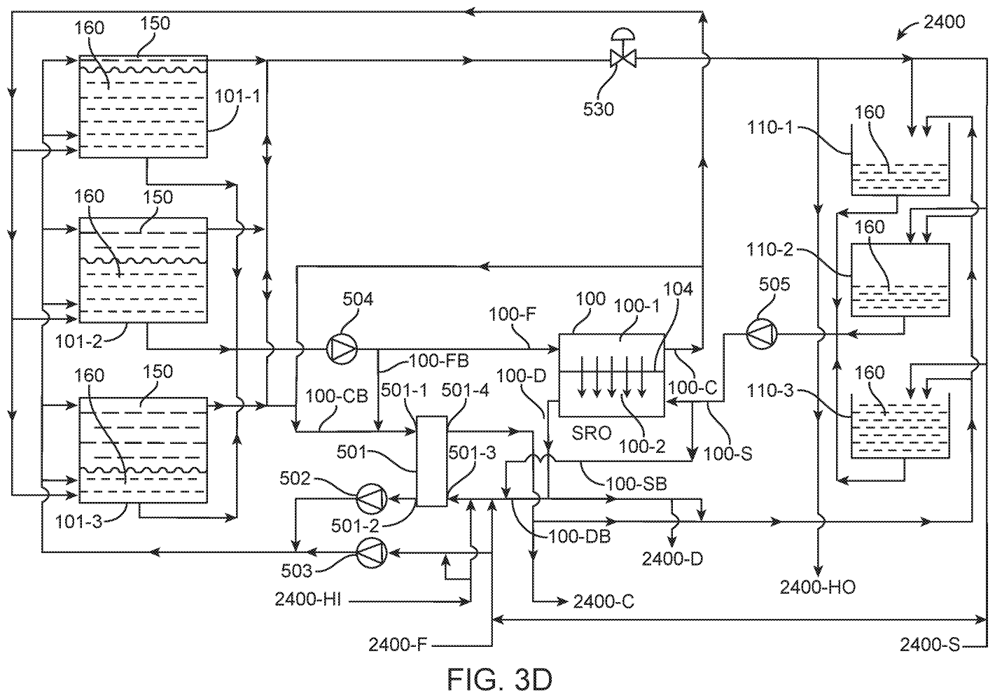

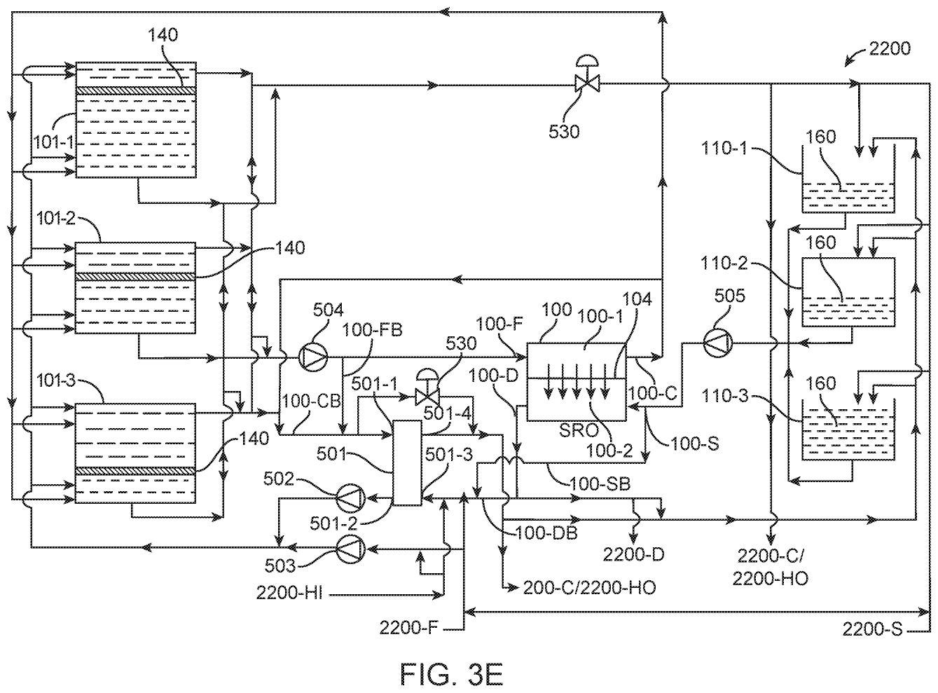

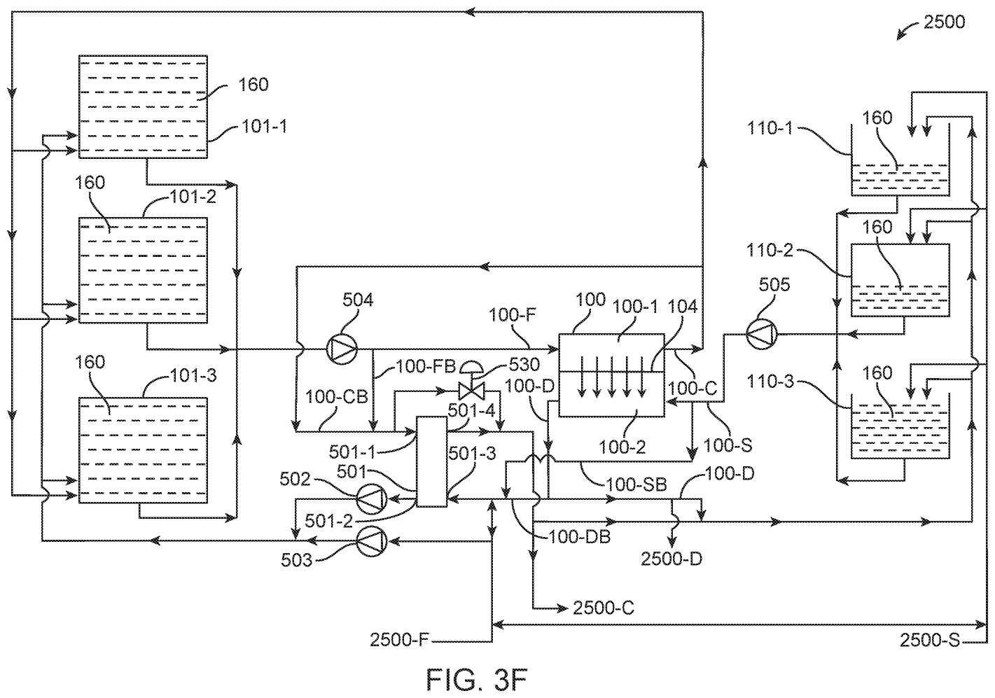

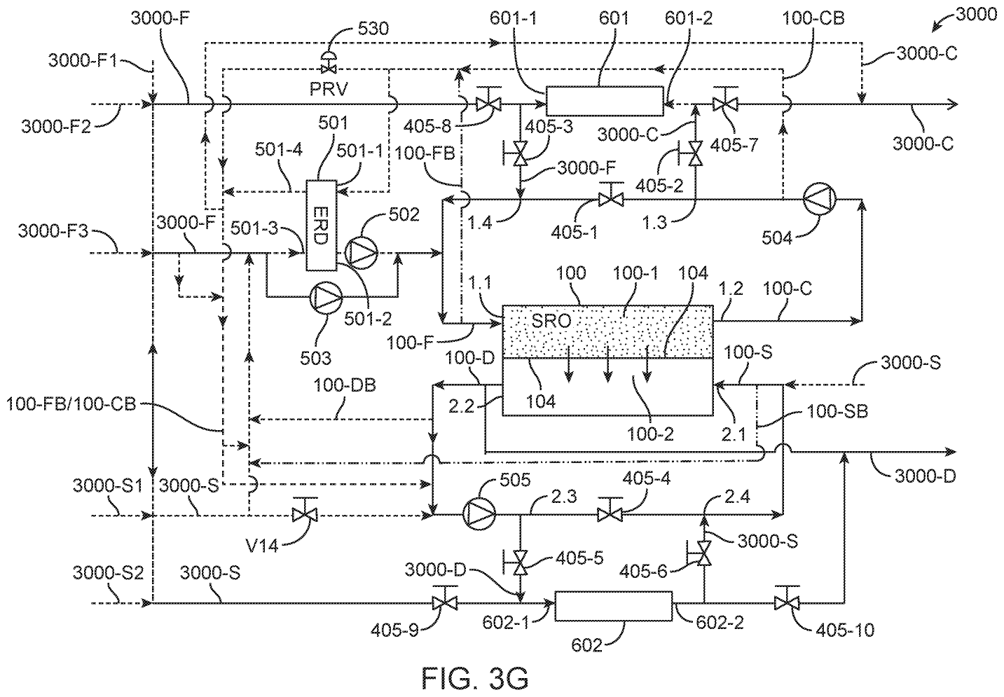

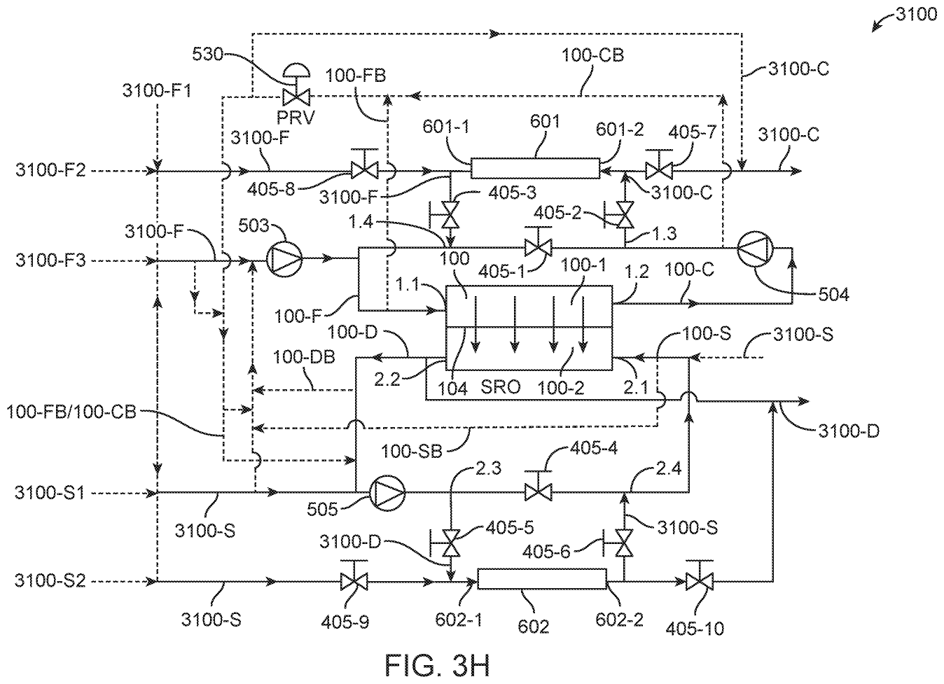

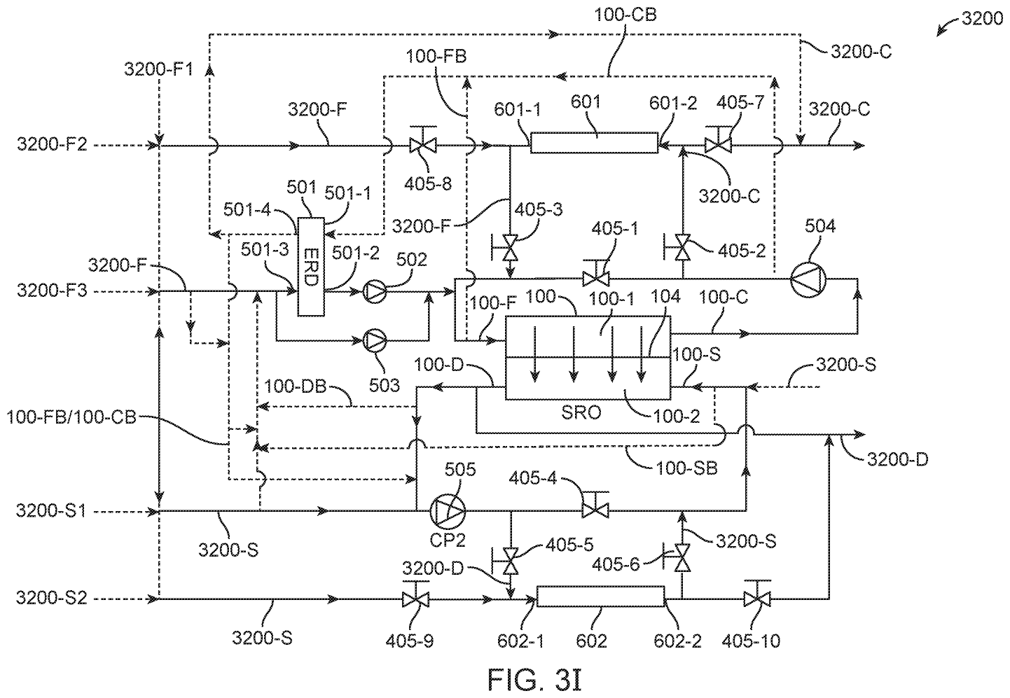

The system 2000 as shown in FIG. 3A may include at least one, two or three feed and sweep tanks as shown in FIG. 3A. It employs unpressurized feed tanks. Unpressurized tanks FIG. 1D, FIG. 1E and FIG. 1M with with one or more chambers may be used for feed tanks or sweep tanks or both. Each feed tank is hydraulically connected to feed side circulation pump 504, LPO of ERD 501-4, second outlet 2.2 on sweep side, sweep side circulation pump 505 and external process solution supply 2000-F, 2000-S. Each sweep tank is hydraulically connected to sweep side circulation pump 505, feed side circulation pump 504, second outlet 2.2, LPO of ERD 501-4 and external process solution supply 2000-F, 2000-S. Feed solution from feed tanks 101-1, 101-2 and 101-3 feed the first inlet 1.1 of SRO module 100. Sweep solution from the sweep tanks 110-1, 110-2, 110-3 feed the second inlet 2.1 of the SRO module 100.

An exemplary mode of operating the system 2000 in FIG. 3A is as follows. The following process explains batch with bleed streams mode of operating the system. The process begins with initial feed solutions in first feed side tank 101-1 and second sweep side tank 110-2 respectively. Second and third feed side tanks 101-2 and 101-3 respectively are empty. First and third sweep side tanks 110-1 and 110-3 respectively are empty. The system operates in non-recirculation mode as follows. In pass 1 at a time t=t₁, solution from the first feed side supply tank 101-1 is fed to the first inlet of SRO unit and solution from the second sweep side supply tank 110-2 is fed to the second inlet of SRO unit to obtain a first concentrate and a first diluate solution having different osmotic pressures. A portion of the first concentrate is fed to an empty first sweep side receiving tank 110-1. Remaining portion of first concentrate from the SRO unit is fed to an empty third feed side receiving tank 101-3. The first diluate solution is fed to an empty third sweep side receiving tank 110-3. At the end of pass 1 both supply tanks 101-1 and 110-2 are empty. In pass 2 at time t=t₂ solution from the third feed side supply tank 101-3 containing a portion of concentrate stream from pass 1 is fed to the first inlet of SRO unit and solution from first sweep side supply tank 110-1 containing a portion of concentrate stream from pass 1 is fed to the second inlet of SRO unit to obtain a second concentrate and a second diluate solutions having different osmotic pressures. Second concentrate stream from the SRO unit at concentrate osmotic pressure or solution concentration defined by the predetermined separation duty is removed from the system. A portion of the second diluate solution at osmotic pressure equal to that of feed solution in pass 1 is fed to an empty second feed side receiving tank 101-2. While the remaining second diluate solution is fed to an empty second sweep side receiving tank 110-2. At the end of pass 2 both supply tanks 101-3 and 110-1 are empty. In pass 3 at time t=t₃ solution from the second feed side supply tank 101-2 is sent to first inlet of SRO unit and solution from the second sweep side supply tank 110-2 is sent to second inlet of SRO unit to obtain a third concentrate stream and a third diluate solution having different osmotic pressures.

The third concentrate stream is fed to an empty third feed side receiving tank 101-3. The third diluate solution at the same osmotic pressure as diluate solution from first pass is sent to first feed side receiving tank 101-1. At the end of pass 3 both supply tanks 101-2 and 110-2 are empty. In pass 4 at time t=t₄ solution from the first feed side supply tank 101-1 is sent to first inlet of SRO unit and solution from the third sweep side supply tank 110-3 is sent to second inlet of SRO unit to obtain a fourth concentrate stream and a fourth diluate solution having different osmotic pressures. The fourth concentrate stream is fed to an empty second feed side receiving tank 101-2. Fourth diluate solution from the SRO unit at diluate osmotic pressure or solute concentration defined by the predetermined separation duty is removed from the system. At the end of pass 4 both supply tanks 101-1 and 110-3 may be empty. At this point of time in the separation process, residual solutions remains in second and third feed side tanks 101-2 and 101-3 respectively. This may be further split in subsequent passes to yield final solutions defined by predetermined separation duty. In further variations of the above process, additional residual solutions may remain between passes in other feed and sweep tanks mentioned.

In such instances, these solutions may be mixed with solutions of same or similar osmotic pressures within a tolerance range acceptable for that application. In the above description this may be achieved in pass 3 when a portion of third diluate solution at same osmotic pressure as first diluate solution may be fed to third sweep side receiving tank 110-3 which already contains the first diluate solution. This combined solution in tank 110-3 may be processed in subsequent passes. In instances where it is not possible to split all of the initial solution into concentrate and diluate solutions defined by the predetermined separation duty, it may be decided to terminate the batch with unconverted residual solutions at concentrations different from that defined by separation duty. These residual solutions could be stored and carried over to subsequent batch or semi-batch where they are processed further. In the above process, if it is decided that residual solution may be carried over to next batch after pass 3 above, then the solution may be retained in feed tank 101-1 until a process solution of equal or within an acceptable range of osmotic pressures is generated, at which time it may be mixed with this residual solution and further processed. Accordingly the feed tank 101-2 may not be available during subsequent batch until this instant. However the next batch may start with batch feed solution in just one tank, say 101-1. Alternatively additional tanks may be provided exclusively for the purpose of carrying over residual solutions between batches. Alternative method of finishing a batch or semi-batch is to run the residual solutions in recirculation mode to achieve solutions defined by the predetermined separation duty. If it is decided after pass 3 above, that the solution may be run in recirculation mode, then in pass 4 at time t=t₄ the system may operate in re-circulation mode where solution from feed side supply tank 101-2, is sent to the SRO unit to obtain concentrate stream or diluate solution defined by the predetermined separation duty. It may still be decided to carryover a residual solution if the predetermined separation duty is not met. The above process is batch with bleed streams mode of operation.

Further the system may be operated as semi-batch with bleed streams mode of operation as follows. During a similar process to that explained for batch with bleed streams above, process solution may be added to any of the feed or sweep tanks during the separation process described above where it mixes with a solution already present in the tank and the combined solution is processed in the same separation process, then the process becomes a semi-batch with bleed streams for the corresponding side(s) where this addition is done. Alternatively and desired for continuous operation is when a process solution is added to an empty tank towards the end of an operation cycle and is processed in a subsequent separation process, then the current process is still considered a batch. If the process solution is added to a tank with another solution and processed in a subsequent separation process, the current separation process shall be considered a batch while the subsequent separation process which processes this mixed solution shall be considered a semi-batch.

The embodiment in FIG. 3A may also be operated as batch without bleed streams as follows. In this mode, the system operates similar to the above batch with bleed streams separation process except that in this operation mode there are no bleed streams. The feed side solution shall not be mixed with sweep side solution and sweep side solution shall not be mixed with feed side solution. This process becomes batch without bleed streams mode of operating the system.

The embodiment in FIG. 3A may also be operated as semi-batch without bleed streams as follows. In this mode, the system operates similar to the above batch without bleed streams with an additional provision that external process solution may be added to any of the feed or sweep tanks during the separation process where it mixes with a process solution already present in the tank and the combined solution is processed in the same separation process, then the process become semi-batch without bleed streams mode for the corresponding side(s) where this addition is done. The method described above for unpressurized feed tanks with one chamber containing process solution may be extended similarly to unpressurized feed tanks with two or more chambers FIG. 1M.

The system 2100 as shown in FIG. 3B may include at least one, two or three feed and sweep tanks. It employs piston pressurized feed tanks where the process solution is pressurized using a piston 130. Each feed tank is hydraulically connected to feed side circulation pump 504, high pressure side of PRV 530, first outlet 1.2 of SRO unit 100, outlet of HPP 503 and BP 502. Each sweep tank is hydraulically connected to sweep side circulation pump 505, second outlet 2.2, LPO of ERD 501-4 and external process solution supply (2100-F and 2100-S). The system 2100 may be partitioned overall into high pressure region and low pressure region. High pressure region of the system is contained between outlet of HPP 503, high pressure outlet of ERD 501-2, high pressure inlet of ERD 501-1, high pressure side of PRV 530 and feed side 100-1 of SRO unit 100. This region comprises process solutions, feed side tanks and interconnecting conduits among other components. The low pressure region of the system is contained between inlet of HPP 503, low pressure inlet 501-3 of ERD, low pressure outlet 501-4 of ERD, low pressure side of PRV 530 and sweep side 100-2 of SRO unit 100. This region comprises process solution, sweep side tanks and all interconnecting conduits among other components.

The system components ERD 501, PRV 530 and HPP 503 form the boundary between high pressure and low pressure regions in the system and are an essential system feature which permit direct hydraulic exchange of solutions between the high pressure and low pressure regions. Feed solution from feed tanks 101-1, 101-2 and 101-3 feed the first inlet 1.1 of SRO module 100. Sweep solution from the sweep tanks 110-1, 110-2, 110-3 feed the second inlet 2.1 of the SRO module 100.

An exemplary mode of operating the system is as follows. The below process explains batch with bleed streams mode of operating the system. The system operation begins with process solution filled in feed side tank 101-1 and sweep side tank 110-2. Remaining tanks are empty. The system operates in non-recirculation mode as follows. In pass 1 at a time t=t1, solution from the first feed side supply tank 101-1 is fed to the first inlet of SRO unit and solution from the second sweep side supply tank 110-2 is fed to the second inlet of SRO unit to obtain a first concentrate and a first diluate solutions having different osmotic pressures. A portion of the first concentrate is fed to an empty first sweep side receiving tank 110-1 using the third conduit and via ERD 501. Remaining portion of first concentrate from the SRO unit is fed to an empty third feed side receiving tank 101-3. The first diluate solution is fed to an empty third sweep side receiving tank 110-3. At the end of pass 1 both supply tanks 101-1 and 110-2 are empty.

In pass 2 at time t=t₂ solution from the third feed side supply tank 101-3 containing a portion of concentrate stream from pass 1 is fed to the first inlet of SRO unit and solution from first sweep tank 110-1 containing a portion of concentrate stream from pass 1 is fed to the second inlet of SRO unit to obtain a second concentrate and a second diluate solution having different osmotic pressures. Second concentrate stream from the SRO unit at concentrate osmotic pressure or solution concentration defined by the predetermined separation duty is removed from the system via the ERD 501. A portion of the second diluate solution at osmotic pressure equal to that of feed solution in pass 1 is fed to an empty second feed side receiving tank 101-2 via ERD 501 and HPP 503. While the remaining second diluate solution is fed to an empty second sweep side receiving tank 110-2. At the end of pass 2 both supply tanks 101-3 and 110-1 are empty. In pass 3 at time t=t3 solution from the second feed side supply tank 101-2 is sent to first inlet of SRO unit and solution from the second sweep side supply tank 110-2 is sent to second inlet of SRO unit to obtain a third concentrate stream and a third diluate solution having different osmotic pressures.

The third concentrate stream is fed to an empty third feed side receiving tank 101-3. The third diluate solution at the same osmotic pressure as diluate solution from first pass is sent to first feed side receiving tank 101-1 via ERD 501 and HPP 503. At the end of pass 3 both supply tanks 101-2 and 110-2 are empty. In pass 4 at time t=t4 solution from the first feed side supply tank 101-1 is sent to first inlet of SRO unit and solution from the third sweep side supply tank 110-3 is sent to second inlet of SRO unit to obtain a fourth concentrate stream and a fourth diluate solution having different osmotic pressures. The fourth concentrate stream released from first outlet of SRO unit is fed to an empty second feed side receiving tank 101-2. Fourth diluate solution released from second outlet of SRO at diluate osmotic pressure or solute concentration defined by the predetermined separation duty is removed from the system. At the end of pass 4 both supply tanks 101-1 and 110-3 may be empty. Residual solutions remain in second and third feed tanks 101-2 and 101-3 respectively. These solutions may be further split in subsequent passes to yield final solutions defined by predetermined separation duty. In further variations of the above process, additional residual solutions may remain between passes in other feed and sweep tanks mentioned. In such instances, these solutions may be mixed with solutions of same or similar osmotic pressures with a tolerance acceptable for that application. In the above description an exemplary case where this may be achieved is in pass 3 when a portion of third diluate solution at same osmotic pressure as first diluate solution may be fed to third sweep side receiving tank 110-3 which already contains the first diluate solution. This combined solution in tank 110-3 may be processed in subsequent passes.

In instances where it is not possible to split all of the initial solution into concentrate and diluate solutions defined by the predetermined separation duty, it may be decided to terminate the batch or semi-batch with unconverted residual solutions at concentrations different from that defined by separation duty. These residual solutions could be stored and carried over to subsequent batch or semi-batch where they are processed further. Alternative method of finishing a batch or semi-batch is to run the residual solutions in recirculation mode to achieve solutions defined by the predetermined separation duty. The above process explains batch with bleed streams mode of operating the system.

The embodiment in FIG. 3B may be operated as semi-batch with bleed streams mode of operation as follows. During a similar process to that explained for batch with bleed streams above, process solution may be added to any of the feed or sweep tanks during the separation process described above where it mixes with a solution already present in the tank and the combined solution is processed in the same separation process, then the process becomes semi-batch with bleed streams for the corresponding side(s) where this addition is done.

The embodiment in FIG. 3B may also be operated without bleed streams. The system operates similar to the above batch with bleed streams mode except that in this operation mode there are no bleed streams. The feed side solution shall not be mixed with sweep side solution and sweep side solution shall not be mixed with feed side solution. This process is batch without bleed streams mode of operating the system.

The embodiment in FIG. 3B may also be operated as semi-batch without bleed streams as follows. In this mode, the system operates similar to the above batch without bleed streams with an additional provision that external process solution may be added to any of the feed or sweep tanks during the separation process where it mixes with a process solution already present in the tank and the combined solution is processed in the same separation process, then the process become semi-batch without bleed streams for the corresponding side(s) where this addition is done.

In various embodiments of system 2200 in FIG. 3E two types of indirect hydraulically pressurized feed tanks are implied. First type of tanks that may be used are indirect hydraulically and pneumatically pressurized feed tanks with constant total volume as shown in FIG. 1G. Each chamber of each feed side tank is hydraulically connected to feed side circulation pump 504, HPI of ERD 501-1, outlet of BP 502, outlet of HPP 503, high pressure side of PRV 530 and first outlet 1.2 of SRO unit 100. Each sweep side tank is connected to sweep side circulation pump 505, second outlet 2.2 of SRO unit 100, LPO of ERD 501-4 and external process solution supply (2200-F and 2200-S). In this embodiment combination of HPP 503, BP 502 and ERD 501 may be used to compensate for changes to total solution volume of system and regulate system pressure. This is explained as follows.

During operation, in order to maintain system pressure, hydraulic fluid flows from the hydraulic chamber of receiving tank for that pass to hydraulic chamber of supply tank for that pass. Further, total volume of process solution decreases during operation due to removal of permeate solution through SRO unit. This volume reduction will tend to reduce system pressure. To prevent loss in system pressure corresponding volume of hydraulic solution is pumped through high pressure pump 503 to the hydraulic chamber of the corresponding feed tanks. Still further loss in total volume of process solution occurs when solution is removed from the system as concentrate or diluate streams meeting predetermined separation duty. To prevent related system pressure drop, the solution being removed from the high pressure region of the system is removed through ERD 501 and corresponding volume of hydraulic solution 2200-HI is supplied through ERD 501. A booster pump BP 502 at the high pressure outlet HPO 501-2 of ERD 501 is used to bring the incoming solution to required pressure. When operated with process solution in both chambers as described above with the addition of external process solution to at least one of the chambers, it is possible to achieve semi-batch operation using a tank with at least two chambers.

Another type of tank that may be used is indirect hydraulically and pneumatically pressurized feed tanks with constant total volume as shown in FIG. 1N. Here more than two chambers are used to achieve the separation through multiple passes. When using two chambers for process solution and a third chamber for hydraulic fluid in a three chamber tank, pass level separation may be achieved in non-recirculation mode whereby, a pass level feed solution is supplied from a supply chamber and a pass level concentrate solution is collected in a receiving chamber. Here the process solution in the supply chamber is hydraulically isolated from process solution in the receiving chamber. Similarly the method of using supply and receiving chambers may be extended when using more than three chambers.

In various embodiments of system 2300 in FIG. 3C, two types of feed tanks that may be used. The first one is indirect hydraulically and piston pressurized tanks with variable total volume as shown in FIG. 1H. Each chamber of each tank is hydraulically connected to feed side circulation pump 504, HPI of ERD 501-1, outlet of BP 502, outlet of HPP 503, high pressure side of PRV 530 and first outlet 1.2 of SRO module 100. The piston 130 in the tank permits adjustments to total volume of solutions in both chambers. This feature offers unique advantages. It enables batch operation without recirculation to be achieved using a single tank. In such operation process solution shall flow from the supply chamber of feed tank to SRO module and returns to receiving chamber in the same feed tank. The sweep tanks are connected to sweep side circulation pump 505, second outlet 2.2, LPO of ERD 501-4 and external process solution supply (2300-F and 2300-S). In this embodiment combination of piston 130 and HPP 503, BP 502 and ERD 501 may be used to compensate for changes to total fluid volume of system and regulate system pressure. This is explained as follows. During operation, in order to maintain system pressure, hydraulic fluid flows from the hydraulic chamber of receiving tank for that pass to hydraulic chamber of supply tank for that pass. Total volume of process solution contained in supply tank, receiving tank and interconnecting conduits decreases during operation due to removal of permeate solution through SRO unit. This embodiment offers two measures to prevent loss in system pressure due to volume reduction for batch mode of operation. One method similar to embodiment without piston above, pumps a volume of hydraulic solution through high pressure pump 503 to the hydraulic side of the movable partition of the feed tanks corresponding to permeate solution removed. Another method unique to this embodiment, is using piston movement to adjust for change in total fluid volume. In this case the piston shall move so as to reduce the total volume and maintain required system pressure. Still further loss in total volume of process solution occurs when solution is removed from the system as concentrate or diluate streams defined by predetermined separation duty. To prevent related system pressure drop, the solution being removed from the system is removed through high pressure inlet HPI 501-1 of ERD 501 and corresponding volume of hydraulic solution 2300-HI is supplied to low pressure inlet LPI 501-3 of ERD 501. A booster pump BP 502 at the high pressure outlet HPO 501-2 from the ERD 501 is used to bring the incoming solution to required pressure. Alternatively, piston position shall be adjusted to maintain required system pressure.

Another tank that may be used in FIG. 3C is the indirect hydraulically and pneumatically pressurized feed tanks with more than three chambers and constant total volume as shown in FIG. 1N. Although the total volume of three or more chambers is constant, when hydraulic fluid is used in one of the chambers, the total volume of process solution in the other two chambers may be varied. This tank could be used instead of tank 1H used in system 2300, where the hydraulic fluid replaces the function of a piston. Additional aspects common to both types of feed tanks FIG. 1N and FIG. 1H used in the embodiments in FIG. 3C are explained below. In certain operations, process solution may be used to apply pressure on the feed side process solution. In one batch this process solution behaves as a hydraulic fluid for pressurizing the system. In the next batch this process solution may be used as feed side process solution whereby it is processed in the SRO unit. Accordingly process connections to the tank chambers would change. Feed solution from feed tanks 101-1, 101-2 and 101-3 feed the first inlet 1.1 of SRO module 100. Sweep solution from the sweep tanks 110-1, 110-2, 110-3 feed the second inlet 2.1 of the SRO module 100. While depressurizing the system, hydraulic fluid may be removed from the system via PRV 530. Continuous removal through PRV 530 results in loss of system pressure without energy recovery and is preferably not used during separation process.

The system 2300 as shown in FIG. 3C may include at least 1, 2, 3 or more feed and sweep tanks. An exemplary mode of operating the system is as follows. Hydraulic solution not processible at the SRO unit is used in the hydraulic chamber and process solution is used as feed solution in the feed chamber. The system begins with process solution filled in feed chambers of feed side tank 101-1 and sweep side tank 110-2. Remaining tanks are empty. The system operates in non-recirculation mode as follows. In pass 1 at a time t=t₁, solution from the first feed side supply tank 101-1 is fed to the first inlet of SRO unit and solution from the second sweep side supply tank 110-2 is fed to the second inlet of SRO unit to obtain a first concentrate and a first diluate solution having different osmotic pressures. A portion of the first concentrate is fed to an empty first sweep side receiving tank 110-1 via ERD 501 (pressure zone interface). Remaining portion of first concentrate from the SRO unit is fed to an empty third feed side receiving tank 101-3. The first diluate solution is fed to an empty third sweep side receiving tank 110-3. At the end of pass 1 both supply tanks 101-1 and 110-2 are empty. In pass 2 at time t=t₂ solution from the third feed side supply tank 101-3 containing a portion of concentrate stream from pass 1 is fed to the first inlet of SRO unit and solution from first sweep tank 110-1 containing a portion of concentrate stream from pass 1 is fed to the second inlet of SRO unit to obtain a second concentrate and a second diluate solution having different osmotic pressures. Second concentrate stream from the SRO unit at concentrate osmotic pressure or solution concentration defined by the predetermined separation duty is removed from the system via the ERD 501. A portion of the second diluate solution at osmotic pressure equal to that of feed solution in pass 1 is fed to an empty second feed side receiving tank 101-2 via ERD 501 and HPP 503. While the remaining second diluate solution is fed to an empty second sweep side receiving tank 110-2. At the end of pass 2 both supply tanks 101-3 and 110-1 are empty. In pass 3 at time t=t₃ solution from the second feed side supply tank 101-2 is sent to first inlet of SRO unit and solution from the second sweep side supply tank 110-2 is sent to second inlet of SRO unit to obtain a third concentrate stream and a third diluate solution having different osmotic pressures.

The third concentrate stream is fed to an empty third feed side receiving tank 101-3. The third diluate solution at the same osmotic pressure as diluate solution from first pass is sent to first feed side receiving tank 101-1 via ERD 501 and HPP 503. At the end of pass 3 both supply tanks 101-2 and 110-2 are empty. In pass 4 at time t=t₄ solution from the first feed side supply tank 101-1 is sent to first inlet of SRO unit and solution from the third sweep side supply tank 110-3 is sent to second inlet of SRO unit to obtain a fourth concentrate stream and a fourth diluate solution having different osmotic pressures. The fourth concentrate stream is fed to an empty second feed side receiving tank 101-2. Fourth diluate solution from the SRO unit at diluate osmotic pressure or solute concentration defined by the predetermined separation duty is removed from the system. At the end of pass 4 both supply tanks 101-1 and 110-3 may be empty. Residual solutions remain in second and third feed tanks 101-2 and 101-3 respectively. These solutions may be further split in subsequent passes to yield final solutions defined by predetermined separation duty. In further variations of the above process, additional residual solutions may remain between passes in other feed and sweep tanks mentioned. In such instances, these solutions may be mixed with solutions of same or similar osmotic pressures with a tolerance acceptable for that application.

In the above description this may be achieved in pass 3 when a portion of third diluate solution at same osmotic pressure as first diluate solution may be fed to third sweep side receiving tank 110-3 which already contains the first diluate solution. This combined solution in tank 110-3 may be processed in subsequent passes. In instances where it is not possible to split all of the initial solution into concentrate and diluate solutions defined by the predetermined separation duty, it may be decided to terminate the batch with unconverted residual solutions at concentrations different from that defined by separation duty. These residual solutions could be stored and carried over to subsequent batch or semi-batch where they are processed further. Alternative method of finishing a batch or semi-batch is to run the residual solutions in recirculation mode to achieve solutions defined by the predetermined separation duty. The above process explains batch with bleed streams mode of operating the system.

The embodiment in FIG. 3C may be operated as semi-batch with bleed streams mode of operation as follows. During a similar process to that explained for batch with bleed streams above, external process solution may be added to any of the feed or sweep tanks during the separation process where it mixes with a solution already present in the tank and the combined solution is processed in the same separation process, then the process becomes a semi-batch with bleed streams for the corresponding side(s) where this addition is done.

The embodiment in FIG. 3C may also be operated without bleed streams. In this mode, the system operates similar to the above batch with bleed streams mode except that in this operation mode there are no bleed streams. The feed side solution shall not be mixed with sweep side solution and sweep side solution shall not be mixed with feed side solution. This process is batch without bleed streams mode of operating the system.

The embodiment in FIG. 3C may also be operated as semi-batch without bleed streams as follows. In this mode, the system operates similar to the above batch without bleed streams, with an additional provision for adding external process solution to any of the feed or sweep tanks during the separation process where it mixes with a process solution already present in the tank and the combined solution is processed in the same separation process, then the process become semi-batch without bleed streams for the corresponding side(s) where this addition is done.

In various embodiments the system 2400 may include direct hydraulically pressurized feed tanks system as shown in FIG. 3D. It employs feed tanks containing two immiscible fluids separated by the interface between them as shown in FIG. 1J. One fluid is the hydraulic fluid used to regulate pressure of feed side process solution while the other fluid is the feed side process solution. These fluids divide volume of feed tank into two regions. In the embodiment shown in FIG. 3D hydraulic region is at the top portion of the tank while process solution region is at the bottom portion of the tank. This would be the case when the density of hydraulic fluid is less than the density of process solution. Process solution region of each tank is hydraulically connected to feed side circulation pump 504, HPI of ERD 501-1, outlet of BP 502, outlet of HPP 503 and first outlet 1.2 of SRO module 100. Hydraulic solution region of each tank is hydraulically connected to HPI of ERD 501-1 and high pressure side of PRV 530. When the density of hydraulic fluid is greater than density of process solution, the hydraulic region shall occupy bottom portion of the tank while process solution region shall occupy top region of the tank. Accordingly the hydraulic connections of the tank shall be modified to maintain above said connections between the two fluid regions and other system components. In some applications the density of process solution changes during operation such that the relatively denser fluid at the start of the process becomes relatively lighter and vice versa. This causes reversal of positions of fluids in the tank. Accordingly hydraulic connections of tank regions with system components will change. Both regions of feed tanks in embodiment FIG. 3E are designed to permit filling them completely with hydraulic solution or process solution. Likewise the chambers may be emptied completely leaving minimal residual solution for improved process efficiency.

The sweep tanks are connected to sweep side circulation pump 505, second outlet 2.2, LPO of ERD 501-4 and external process solution supply (2400-F and 2400-S). Feed solution from feed tanks 101-1, 101-2 and 101-3 feed the first inlet 1.1 of SRO module 100. Sweep solution from the sweep tanks 110-1, 110-2, 110-3 feed the second inlet 2.1 of the SRO module 100. During operation, in order to maintain system pressure, hydraulic fluid flows from the hydraulic region of receiving tank for that pass to hydraulic region of supply tank for that pass. Further total volume of process solution decreases during operation due to removal of permeate solution through SRO unit. This reduction in total process solution volume will tend to reduce system pressure. To prevent loss in system pressure for batch mode of operation, similar to FIG. 3C above, a volume of hydraulic solution is pumped using high-pressure pump 503 corresponding to permeate solution removed to the hydraulic region of the feed tanks. Still further loss in total volume of process solution occurs when feed side solution is removed from the system as concentrate when a predetermined separation duty is achieved or as bleed streams. To prevent related system pressure drop, the solution being removed from the system is supplied to high pressure inlet HPI 501-1 of ERD 501 and corresponding volume of hydraulic solution 2400-HI is supplied to low pressure inlet LPI 501-3 of ERD 501. A booster pump BP 502 at the high pressure outlet HPO 501-2 of ERD 501 is used to bring the incoming solution to required pressure. While depressurizing the system hydraulic fluid may be removed from the system via PRV 530.

The system 2400 as shown in FIG. 3D may include at least 1, 2, 3 or more feed and sweep tanks. An exemplary mode of operating the system is as follows. The system begins with process solution filled in feed side tank 101-1 and sweep side tank 110-2. Remaining tanks are empty. The system operates in non-recirculation mode as follows. In pass 1 at a time t=t1, solution from the first feed side supply tank 101-1 is fed to the first inlet of SRO unit and solution from the second sweep side supply tank 110-2 is fed to the second inlet of SRO unit to obtain a first concentrate and a first diluate solution having different osmotic pressures. A portion of the first concentrate is fed to an empty first sweep side receiving tank 110-1 via ERD 501. Remaining portion of first concentrate from the SRO unit is fed to an empty third feed side receiving tank 101-3. The first diluate solution is fed to an empty third sweep side receiving tank 110-3. At the end of pass 1 both supply tanks 101-1 and 110-2 are empty. In pass 2 at time t=t2 solution from the third feed side supply tank 101-3 containing a portion of concentrate stream from pass 1 is fed to the first inlet of SRO unit and solution from first sweep tank 110-1 containing a portion of concentrate stream from pass 1 is fed to the second inlet of SRO unit to obtain a second concentrate and a second diluate solution having different osmotic pressures. Second concentrate stream from the SRO unit at concentrate osmotic pressure or solution concentration defined by the predetermined separation duty is removed from the system via the ERD 501. A portion of the second diluate solution at osmotic pressure equal to that of feed solution in pass 1 is fed to an empty second feed side receiving tank 101-2 via ERD 501 and HPP 503. While the remaining second diluate solution is fed to an empty second sweep side receiving tank 110-2. At the end of pass 2 both supply tanks 101-3 and 110-1 are empty. In pass 3 at time t=t3 solution from the second feed side supply tank 101-2 is sent to first inlet of SRO unit and solution from the second sweep side supply tank 110-2 is sent to second inlet of SRO unit to obtain a third concentrate stream and a third diluate solution having different osmotic pressures. The third concentrate stream is fed to an empty third feed side receiving tank 101-3. The third diluate solution at the same osmotic pressure as diluate solution from first pass is sent to first feed side receiving tank 101-1 via ERD 501 and HPP 503. At the end of pass 3 both supply tanks 101-2 and 110-2 are empty.

In pass 4 at time t=t4 solution from the first feed side supply tank 101-1 is sent to first inlet of SRO unit and solution from the third sweep side supply tank 110-3 is sent to second inlet of SRO unit to obtain a fourth concentrate stream and a fourth diluate solution having different osmotic pressures. The fourth concentrate stream is fed to an empty second feed side receiving tank 101-2. Fourth diluate solution from the SRO unit at diluate osmotic pressure or solute concentration defined by the predetermined separation duty is removed from the system. At the end of pass 4 both supply tanks 101-1 and 110-3 may be empty. Residual solutions remain in second and third feed tanks 101-2 and 101-3 respectively. These solutions may be further split in subsequent passes to yield final solutions defined by predetermined separation duty. In further variations of the above process, additional residual solutions may remain between passes in other feed and sweep tanks mentioned. In such instances, these solutions may be mixed with solutions of same or similar osmotic pressures with a tolerance acceptable for that application.

In the above description an exemplary case where this may be achieved is in pass 3 when a portion of third diluate solution at same osmotic pressure as first diluate solution may be fed to third sweep side receiving tank 110-3 which already contains the first diluate solution. This combined solution in tank 110-3 may be processed in subsequent passes. In instances where it is not possible to split all of the initial solution into concentrate and diluate solutions defined by the predetermined separation duty, it may be decided to terminate the batch with unconverted residual solutions at concentrations different from that defined by separation duty. These residual solutions could be stored and carried over to subsequent batch or semi-batch where they are processed further. Alternative method of finishing a batch or semi-batch is to run the residual solutions in recirculation mode to achieve solutions defined by the predetermined separation duty. The above process explains batch with bleed streams mode of operating the system.

The embodiment in FIG. 3D may be operated as semi-batch with bleed streams mode of operation as follows. During a similar process to that explained for batch with bleed streams above, external process solution may be added to any of the feed or sweep tanks during the separation process where it mixes with a solution already present in the tank and the combined solution is processed in the same separation process. Then the process becomes a semi-batch with bleed streams for the corresponding side(s) of the system where this addition is done.

The embodiment in FIG. 3D may also be operated as batch without bleed streams. In this mode, the system operates similar to the above batch with bleed streams mode except that in this operation mode there are no bleed streams. The feed side solution shall not be mixed with sweep side solution and sweep side solution shall not be mixed with feed side solution. This process is batch without bleed streams mode of operating the system.

The embodiment in FIG. 3D may also be operated as semi-batch without bleed streams as follows. In this mode, the system operates similar to the above batch without bleed streams, with an additional provision for adding external process solution to any of the feed or sweep tanks during the separation process where it mixes with a process solution already present in the tank and the combined solution is processed in the same separation process. Then the process become semi-batch without bleed streams for the corresponding side(s) of the system where this addition is done.

In various embodiments the system 2500 as shown in FIG. 3F may include direct hydraulically pressurized feed tanks system as shown in FIG. 1K. The system 2500 as shown in FIG. 3F may include at least 1, 2, 3 or more feed and sweep tanks. It employs feed tanks completely filled with process solution. Each tank is hydraulically connected to feed side circulation pump 504, HPI of ERD 501-1, outlet of BP 502, outlet of HPP 503, high pressure side of PRV 530 and first outlet 1.2 of SRO module 100. Feed tanks in embodiment FIG. 3E are designed to permit filling them completely with process solution. Likewise the feed tanks may be emptied completely leaving minimal residual solution for improved process efficiency. The feed side tanks may be pressurized towards end of the filling operation using high pressure pump HPP 503. The sweep tanks are connected to sweep side circulation pump 505, second outlet 2.2, LPO of ERD 501-4 and external process solution supply (2500-F and 2500-S). Feed solution from feed tanks 101-1, 101-2 and 101-3 feed the first inlet 1.1 of SRO module 100. Sweep solution from the sweep tanks 110-1, 110-2, 110-3 feed the second inlet 2.1 of the SRO module 100. During operation, total volume of process solution decreases due to removal of permeate solution through SRO unit. This reduction in total process solution volume will tend to reduce system pressure. To prevent loss in system pressure for batch mode of operation, a volume of process solution is pumped using high-pressure pump 503 corresponding to permeate solution removed to the supply feed tank. Still further loss in total volume of process solution occurs when process solution is removed from the system as concentrate or diluate streams meeting a predetermined separation duty. To prevent related system pressure drop, the solution being removed from the system is supplied to high pressure inlet HPI 501-1 of ERD 501 and corresponding volume of process solution 2500-F/2500-S is supplied to low pressure inlet LPI 501-3 of ERD 501. A booster pump BP 502 at the high pressure outlet HPO 501-2 from the ERD 501 is used to bring the incoming solution to required pressure. While depressurizing the system, process solution may be removed from the system via PRV 530.

An exemplary mode of operating the system is as follows. In the following description one feed tank which serves as both supply and receiving tank is connected to the system at a time while the other tanks are isolated. The process operates in the semi-batch without bleed streams mode of operation. The system operates in recirculation mode as follows. The system begins with process solutions in feed side tank 101-1, 101-2 and sweep side tank 110-2. Remaining tanks are empty. At time t=t1, solution from the first feed side supply tank 101-1 is fed to the first inlet of SRO unit and solution from the second sweep side supply tank 110-2 is fed to the second inlet of SRO unit to obtain a first concentrate and a first diluate solutions having different osmotic pressures. A portion of the first concentrate is fed to an empty first sweep side receiving tank 110-1 using the third conduit and via ERD 501. Remaining portion of first concentrate from the SRO unit is sent back to first feed side receiving tank 101-1. The first diluate solution is sent back to second sweep side receiving tank 110-2. The feed side process solution and sweep side process solutions are re-circulated continuously. At time t=t2 diluate from second outlet of SRO unit at the osmotic pressure or solution concentration of diluate stream defined by predetermined separation duty is removed from the system. At time t=t3, tank 110-2 is empty and is hydraulically disconnected from the system while first sweep side supply tank 110-1 is hydraulically connected to the second inlet of SRO module. This change over of sweep side tank from 110-2 to 110-1 is carried out without or with minimal interruption to separation process performed by the SRO system. The process continues with sweep solution supplied from sweep side supply tank 110-1. The diluate solution from second outlet of SRO unit is re-circulated back to same sweep side receiving tank 110-1.

The process continues in re-circulation mode on both feed and sweep sides until a time t=t4, when a concentrate stream defined by the predetermined separation duty is obtained in 101-1. Once this is achieved, 101-1 is isolated at its inlet and outlet connections from high pressure zone of the system. 101-2 is connected at its inlet to the outlet of Booster pump (BP 505) and to the outlet of High pressure pump (HPP 503) and the outlet of 101-2 is connected to inlet of circulation pump (504). This change over of feed side tank from 101-1 to 101-2 is carried out without or with minimal interruption to separation process performed by the SRO system. Subsequently 101-1 is depressurized and concentrate from 101-1 may be removed from the system by draining. Alternatively pressure in 101-1 may be transferred to another feed tank 101-2 or 101-3 and subsequently depressurized and drained. Subsequently empty feed tank 101-1 may be filled at low pressure with feed solution for next semi-batch. The process continues to achieve predetermined separation duty continuously. This process is semi-batch with bleed streams mode of operating the system.

The embodiment in FIG. 3F may also be operated as semi-batch without bleed streams. In this mode, the system operates similar to semi-batch with bleed streams except that in this operation mode there are no bleed streams. The feed or concentrate stream from the feed side solution shall not supply sweep solution to sweep tanks. Instead external process solution may be added to the sweep tanks. This process is semi-batch without bleed streams mode of operating the system.

In both the above modes of operation, the concentrate and diluate solutions at the osmotic pressures and solute concentrations of predetermined separation duty may be carried over to subsequent batches instead of being removed from the system. For instance at time t=t4, when a concentrate stream defined by the predetermined separation duty is obtained in 101-1, the solution may be retained and the 101-1 may be hydraulically isolated from the high pressure side of the system while 101-2 may be hydraulically connected to the high pressure side of the system. The system would continue to operate with feed side solution supplied from 101-2. At a later time or later semi-batch, 101-1 may be hydraulically connected and supply feed side solution to SRO unit. Thus the concentrate from one separation process may be carried over in a subsequent separation process. In a similar manner, diluate from a separation process may be carried over in a subsequent separation process.

In a further variation of the above process, these residual solutions may be mixed with solutions of same or similar osmotic pressures within a tolerance level acceptable for that application. In the above description an exemplary case where this may be achieved is at time t=t2 in semi-batch with bleed stream mode of operating embodiment in FIG. 3F instead of removing diluate solution from the system, it may be re-circulated back to sweep side tank 110-2 and stored. Subsequently 110-2 may be hydraulically disconnected and another sweep tank may supply sweep solution to the SRO unit. At a later time or later semi-batch, diluate solution from second outlet of SRO unit having osmotic pressure and solute concentration within an acceptable range from the osmotic pressure and solute concentration of residual solution in 110-2 may be sent to 110-2 and mixed with the residual solution. Subsequently or at a still later time 110-2 may be hydraulically connected and supply sweep side solution. Thus the diluate from one separation process may be mixed with diluate solution from another separation process and carried over in a subsequent separation process.

A generalized SRO system 3000 or semi-batch operation using holding chambers is shown in FIG. 3G. The system comprises of SRO unit 100 with an SRO membrane 104. The SRO unit has a feed side 100-1 and a sweep side 100-2. A feed side circulation loop connects first outlet 1.2 to first inlet 1.1 of SRO unit 100. Similarly, a sweep side circulation loop connects second outlet 2.2 to second inlet 2.1 of SRO unit 100. The system further comprises of feed side holding chamber (HC-1) 601 with at least two connections 601-1 and 601-2 for process solution transfer. Similarly the system comprises of sweep side holding chamber (HC-2) 602 with at least two connections 602-1 and 602-2 for process solution transfer. The holding chamber 601 and 602 are connected to the corresponding loops and to external connections for achieving process solution transfers necessary for system operation. The connection between feed side holding chamber 601 and feed side circulation loop is controlled by valves 405-2 and 405-3, while the connection between HC-1 601 and external transfers is controlled by valves 405-7 and 405-8. The valve 405-1 in the feed loop is used to control fluid circulation in the feed loop necessary for semi-batch operation and for exchanging process solution with HC-1 during solution changeover sequence. Similarly the connection between sweep side holding chamber 602 and sweep side circulation loop is controlled by valves 405-5 and 405-6, while the connection between HC-2 602 and external transfers is controlled by valves 405-9 and 405-10. The valve 405-4 in the sweep loop is used to control fluid circulation in the sweep loop necessary for semi-batch operation and for exchanging process solution with HC-2 during solution changeover sequence. Circulation pumps 504 and 505 in the feed and sweep loops are used to circulate the process solutions in the respective loops during system operation. In some embodiments, bleed streams 100-FB and 100-CB from feed side convey feed side solution to the sweep side while bleed streams 100-DB and 100-SB from sweep side convey sweep side solution to the feed side. Streams 100-FB and 100-CB are at high pressure and shall be depressurized from feed side solution pressure to sweep side solution pressure. In some embodiments, it may be depressurized through a pressure-reducing valve (PRV) 530. While in other embodiments, it may be depressurized through an energy recovery device (ERD) 501 whereby its energy is recovered into the incoming process solution added to the feed circulation loop. A booster pump (BP) 502 may be used at the HPO of ERD 501 to bring the process solution to feed side pressure. HPP pump 503 may be used to add process solution to feed side during system operation. This additional volume typically corresponds to feed side solution volume removed as bleed and permeate. Likewise diluate solution may be removed from sweep side through stream ZZZZ-D. This typically corresponds to net increase of sweep side solution volume accounting for permeate quantity added and sweep solution removed as bleed streams ZZZZ-DB and ZZZZ-SB. Further external sweep solution may be added directly to sweep side circulation loop via stream ZZZZ-S. The quantity, addition or removal of process solution volumes are performed to achieve desired system operating conditions such as concentration, volume or pressure.

The process sequence begins with filling of feed loop (1.1-1.2-1.3-1.4) and sweep loop (2.1-2.2-2.3-2.4) with feed side and sweep side solutions respectively. Initial process solution in the loops may be same or different. In the embodiments described herein, the process solution may be supplied from a common feed stream 3000-F to all parts of the system. Alternatively different process solution may feed different parts of the system. This method of operation is as follows, feed stream 3000-F2 supplies the feed loop holding chamber 601, feed stream 3000-F3 supplies the feed loop 1.1-1.2-1.3-1.4-1.1 of SRO unit 100, sweep stream 3000-S1 supplies the sweep loop 2.1-2.2-2.3-2.4-2.1 of SRO unit 100 and sweep stream 3000-S2 supplies the sweep loop holding chamber 602. Once the process solutions have been filled, their circulation is started in both the circulation loops. Feed side circulation pump 504 circulates feed side solution in the feed circulation loop. Sweep side circulation pump 505 circulates sweep side solution in the sweep circulation loop. For an exemplary SRO membrane with positive solute rejection, feed circulation loop pressure is increased by using high pressure pump 503. As the net hydraulic pressure exceeds the net difference in osmotic pressure, permeate solution begins to flow from feed side to sweep side of SRO unit. Such an arrangement with multiple feed streams and sweep streams may be required for transient and ad-hoc separation duties such as sequentially performing different separation duties using a single SRO system. The SRO system may be operated without bleed streams whereby there is no exchange of process solution between feed and sweep sides. Alternatively the SRO system may be operated with bleed streams thereby exchanging process solution between the two sides of SRO system.

Filling the loops may be achieved directly from feed or sweep supply without using the holding chambers 601 on the feed side and 602 on the sweep side. However for continuous operation the preferred method involves making use of a first holding chamber 601 for feed loop and a second holding chamber 602 for sweep loop. This process may be referred to as charging of holding chambers. Process sequence is as follows, 601 and 602 are charged with feed solution and/or sweep solution respectively. This charging is accomplished in parallel to an operation cycle performed in the corresponding SRO system. During the charging process previous solution in the chambers are discharged. For continuous operations, previous solutions are system level process solutions from the respective loops at the end of previous semi-batch. During system start-up, the previous solutions may be solutions used for flushing the system before it was last shut down. Charging of 601 for feed loop is accomplished by opening valves 405-7 and 405-8 while valves 405-2 and 405-3 stay closed. Similarly charging of 602 for sweep loop is accomplished by opening valves 405-9 and 405-10 while valves 405-5 and 405-6 remain closed. Charging process is complete when the charged solution is pressurized to a pre-determined pressure. When charging 601 the solution in the chamber and in the piping between valves 405-8, 405-3, 405-2 and 405-7 is pressurized. This is done to maximize pressure recovery from the concentrate solution in the feed loop during solution change over. This improves overall process efficiency. Similarly, when charging 602, the solution in the chamber and in the piping between valves 405-9, 405-5, 405-6 and 405-10 is pressurized. During the semi-batch, when using membranes with positive solute rejection feed loop solution concentration increases from the initial feed solution concentration while sweep loop solution concentration decreases from the initial sweep solution concentration. Valves 405-1 in feed loop and 405-4 in sweep loop are kept open during the semi-batch. Additionally during the semi-batch, constant volume is maintained in the sweep loop for instance by bleeding volume gained due to permeate addition in sweep loop. Similarly during the semi-batch, constant volume is maintained in the feed loop for instance by adding feed solution by HPP pump into the feed loop to make-up for volume lost due to permeate removal from feed loop. However HPP pump also has the added function of increasing pressure in feed loop as the batch progresses. Further volume compensation is made in both the loops corresponding to bleed streams removal, bleed streams addition and external process solution addition.

The semi-batch process is continued until desired process end condition is met. The system may be operated in such a manner that the process end condition may be met for both circulation loops simultaneously or independently. After a pre-determined concentration, gauge pressure, semi-batch recovery, process time or volumetric basis, the semi-batch ends and solution in both the loops are replaced in a solution change over sequence without stopping the process, with minimal mixing between solutions of different concentrations and within minimal duration. This continuous interruption free separation is crucial to this embodiment as it enables practical realization of the technology. This continuous separation concept during solution changeover is applicable to all other embodiments described in this invention and serves as an integral part of their operation and as a distinguishable feature of this invention. The volume of individual loops may be optimized depending on the application. This includes providing volume accumulating devices (not shown in figure) in the loops. Solution change over in feed loop is accomplished by opening valves 405-2 and 405-3 and closing valves 405-1, 405-7 and 405-8. This allows first circulation pump 504 on the feed side to push the feed side solution from the feed loop into holding chamber 601 while simultaneously transferring process solution from 601 into the feed loop. Equipment and process design may be optimized to reduce mixing between the two solutions. Similarly solution changeover in sweep loop is accomplished by opening valves 405-5 and 405-6 and closing valves 405-4, 405-9 and 405-10. This allows second circulation pump 505 on the sweep side to push the sweep side solution from the sweep loop into holding chamber 602 while simultaneously transferring process solution from 602 into the sweep loop. Preferably solution change over in both the loops is accomplished simultaneously. However unsynchronized and independent timings may also be followed for solution change over in either of the loops.

When the solution changeover is not synchronized, the semi-batch in each loop may progress along a different trajectory. This means that the percentage of semi-batch completed in each loop may be different at a given instant. At the end of solution change over sequence, initial process solution for next semi-batch is present in the respective loops and this allows continuation of subsequent semi-batch. It is also possible to change the initial process solution in each instance such that consecutive semi-batches in a loop may not start with the same initial solution. Such feature may be required when using the same SRO unit for multiple separation duties with different initial and final solutions. After the solution change over sequence, solution charging in the respective holding chamber occurs. This fills the respective HC chambers with feed/sweep solution for next operation cycle while simultaneously discharging final system level concentrate solution 3000-C from feed side holding chamber 601 and system level diluate solution 3000-D from sweep side holding chamber 602 both of them produced in a previous semi-batch. Likewise the process continues with further semi-batches and/or separation duties.

During an operation cycle system level diluate solution XXXX-D may be discharged continuously from the sweep side circulation loop directly and system level feed solution XXXX-F may be added continuously to the feed side circulation. An essential variation of system configuration shall include the following. More than one holding chambers may be connected to a single loop and more than one loop may be connected to a single holding chamber. Such an arrangement may be useful when optimizing the utilization of system components in certain applications and for synchronizing multiple systems to achieve larger separation duties, for instance in an array of SRO systems with holding chambers.

The described arrangement is particularly important for solution change over that occurs between completion of a semi-batch and beginning of next semi-batch. By this arrangement a true semi-batch osmotically assisted separation may be achieved as a continuous process.

The invention in its various embodiments, proposes a system derived from the embodiment described in FIG. 3G for semi-batch operation. This embodiment does not consist of bleed streams. The process solutions in the two loops of the SRO unit 100 are hydraulically isolated from each other. Since there are no bleed streams, these embodiments may operate without PRV or ERD. When these SRO units are combined in an array configuration, they form internally isolated SRO arrays with holding chambers. High pressure pump (HPP) 503 is used to add solution to the feed side in addition to the solution added by ERD and regulate the operating pressure on feed side of SRO unit. As an exemplary embodiment of supplying a common process solution to the system, all feed and sweep solutions may be supplied from a single tank.

The invention in its various embodiments, proposes a system for semi-batch operation of the system 3100, as shown in FIG. 3H. This embodiment is derived from the general embodiment. described in FIG. 3G. This embodiment consists of bleed streams from feed side solution to sweep side solution via a pressure reducing valve (PRV). It also consists of bleed streams from sweep side solution to feed side solution. These bleed streams permit transfer of solution from one side of the SRO unit to the other. These features are useful and become necessary in certain applications. An exemplary case would be the change in concentration of solute in a loop due an imbalance between its inflow and outflow to and from the loop when staged in an array. This could result from the difference in membrane rejection performance and operating conditions of the current and linked SRO stages. By using bleed streams this effect may be compensated and thereby the system may maintain required solute concentration in the loop.

The invention in its various embodiments, proposes a system 3200 as shown in FIG. 3I for semi-batch operation. This system configuration is derived from the embodiment described in FIG. 3G. Similar to the embodiment in FIG. 3H, this embodiment consists of bleed streams from feed side solution to sweep side solution and bleed streams from sweep side solution to feed side solution. Both bleed streams flow via an energy recovery device (ERD) 501 which works in tandem with BP 502 and HPP 503 as described earlier.

The process may be operated with different set of target performance metrics. In an exemplary embodiment, the permeate flux defined as the flow per unit membrane area per unit time may be maintained constant throughout the process.

In order to maintain, constant sweep loop volume, it is necessary to remove sweep solution from the loop continuously. This solution removal is accomplished through stream 3000-D as shown in FIG. 3G. Once the process end condition is reached, a solution change over sequence is initiated where solutions in the loops that are undergoing changeover is switched with solutions in the corresponding holding chambers. During operation, process solution is continuously added to both the holding chambers. This serves the purpose of displacing previous solution in the chamber and filling the chamber with solution required for subsequent process cycle.

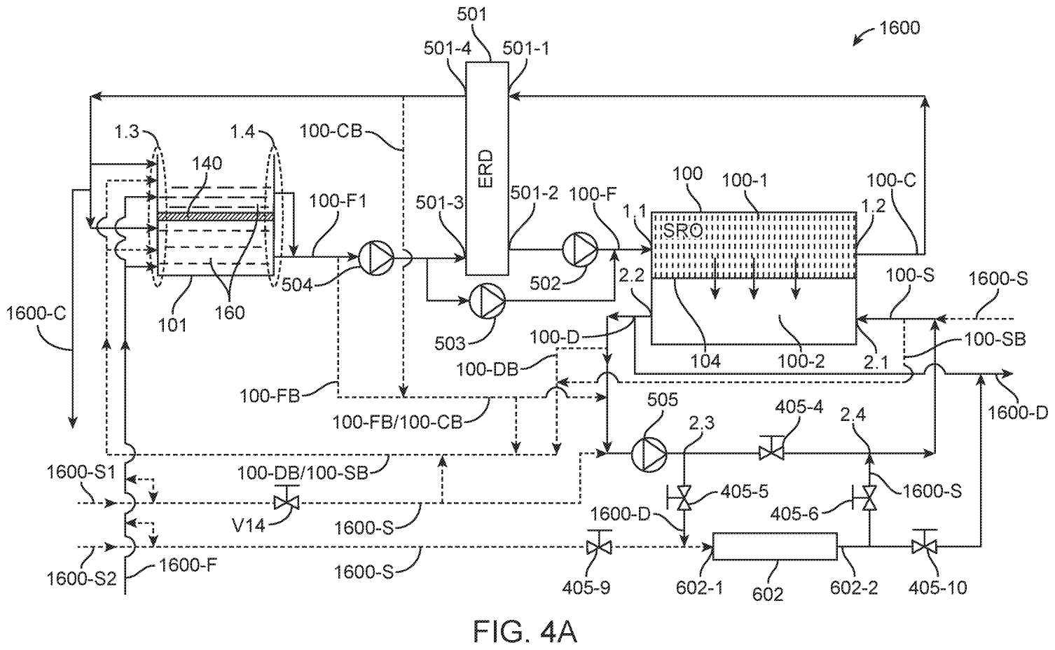

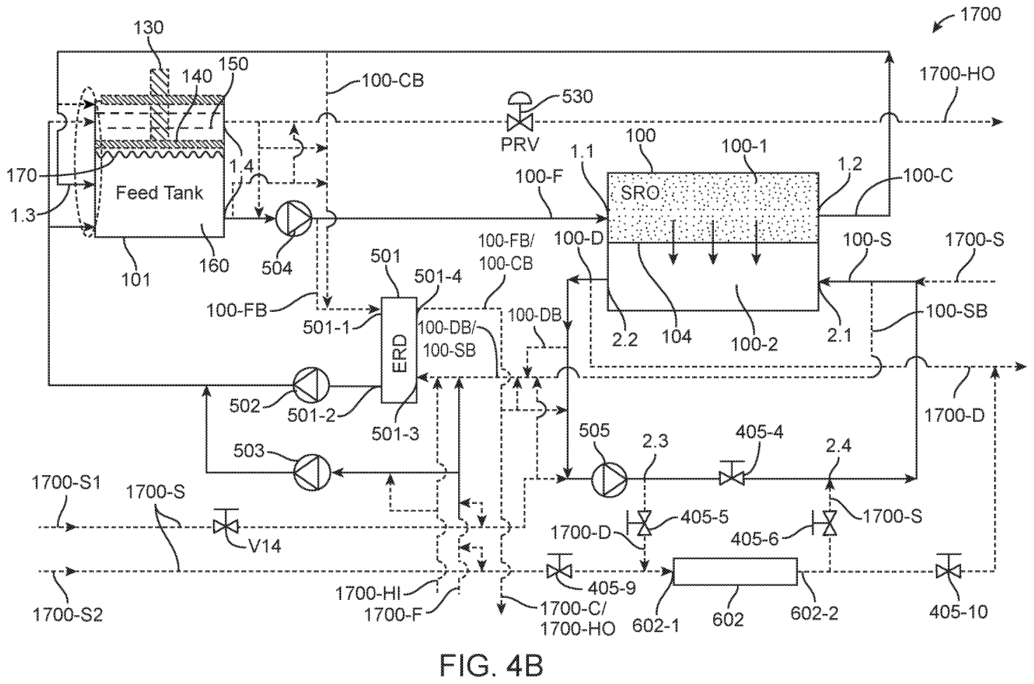

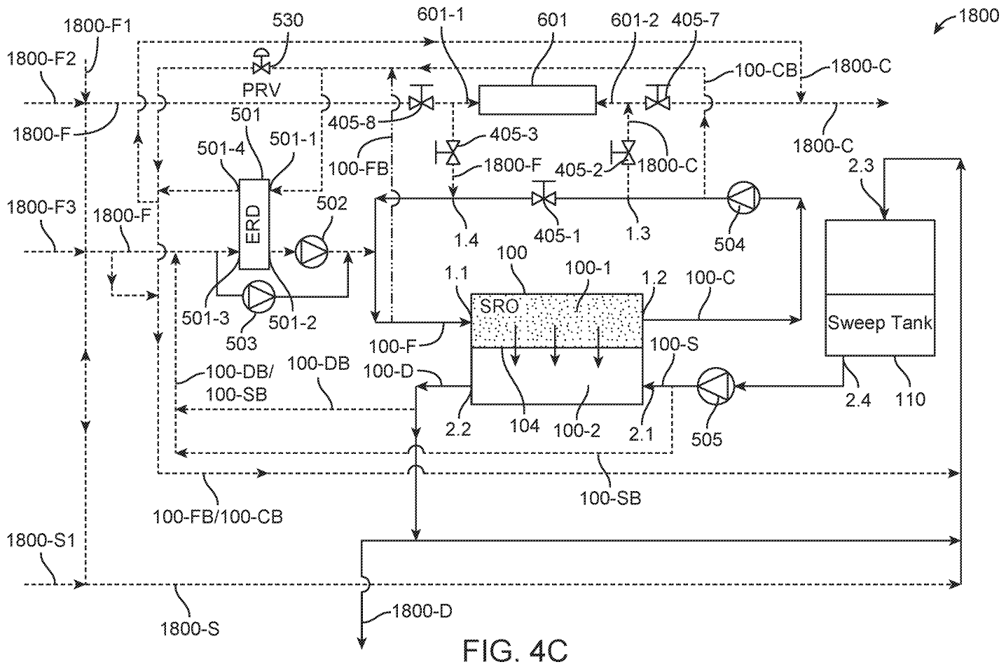

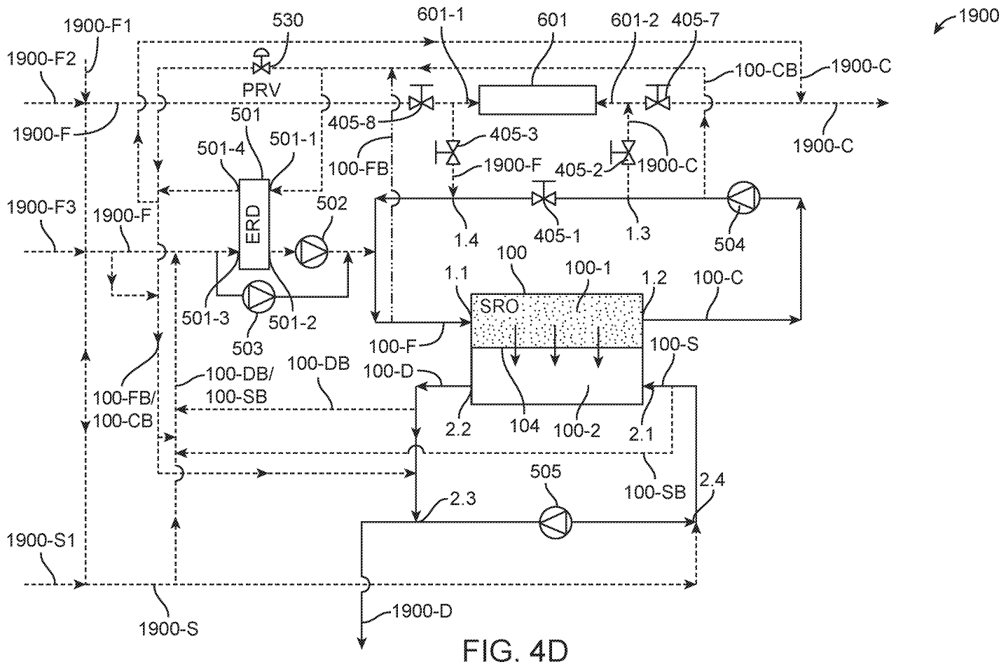

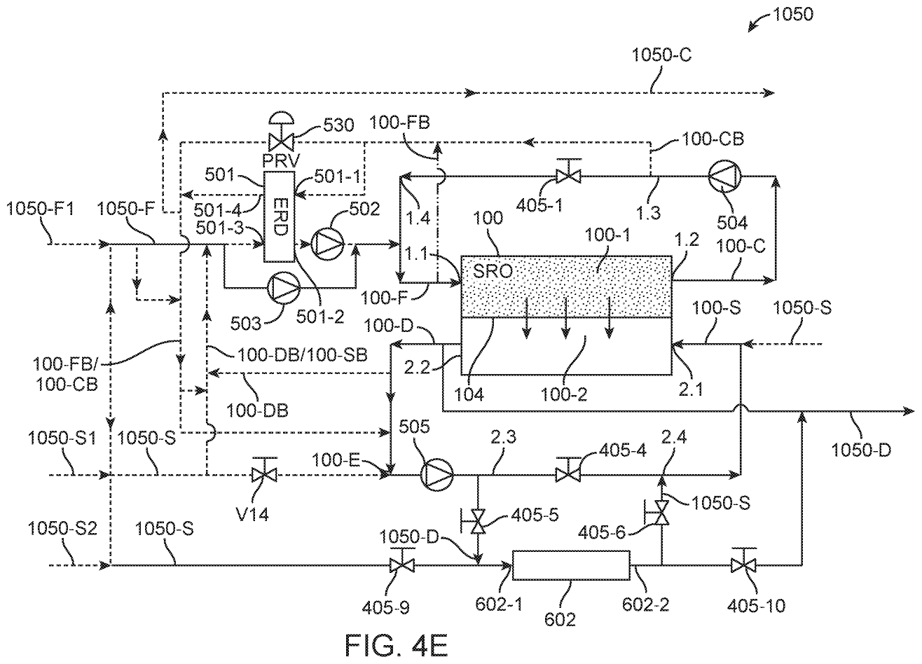

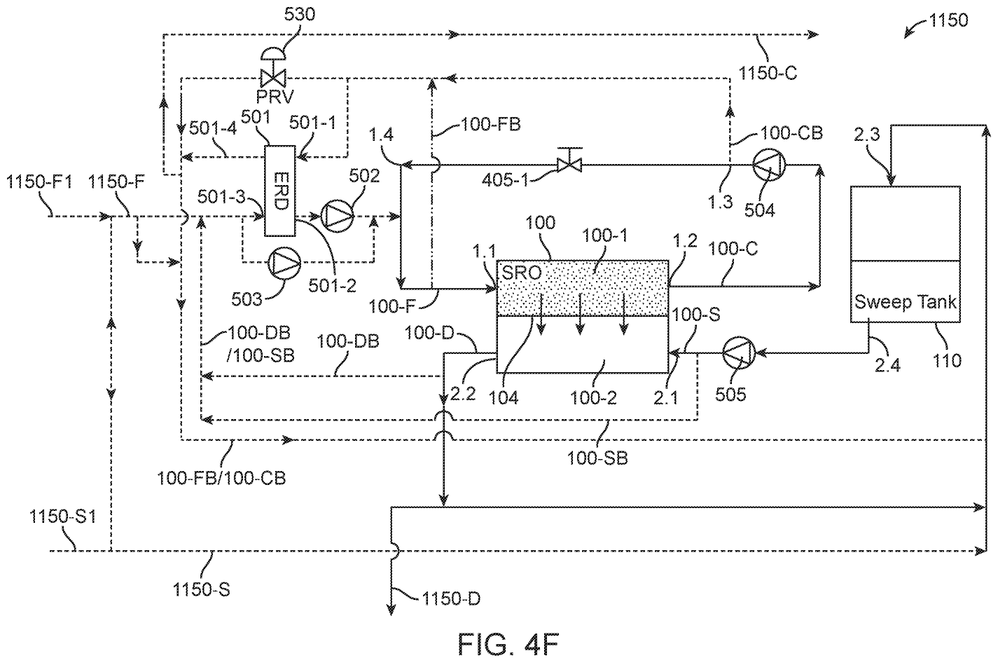

Batch and semi-batch operation of SRO system may be achieved using a combination of features of SRO systems with tanks, holding chambers and direct external process solution supply/removal as shown in FIG. 4A to FIG. 4F. Further it is also possible to achieve batch and semi-batch operation on one circulation loop while the other operates on a continuous basis. These configurations enable elimination of tanks from the sides of an embodiment that does not require batch mode of operation, thereby reducing the cost and footprint of SRO system. In following embodiments although only one tank and one holding chamber is depicted in the figures, it must be understood that more than one tank and/or holding chambers could be used. SRO systems with combination of features are summarized in the table below.

TABLE 1
Process combinations possible in feed and sweep loops of SRO
embodiments disclosed in the invention

| | | Feed loop operation | | |
|---|---|---|---|---|
| | | Batch | Semi-batch | Continuous |
| Sweep loop | Batch | Yes | Yes | Yes |
| operation | Semi-batch | Yes | Yes | Yes |
| | Continuous | Yes | Yes | Prior Art |

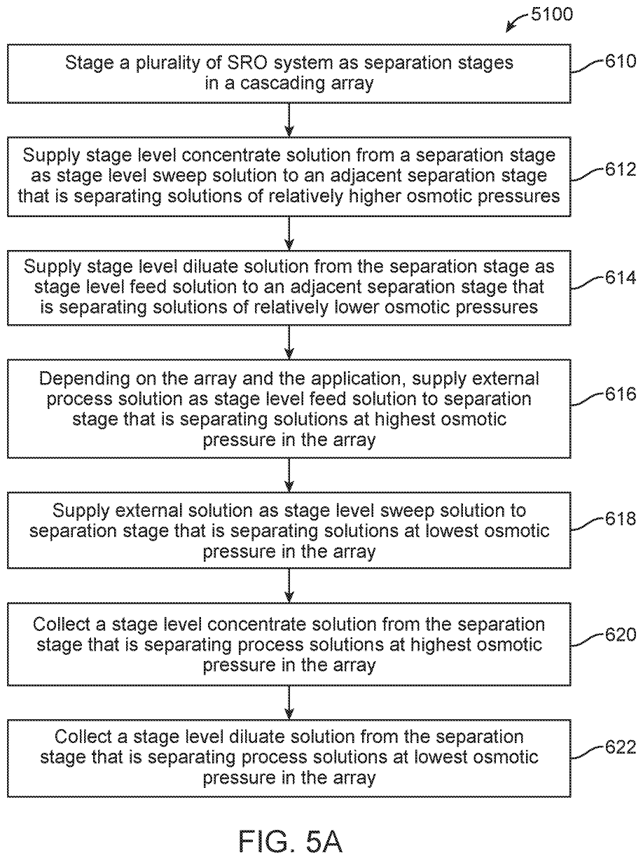

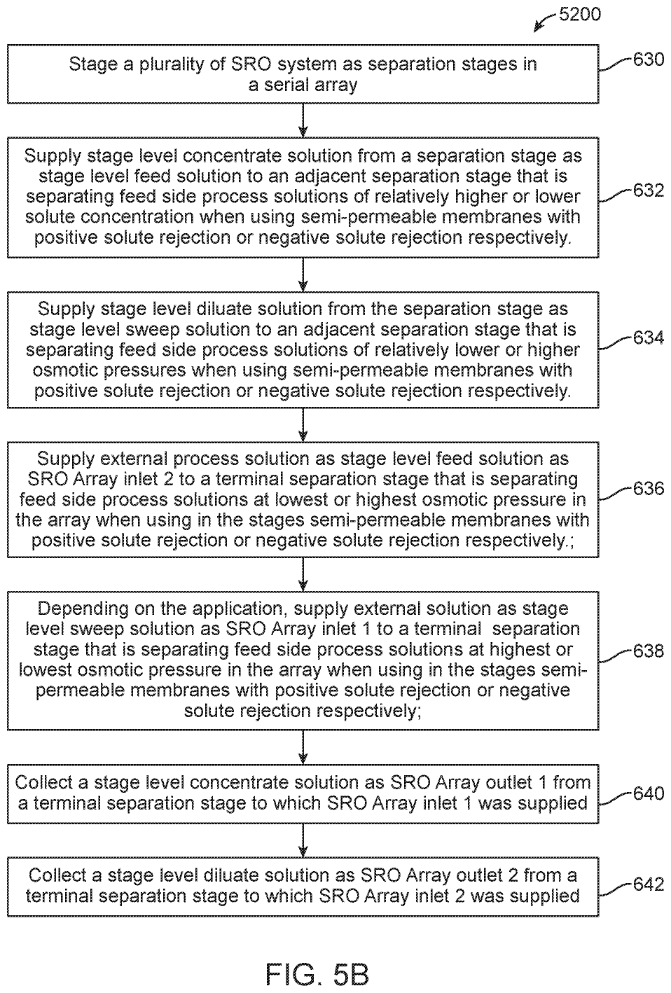

TABLE 2
System configurations possible in feed side and sweep side of SRO
embodiments disclosed in the invention

| | | Configuration | | | |
|---|---|---|---|---|---|
| | | | | | Continuous |
| | | Holding | | | bleed and/or |
| FIG. | System side | chambers | Pressurized Tanks | Unpressurized Tanks | external source/sink |
| FIG. 2B | Feed side | | | Yes | |
| | Sweep side | | | Yes | |
| FIG. 2D | Feed side | | Yes | | |
| | Sweep side | | | Yes | |
| FIG. 2A | Feed side | | | Yes | |
| | Sweep side | | | | Yes |
| FIG. 2C | Feed side | | Yes | | |
| | Sweep side | | | | Yes |
| FIG. 5A | Feed side | Yes | | | |
| | Sweep side | Yes | | | |
| Hybrid 1 | Feed side | Yes | | | |
| | Sweep side | | | | Yes |
| Hybrid 2 | Feed side | | | | Yes |
| | Sweep side | Yes | | | |
| Hybrid 3 | Feed side | Yes | | | |
| | Sweep side | | | Yes | |
| Hybrid 4 | Feed side | | | Yes | |
| | Sweep side | Yes | | | |
| Hybrid 5 | Feed side | | Yes | | |
| | Sweep side | Yes | | | |
| Hybrid 6 | Feed side | | | | Yes |
| | Sweep side | | | Yes | |

The invention in its various embodiments, proposes methods for batch or semi-batch operation of the systems 1100, 1200, 1300, 1400 shown in FIG. 2A to 2D, for system 2000 to 2500 shown in FIG. 3A to 3F, for system 3000, 3100, 3200 shown in FIG. 3G to 3I and for systems 1600, 1700, 1800, 1900, 1050 and 1150 shown in FIG. 4A to 4F. In these embodiments, a system level feed solution ZZZZ-F from an external source is supplied to the feed side of SRO system where it may be collected in one of at least one feed tank 101-X, collected in at least one feed side holding chamber 601 or supplied directly to feed side circulation loop. Similarly, a system level sweep solution ZZZZ-S from an external source may be supplied to the sweep side of SRO system where it may be collected in one of at least one sweep tank 110-Y, collected in at least one sweep side holding chamber 602 or supplied directly to sweep side circulation loop. X and Y correspond to respective feed and sweep tank numbers and ZZZZ corresponds to system number. This generalized nomenclature shall be used in the following description. The external source supplying system level feed solution may be same as the external source supplying system level sweep solutions or may be different. The system level process solutions are then processed in the SRO system in multiple passes as explained earlier. In some embodiments the SRO unit on one side operates directly on external source and external sink of process solution without recirculation of pass level solution from an outlet to inlet on same side of SRO unit. Here the circulation loop on the said side achieves separation in a single pass similar to a continuous process. When operating with recirculation a portion of the pass level solution from the outlet is recirculated from the outlet to inlet on the same side of SRO unit, thereby operating in multiple passes. When a circulation loop is operated using tanks and holding chambers separation is performed in multiple passes through the SRO unit 100. When operating in multiple passes separation is achieved in every pass through the SRO unit. In every pass, a Pass level feed solution 100-F and pass level sweep solution 100-S enter the feed side 100-1 and the sweep side 100-2 SRO unit 100. Upon application of pressure on process solution in feed side circulation loop, permeate solution is transferred from first side 104-1 to second side 104-2 of semi-permeable membrane 104. Correspondingly in every pass, a pass level concentrate solution 100-C and a pass level diluate 100-D solution are produced. The process continues with additional passes until a required separation is achieved whereby a system level concentrate solution ZZZZ-C and a system level diluate solution ZZZZ-D are produced in the feed side and sweep side circulation loops respectively. They may be removed from the system as described earlier. The system continues to a subsequent operation cycle repeating the steps above. Overall the systems are configured to continuously receive system level process solutions and discharge system level process solutions. This continuous separation of system level feed and sweep solutions into system level concentrate and system level diluate solutions is achieved through multiple passes through the SRO unit there by achieving a batch, semi-batch or continuous separation on the circulation loops.

In certain operations bleed streams are used for regulating process solution composition in the circulation loop. Feed 100-FB and concentrate 100-CB bleed streams transport feed side solution from feed side to sweep side of SRO system ZZZZ. Sweep 100-SB and diluate 100-DB bleed streams transport sweep side solution from sweep side to feed side of SRO system ZZZZ.

In certain methods, one circulation loop may be supplied entirely by process solution from the other circulation loop. An exemplary application may be described as follows. An embodiment with feed side and sweep side circulation loop supplied by feed tanks may process a single system level process solution into a system level concentrate solution ZZZZ-C and multiple system level diluate solutions ZZZZ-D that are produced throughout the process. The feed side circulation loop may be operated in a non-recirculation batch mode while the sweep side circulation loop is supplied continuously by feed bleed stream 100-FB. Further the sweep circulation loop may have a recirculation flow from second outlet 1.2 to second inlet 1.1 and continuously produce system level diluate solution ZZZZ-D. In these methods of operation, any one of the supply streams 100-FB, 100-CB, ZZZZ-F or ZZZZ-S may supply the sweep side circulation loop individually or in any combination of the supply streams. Likewise any one of the supply streams 100-DB, 100-SB, ZZZZ-D may supply the feed side circulation individually or in any combination of exit streams.

Once permeate flow initiates, operating conditions such as flux, permeability, net driving pressure, per pass recovery, feed loop pressure, salt rejection, circulation rates in loops, feed and sweep loop concentrations and rate of addition of feed or reject streams to sweep loop may be maintained at target values.

In all embodiments of SRO systems, the addition of system level feed solution ZZZZ-F to the feed side and system level sweep solution ZZZZ-S to the sweep side from an external source may be performed continuously or intermittently. Similarly in all embodiments, the removal of system level concentrate solution ZZZZ-C from the feed side and removal of system level diluate solution ZZZZ-D from the sweep side may be performed continuously or intermittently. The solution addition and removal from the feed loop and the sweep loop may be done to the extents necessary to maintain at least one of desired circulating volumes, process solution concentrations or operating pressure in the respective loops. In general for loops consisting storage tanks hydraulically connected in the circuit, loop volumes may be varied or kept constant during system operation. However for embodiments where such storage tanks are not provided and thus where loops volumes cannot be changed, loop volumes are maintained constant by continuous removal or addition of solution.

During operation of the batch or semi-batch process on the system ZZZZ, the osmotic pressure of process solution in feed loop (1.1-1.2-1.3-1.4-1.1) increases while osmotic pressure of process solution in sweep loop (2.1-2.2-2.3-2.4-2.1) decreases corresponding to an SRO membrane with a positive solute rejection characteristics. As a result the difference in osmotic pressures between the solutions in two loops across the membrane (H_{F}−H_{S}) increases with the progress of passes. In order to maintain the earlier permeate flux the applied pressure on the feed loop solution is increased corresponding to the increased difference in osmotic pressure and accounting for changes in concentration polarization effects. Alternatively for an SRO membrane with a negative solute rejection characteristics, the osmotic pressure of process solution in feed loop (1.1-1.2-1.3-1.4-1.1) decreases while osmotic pressure of process solution in sweep loop (2.1-2.2-2.3-2.4-2.1) increases. As a result the difference in osmotic pressures between the solutions in two loops across the membrane (Π_{F}−Π_{S}) decreases with the progress of passes. In order to maintain the earlier permeate flux the applied pressure on the feed loop solution is decreased corresponding to the decreased difference in osmotic pressure and accounting for changes in concentration polarization effects. In summary, the pressure of feed solution may be increased or decreased based on the target permeate flux to be maintained for an application. The increase or decrease in required operating pressure corresponding to removal of permeate solution from feed side circulation loop continues until at least one of the following conditions are met, a) maximum or minimum desired operating pressure of feed side circulation loop is reached or b) desired solute concentration is reached in feed and/or sweep side circulation solution(s), or c) target recovery of batch or semi batch operation cycle is reached or d) maximum concentration of a species other than the solute of interest such as ions, molecules, compounds, or salts is reached in the feed and/or sweep solution(s). Once any or a combination of the above conditions are met, the process solution in feed loop and/or the process solution in the sweep loop are removed from the system as streams ZZZZ-F, ZZZZ-C and/or ZZZZ-S, ZZZZ-D respectively, while a fresh input of feed and/or sweep solution fills the respective loops via streams ZZZZ-F and/or ZZZZ-S respectively. The process solution volumes removed and added may be equal or unequal.

Furthermore, during the operation of a semi-batch process on the system ZZZZ, feed side process solution may be added to the feed side circulation loop in excess to the volume of permeate solution permeated from the feed side circulation loop into the sweep side circulation loop via membrane 104 while simultaneously volume of solution equal to this excess added volume may be purged from the feed loop. Similarly the sweep solution may be removed in excess to the volume of permeate solution permeated into the sweep side circulation loop from the feed side circulation loop via membrane while simultaneously volume of process solution equal to this excess purge volume may be added to the sweep side circulation loop.

In hybrid 4 unpressurised feed tank is used on the feed side circulation loop while holding chamber is used on sweep side circulation loop. This configuration allows batch and semi-batch operation on feed side, while on sweep side it allows semi-batch operation without the need for sweep side tanks. In hybrid 5 pressurized feed tank is used on the feed side circulation loop while holding chamber is used on sweep side circulation loop. Any of the pressurized tanks mentioned in this invention may be used as feed side tank. This configuration allows batch and semi-batch operation on feed side, while on sweep side it allows semi-batch operation without the need for sweep side tanks. In hybrid 3, holding chamber is used on feed side circulation loop while tank is used on sweep side circulation loop. This configuration allows batch and semi-batch operation on sweep side, while on feed side it allows semi-batch operation without the need for feed side tanks. In hybrid 1, holding chamber is used on feed side circulation loop while sweep side circulation loop is operated with continuous bleed and/or external process solution supply and removal. This configuration allows semi-batch operation on feed side without the need for feed side tanks and continuous operation on sweep side. In hybrid 2, feed side circulation loop is operated with continuous bleed and/or external process solution supply and removal while holding chamber is used on sweep side circulation loop. This configuration allows continuous operation on feed side and semi-batch operation on sweep side without the need for sweep side tanks. In hybrid 6, feed side circulation loop is operated with continuous bleed and/or external process solution supply and removal while tank is used on sweep side circulation loop. This configuration allows continuous operation on feed side and, batch and semi-batch operation on sweep side.

The invention in various embodiments discloses a batch or semi-batch method of operating a plurality of SRO systems cascaded in one or more configurations. The method 5100 as shown in FIG. 5A includes staging plurality of SRO systems as separation stages in a cascading array in step 610. In step 612 stage level concentrate solution is supplied from a separation stage as stage level sweep solution to an adjacent separation stage that is separating solutions of relatively higher osmotic pressures. In step 614 stage level diluate solution is supplied from the separation stage as stage level feed solution to an adjacent separation stage that is separating solutions of relatively lower osmotic pressures. In step 616 depending on the array and the application, external process solution is supplied as stage level feed solution to separation stage that is separating solutions at highest osmotic pressure in the array. In step 618 external solution is supplied as stage level sweep solution to separation stage that is separating solutions at lowest osmotic pressure in the array. A stage level concentrate solution is collected in step 620 from the separation stage that is separating process solutions at highest osmotic pressure in the array and a stage level diluate solution is collected from the separation stage in step 622 that is separating process solutions at lowest osmotic pressure in the array.

In some embodiments the SRO systems are connected serially in one or more configurations. A method of operating an array of serially connected SRO systems is disclosed in FIG. 5B. The method 5200 includes staging a plurality of SRO system as separation stages in a serial array in step 630. Stage level concentrate solution is supplied in step 632 from a separation stage as stage level feed solution to an adjacent separation stage that is separating feed side solutions of relatively higher or lower osmotic pressures when using semi-permeable membranes with positive solute rejection or negative solute rejection respectively. This may be further explained as follows. When using membranes with positive solute rejection in a stage, concentration and osmotic pressure of system level concentrate solution to the stage is higher than that of system level feed solution to the stage. When using membrane with negative solution rejection, concentration and osmotic pressure of system level concentrate solution to the stage is lower than that of system level feed solution to the stage. In step 634 stage level diluate solution is supplied from the separation stage as stage level sweep solution to an adjacent separation stage that is separating feed side solutions of relatively lower or higher osmotic pressures when using semi-permeable membranes with positive solute rejection or negative solute rejection respectively. External process solution is supplied in step 636 as stage level feed solution to separation stage that is separating feed side solutions at lowest or highest osmotic pressure in the array when using in the stages semi-permeable membranes with positive solute rejection or negative solute rejection respectively. Depending on the application, external solution is supplied as stage level sweep solution in step 638 to separation stage that is separating feed side solutions at highest or lowest osmotic pressure in the array when using in the stages semi-permeable membranes with positive solute rejection or negative solute rejection respectively. In step 640 a stage level concentrate solution is collected from the separation stage that is separating feed side solution at highest osmotic pressure or any other separation stage in the array and in step 642 a stage level diluate solution is collected from the separation stage that is separating feed side solution at lowest osmotic pressure or any other separation stage in the array.

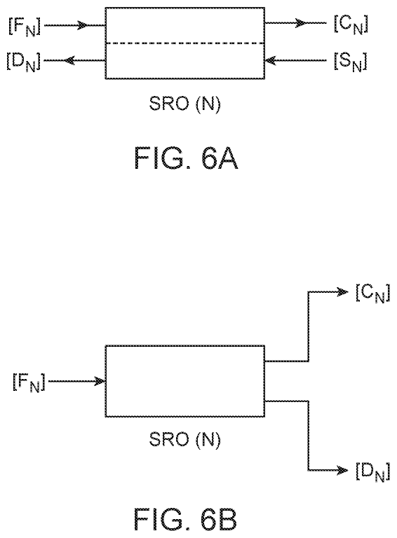

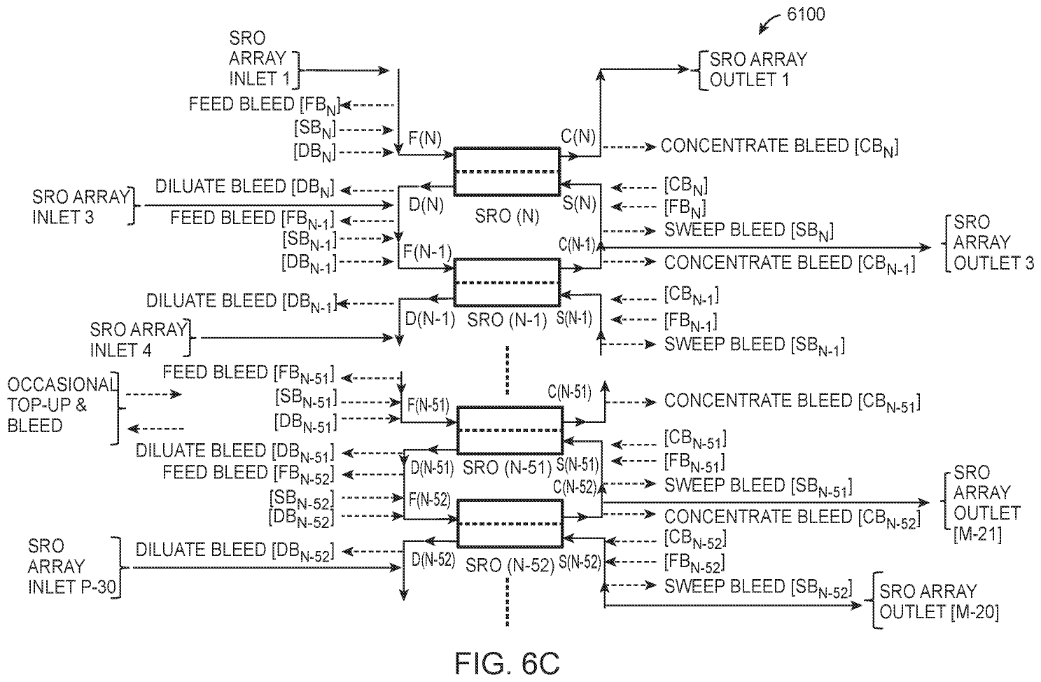

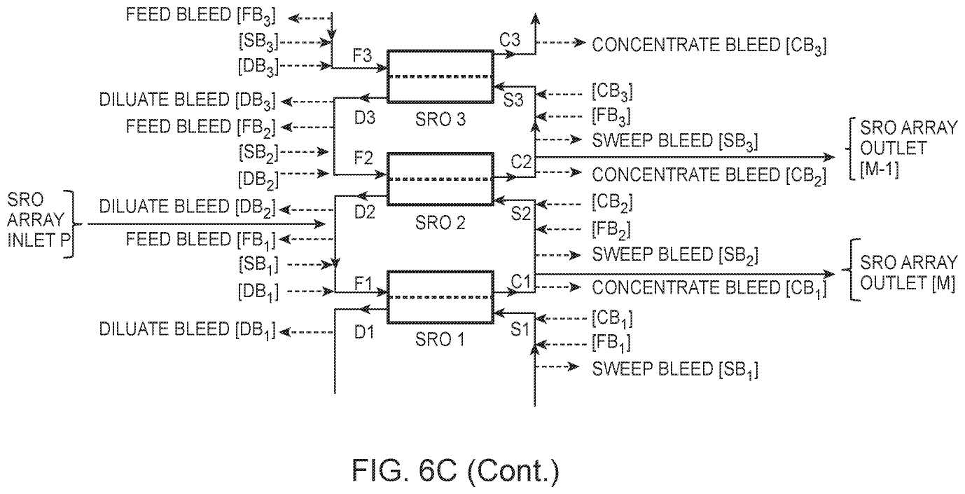

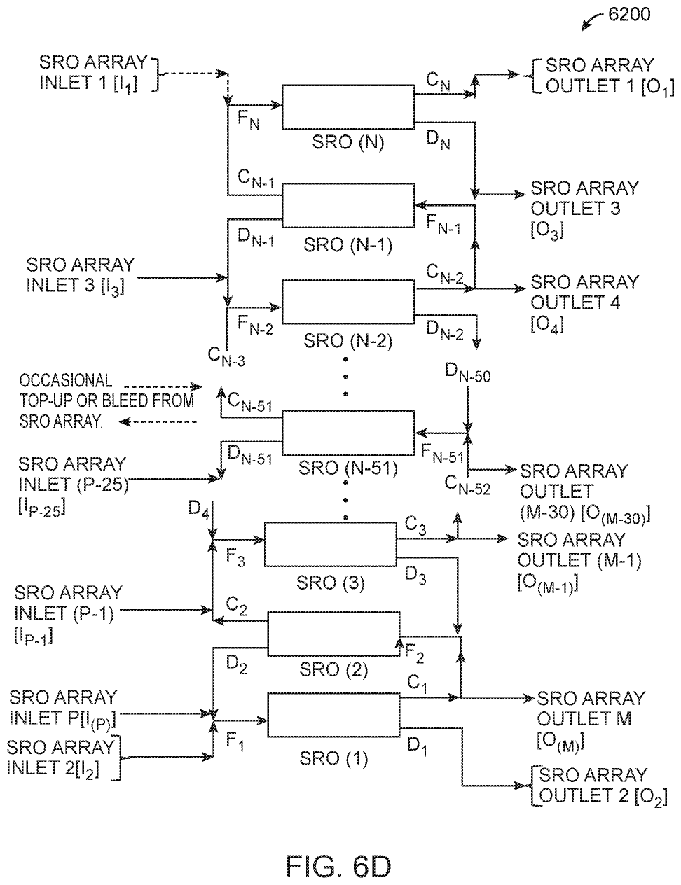

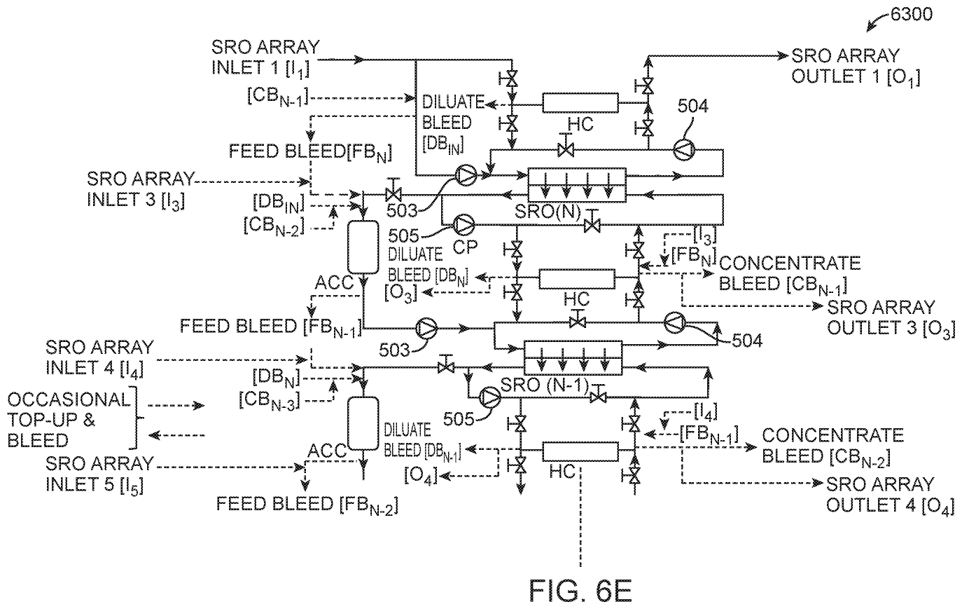

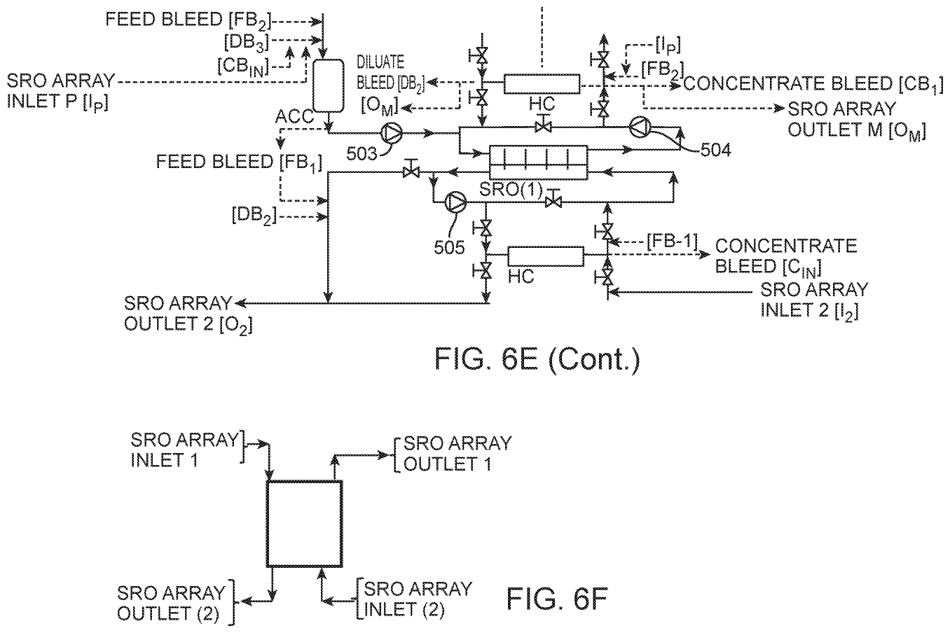

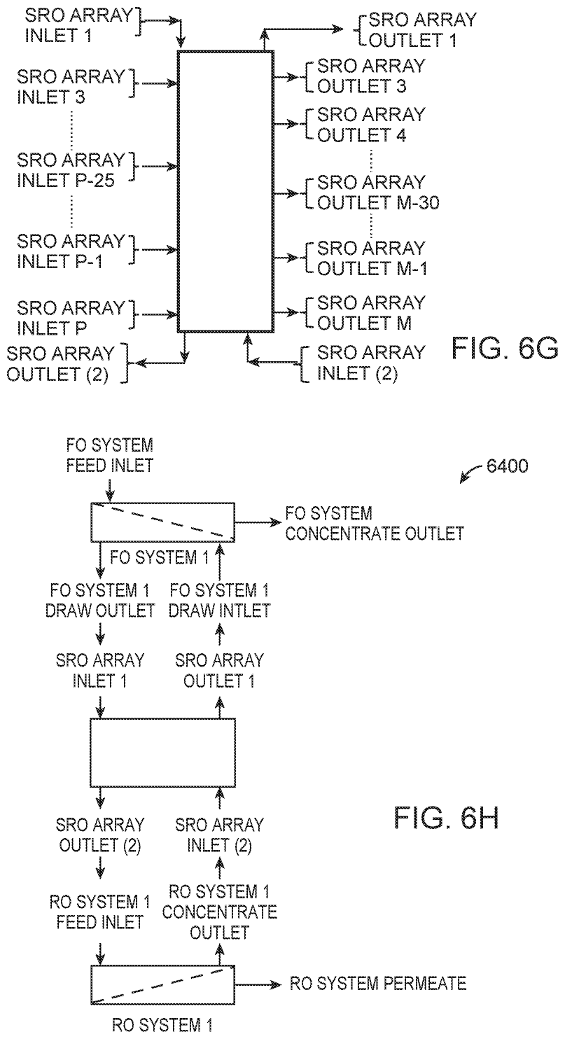

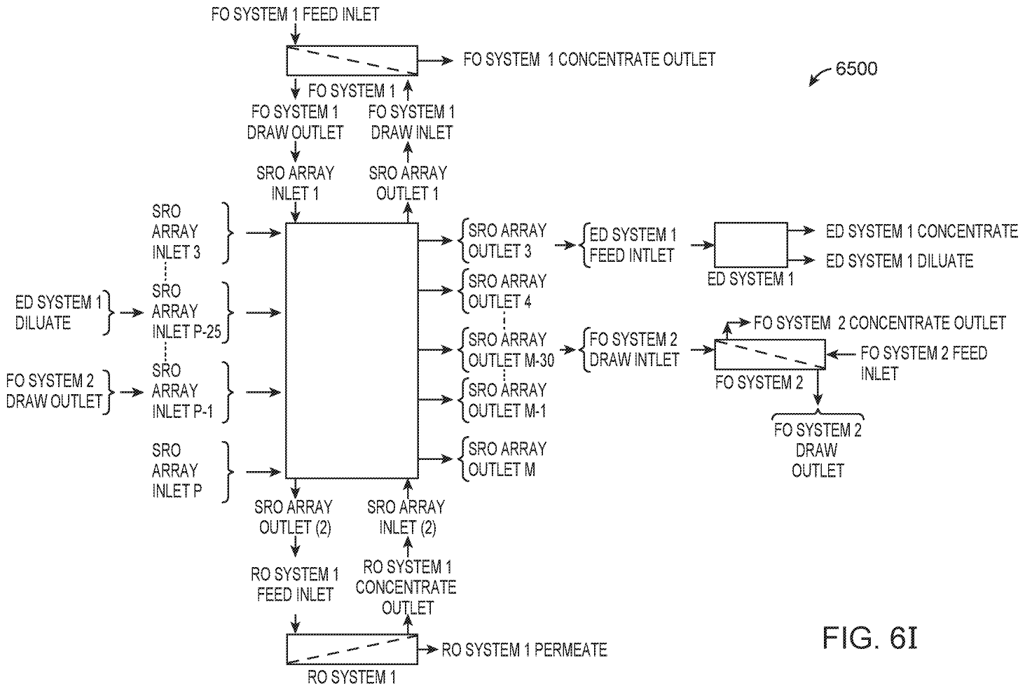

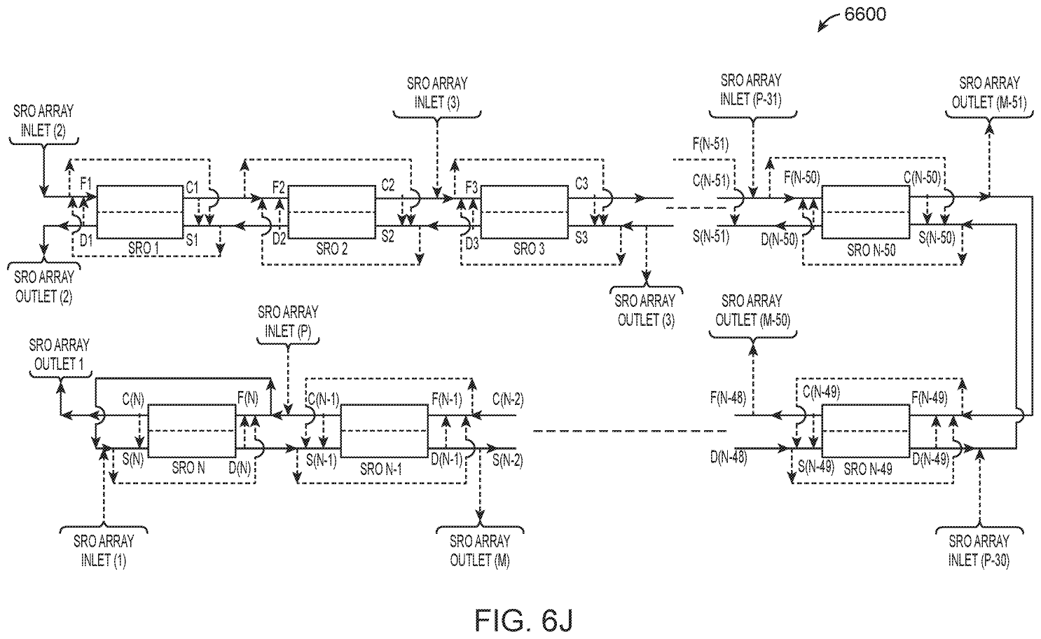

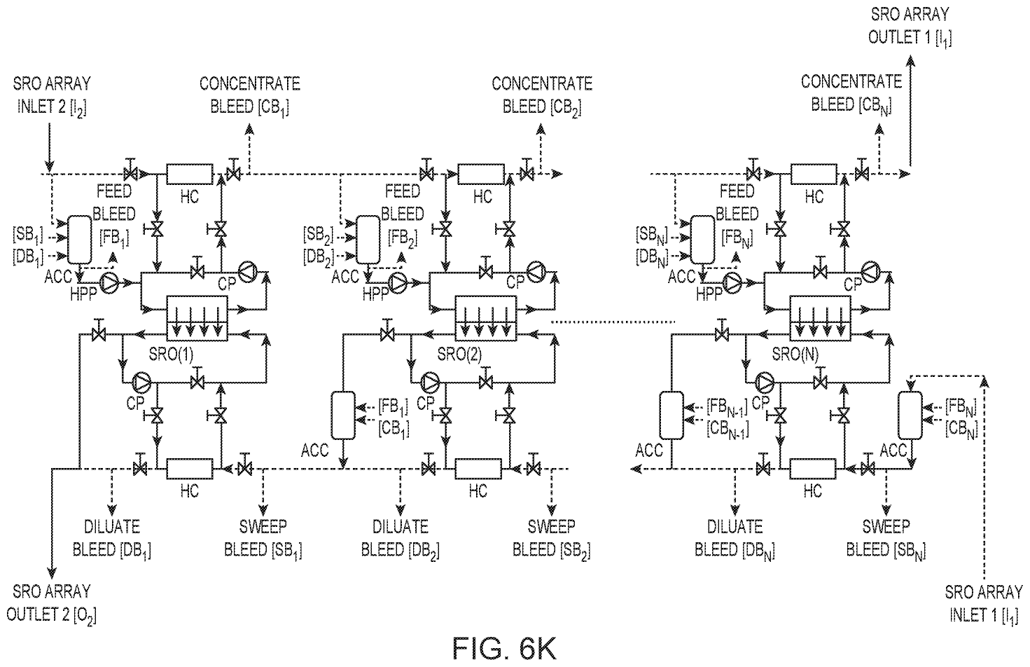

All SRO separation processes and SRO systems described so far may be combined or staged in manner that allows achieving larger separation duties. The configurations of combining or staging their operation may be referred as arrays. The following description, concepts and terminology are applicable to all SRO array embodiments mentioned in this invention. A separation stage or stage of SRO array is where system level separation is performed using SRO system(s). Continuity is maintained between separation duties of adjacent stages such that by arranging system level separation duties of stages in a cascading or a serial arrangement, array level separation duty may be achieved. A stage of an SRO array may be represented by the symbols in FIG. 6A and FIG. 6B. The symbol in FIG. 6A indicates a separation stage achieved using different stage level feed solution and stage level sweep solution supplied to the stage. The symbol in FIG. 6B indicates a separation stage achieved using common stage level feed solution and stage level sweep solution supplied to the stage. FIG. 6B is necessary for SRO systems with single side tank and holding chamber, where diluate from an upper stage and concentrate from a lower stage may be combined and processed together in the stage under consideration. Each separation stage of array may be carried out by a SRO system with SRO unit at its core. Alternatively each separation stage may be achieved using multiple SRO systems with SRO units at their core. Furthermore, each separation stage may be achieved using fewer than one SRO system with SRO unit at its core. This happens when multiple separation stages are achieved using same SRO system with SRO unit at its core. Separation duty of individual separation stages of an array may be equal or unequal. Different types of SRO systems may be used in different stages.

In cascading array configurations, SRO stages are depicted as being cascaded vertically. During operation of such SRO array, permeate solution flows through the semi-permeable membranes 104 of SRO units 100 used in the SRO stages from top of the array to the bottom of the array. Top most and bottom most SRO stages of an array may be referred as terminal stages. All other SRO stages between the terminal stages may be referred as internal stages. In SRO array embodiments that process the feed side and sweep side process solutions separately in the SRO stages, the process solution between consecutive internal stages is circulated essentially in closed loops. These loops may be interconnected through bleed streams in SRO embodiments with internally connected loops. There are different modes of achieving separation at the array level. This may be better explained when considering movement of process solution in loops between stages. In array configuration with internally isolated loops process solution is transferred between consecutive internal stages without crossing a membrane. This transfer occurs by direct hydraulic means between feed side of a SRO unit in one stage and sweep side of a SRO unit in the adjacent stage or vice versa. Such transfers between adjacent stages occur during operation of all cascading array embodiments. During operation it may shuttle between these sides of adjacent stages and all solution exchange with other stages beyond these two stages may occur only through the membrane in the adjacent stages. In internally connected loops cascading array configuration a process solution may be transferred by direct hydraulic means across a membrane, between feed side of a SRO unit in one stage and sweep side of the same SRO unit or feed side of a SRO unit in an adjacent stage or vice versa. In addition process solution may also be transferred by direct hydraulic means between non-adjacent stages. Internally isolated and externally connected internal loops array configuration is essentially an internally isolated configuration with the provision for transferring process solutions from or to external sources by direct hydraulic means. Internally connected and externally connected internal loops array configuration is essentially an internally connected configuration with the provision for transferring process solutions from external sources or to external sinks by direct hydraulic means.

The SRO systems described may also be combined in an serial array configuration as shown in FIG. 6J. In this configuration a stage level concentrate solution CX from the a separation stage X is supplied as a stage level feed solution FX+1 to a separation stage X+1 while a stage level diluate solution DX+1 from the separation stage X+1 is supplied as a stage level sweep solution SX to the separation stage X. Likewise a stage level concentrate solution CX−1 from a separation stage X−1 is supplied as a stage level feed solution FX to the separation stage X while a stage level diluate solution DX from the separation stage X is supplied as a stage level sweep solution SX−1 to the separation stage X−1. Serial array configuration of SRO systems differs from the cascading array configuration as follows. The stages are connected serially wherein, stage level concentrate solution from a stage is supplied as stage level feed solution to another stage and stage level diluate solution from a stage is supplied as stage level sweep solution to another stage. A distinguishing feature of this array is when operated without direct hydraulic means of solution transfers across the membrane, the process solution used on one side in a stage is used on the same side in other stages. Further notable feature is that the permeate solution generated in every stage flows through a semi-permeable membrane only once.

During separation process in both array configurations, in many modes of operation it is necessary to carryover solution generated in one separation stage to the next separation stage. Residual solution carryover is achieved by using solution reservoirs, such as feed tanks, sweep tanks, holding chamber and accumulators to transfer process solution from one stage to another stage simply by holding the desired solution in the reservoir. Further the residual solution may also be transferred in same manner from one side to other side of an SRO unit and/or to another SRO unit. In the simplest case, one residual solution from one process is carried over to another separation process. These two separation stages may be adjacent in space or in time. They may also be non-adjacent in space or in time. In an exemplary operation, it is also possible to carryover a residual solution from a first process, combine it with residual solution from a third process, supply part of it in a fifth process and the rest in a seventh process. The solution volume of circulation loops in various stages may be equal or unequal. In all SRO array configurations, the terminal SRO stages at top and bottom of the array may be connected to other external systems such as reverse osmosis systems, forward osmosis systems, electrodialysis, capacitive deionization, ion concentration polarization, shock electrodialysis or any other processes. For externally connected arrays, internal stages of the array may also be connected to other such external systems. Certain system components such as tanks, holding chambers and accumulators may be shared between stages of all arrays. This permits optimal utilization of these components thereby reducing capital cost of arrays. In the embodiments described below, SRO arrays with internally isolated, internally connected, externally isolated and externally connected internal loops are depicted in a single embodiment. This conveys four different SRO array embodiments namely, internally isolated and externally isolated internal loops, internally isolated and externally connected internal loops, internally connected and externally isolated internal loops and internally connected and externally connected internal loops. These combinations shall be understood as individual embodiments.

In array embodiments shown in FIG. 6C to FIG. 6E, FIG. 6J and FIG. 6K, SRO system embodiments in Table 2 with a combination of tanks, holding chambers or continuous bleed and external supply/removal on feed and sweep sides may be used in the separation stages of the arrays to perform separation. Any combination of these SRO systems may also be used in a single SRO array embodiment. In these SRO arrays, tanks, holding chambers and accumulators may be shared between stages.

In various embodiments an SRO array system as shown in FIG. 6C represents in one embodiment each of the four different SRO array configurations as explained above. Operation of the embodiment in an internally isolated and externally isolated internal loops configuration is as follows. SRO system in each stage has four connections and a semi-permeable membrane. For a SRO stage X the four connections are stage level feed solution to stage FX, stage level sweep solution to stage SX, stage level concentrate solution from stage CX and stage level diluate solution from stage DX. The dashed line in an SRO stage represents membrane of the SRO unit used in that stage. The array consists of N separation stages from SRO 1 to SRO N. In this internally isolated configuration, all inflow to and outflow from process solution contained between adjacent stages for every solution component occurs through the membrane in SRO unit(s) used in those stages. Between adjacent stages, if the inflow of each solution component from upper stage equals the outflow of respective solution components from the lower stage the process solution composition and osmotic pressures between the adjacent stages shall remain unchanged. An exception to this is for solutions with certain chemical compositions, where by osmotic pressure remains unchanged with change in composition. However in other applications where there may be an imbalance between the inflow from upper stage and outflow from lower stage of solution components, process solution composition and osmotic pressures may change. As a result it may be necessary to occasionally top up and/or bleed process solutions to or from the array system respectively. It is important to note that top up and/or bleed of process solution for systems operating with externally isolated internal loops, is not continuous and occur only when necessary to maintain composition of process solution within a range as defined by operating conditions for that particular application.

Operation of the embodiment in FIG. 6C as an internally isolated and externally connected internal loops configuration is as follows. When operated with external connections to internal loops, the system operates with additional hydraulic connections to external source or sink of process solution and other systems with which process solution may be transferred continuously or intermittently. These external connections consist of P SRO array inlet streams from inlet stream 1 to inlet stream P that transfer process solution to the array from external sources and M SRO array outlet streams from outlet stream 1 to outlet stream M that transfer process solution from the array to external sources. The difference between occasional top-up or bleed and intermittent supply or removal is as follows. The intermittent supply or removal of external streams to the system in externally connected mode occurs as demanded by the application whereas the occasional top-up or bleed to the system in externally isolated mode is done to maintain solution composition in the internal loops within a range.

Further FIG. 6C represents SRO array embodiments with internally connected and externally isolated internal loops configuration. Process solutions beyond adjacent stages may be connected by direct hydraulic means through bleed streams or residual solution carryover through tanks or holding chambers or accumulators. In this array configuration, inflow to and outflow from process solution for every solution components between stages may occur through the membrane in SRO unit used in those stages or by direct hydraulic means across the membrane. On the feed side for an stage SRO X, there could be a feed bleed FX and concentrate bleed CX that transfer feed side solution to sweep side and there could be a sweep bleed SX and diluate bleed DX that transfer sweep side solution to feed side. These bleed streams correspond to stage level bleed streams that are transferred during a stage operation. In FIG. 6C the bleed streams are shown to transfer process solution across a membrane in an SRO stage. Alternatively these bleed streams may also be transferred to feed side or sweep side of other stages. Operation of the embodiment in an internally connected and externally isolated internal loops configuration is as follows. Similar to internally isolated and externally isolated embodiment it may be necessary to occasionally top up and/or bleed process solutions to or from the system respectively. Although the loops are interconnected, it may be necessary to top-up or bleed process solutions of internal loops in the system. Such a scenario would be when there is imbalance of solution components within the SRO array as a whole, which may occur when the flow into the internal loop connected to top terminal stage is not balanced by flow out from the internal loop connected to bottom terminal stage. To prevent accumulation or depletion of those solution components, it will be necessary to bleed or top-up the internal loops. It is important to note that top up and/or bleed of process solutions is not continuous and occur only when necessary to maintain composition of process solution within a range as defined by operating conditions for the particular application.

Operation of the embodiment in FIG. 6C as an internally connected and externally connected internal loops configuration is as follows. When operated with external connections to internal loops, the system operates with additional hydraulic connections to external source or sink of process solution and other systems with which process solution may be transferred continuously or intermittently. It consists of P SRO array feed streams from feed stream 1 to feed stream P that transfer process solution to the array from external sources and M SRO array outlet streams from outlet stream 1 to outlet stream M that transfer process solution from the array to external sinks.

SRO array in FIG. 6D represents in one embodiment an internally connected and externally isolated internal loops configuration of N stages and in another embodiment an internally connected and externally connected loops configuration of N stages. Operation of the embodiment in an internally connected and externally isolated internal loops configuration is as follows. This embodiment is similar to internally connected internal loops embodiment in FIG. 6C but differs from it by combining stage level process solutions from other stages and using them at a stage level feed solution and a stage level sweep solution whereas embodiment in FIG. 6C processes the stage level process solutions from other stages separately at a stage while permitting controlled transfer between the solutions on two sides through bleed streams. For a stage SRO X, stage level concentrate solution C_{X-1} from a lower stage SRO X−1 is combined with stage level diluate solution D_{X+1} from the upper stage SRO X+1 and the combined process solution is used as stage level feed solution and stage level sweep solution for SRO stage X to yield a stage level concentrate solution C_{X} and a stage level diluate solution D_{X}. Occasional top-up or bleed of internal loops of the system may be done to maintain composition of process solution within a range as desired for an application.

Operation of the embodiment in FIG. 6D as an internally connected and externally connected internal loops configuration is as follows. When operated with external connections to internal loops, the system operates with additional hydraulic connections to external source or sink of process solution and other systems with which process solution may be transferred continuously or intermittently. It consists of P SRO array inlet streams from inlet stream 1 to inlet stream P that transfer process solution to the array from external sources and M SRO array outlet streams from outlet stream 1 to outlet stream M that transfer process solution from the array to external sources.

The SRO array in FIG. 6J represent serially connected separation stages. The in one embodiment represents each of the four different SRO array configurations as explained above. Operation of the embodiment in an internally isolated and externally isolated internal loops configuration is as follows. In this configuration process solution from an external source Inlet 1 is supplied as a stage level feed solution F1 to a first separation stage SRO 1 while a stage level diluate solution D1 from the first separation stage SRO 1 is discharged to an external sink Outlet 2. Further a stage level concentrate solution C1 from the first separation stage SRO 1 is supplied as a stage level feed solution F2 to a second separation stage SRO 2 while a stage level diluate solution D2 from the second separation stage SRO 2 is supplied as a stage level sweep solution S1 to the first separation stage SRO 1. Likewise a stage level concentrate solution C2 from the second separation stage SRO 2 is supplied as a stage level feed solution F3 to a third separation stage SRO 3 while a stage level diluate solution D3 from the third separation stage is supplied as a stage level sweep solution S2 to the second separation stage SRO 2. Additional stages are connected in a similar manner till an N^{th} separation stage SRO N, wherein the stage level concentrate solution C(N−1) from the N−1 separation stage SRO N−1 is supplied as stage level feed solution F(N) to the N^{th} separation stage SRO N and either a portion of the feed solution F(N) to the N^{th} separation stage or a portion of the concentrate solution C(N) from the N^{th} separation stage or both are supplied as stage level sweep solution S(N) to the N^{th} separation stage. Further a portion of the concentrate solution C(N) from the N^{th} separation stage is discharged to an external sink and the stage level diluate D(N) solution from the N^{th} separation stage is supplied as stage level sweep solution S(N−1) to n−1 separation stage.

Operation of the embodiment in FIG. 6J as an internally isolated and externally connected internal loops configuration is as follows. When operated with external connections to internal loops, the system operates with additional hydraulic connections to external source or sink of process solution and other systems with which process solution may be transferred continuously or intermittently. These external connections consist of P SRO array inlet streams from inlet stream 1 to inlet stream P that transfer process solution to the array from external sources and M SRO array outlet streams from outlet stream 1 to outlet stream M that transfer process solution from the array to external sources.

Further FIG. 6J represents SRO array embodiments with internally connected and externally isolated internal loops configuration. Process solutions beyond adjacent stages may be connected by direct hydraulic means through bleed streams or residual solution carryover. In this array configuration, inflow to and outflow from process solution for every solution components between stages may occur through the membrane in SRO unit used in those stages or by direct hydraulic means across the membrane. On the feed side for an stage SRO X, there could be a feed bleed FX and concentrate bleed CX that transfer feed side solution to sweep side and there could be a sweep bleed SX and diluate bleed DX that transfer sweep side solution to feed side. These bleed streams correspond to stage level bleed streams that are transferred during a stage operation. In FIG. 6J the bleed streams are shown to transfer process solution across a membrane in an SRO stage. Alternatively these bleed streams may also be transferred to feed side or sweep side of other stages. Operation of the embodiment in an internally connected and externally isolated internal loops configuration is as follows. It operates similar to internally isolated and externally isolated embodiment. It has in addition its internal loops connected. To prevent accumulation or depletion of solution components, it will be necessary to bleed or top-up the internal loops to maintain composition of process solution within a range as defined by operating conditions for the particular application.

Operation of the embodiment in FIG. 6J as an internally connected and externally connected internal loops configuration is as follows. When operated with external connections to internal loops, the system operates with additional hydraulic connections to external source or sink of process solution and other systems with which process solution may be transferred continuously or intermittently. It consists of P SRO array feed streams from feed stream 1 to feed stream P that transfer process solution to the array from external sources and M SRO array outlet streams from outlet stream 1 to outlet stream M that transfer process solution from the array to external sinks.

SRO systems with holding chambers may also be combined into array configurations of FIG. 6C, FIG. 6D and FIG. 6J. FIG. 6E and FIG. 6K represent exemplary array configurations of SRO systems with holding chambers. SRO array with holding chambers comprise accumulators as additional components. Further in these arrays holding chambers are shared between circulation loops in adjacent stages. A feed side holding chamber of stage X may be used as sweep side holding chamber in stage X+1. Likewise the sweep side holding chamber of stage X may be used as feed side holding chamber in stage X−1. The SRO array system includes one or more SRO systems with feed side and sweep side holding chambers that are used to perform separation at SRO stages. Further accumulators ACC are used as process solution reservoirs between stages. SRO units in these arrays may have equal number of units and/or volume of holding chambers on both sides. Alternatively the SRO units may have different number of units and/or volume of holding chamber on two sides. Furthermore the volume of the feed side and sweep side circulation loops may be equal or different. In other words, a SRO unit may be considered symmetric if on both sides the holding chambers are of identical volume and/or units; and the circulation loops are of equal volume. A SRO unit may be considered asymmetric if on both sides the holding chambers are of non-identical volume and/or units; and the circulation loops are of unequal volume. Any combination of these SRO units may be used in the stages of SRO array. In the following embodiments symbol for an SRO as shown in FIG. 6A has four connections and a semi-permeable barrier represented by a dashed line. An SRO stage X has four connections, namely system level feed solution to stage FX, system level sweep solution to stage SX, system level concentrate solution from stage CX and system level diluate solution from stage DX. The dashed line represents membrane of the SRO unit used in that stage. This line is shown to emphasize direct hydraulic isolation between loops on either side of the membrane for internally isolated embodiment in FIG. 6E and FIG. 6K and that solution transfer from one side to the other side of a semi-permeable membrane 104 may only occur through the membrane. Also for internally connected embodiment in FIG. 6E and FIG. 6K the dashed line makes it apparent to visualize bleed streams that have direct hydraulic connections across the membranes.

The array embodiments in FIG. 6E are shown to consist of N SRO stages from SRO 1 to SRO N. The top most stage SRO N has an SRO array inlet stream 1 and an SRO array outlet stream 1 connected to the feed side holding chamber of stage SRO N. The bottom most stage SRO 1 has an SRO array inlet stream 2 and an array outlet stream 2 connected to the sweep side holding chamber. In all SRO array embodiments, permeate solution is transferred from the top external stream to the bottom external stream through the array.

In FIG. 6E, HC is shown to be shared between adjoining stages. Process solution in HC is used as feed side solution at a lower stage whereby it gets concentrated and as sweep side solution at an upper stage whereby it gets diluted. Overall permeate solution volume added to the process solution in the upper stage may be removed from the process solution in the lower stage. In other words permeate solution flows through the array from an upper stage through the process solution in stage being described to a lower stage. Further, HC may be shared between non-adjacent and non-adjoining stages. An additional feature of the arrays are the process solution accumulators that are provided between stages to collect diluate solution produced by a stage and transfer it to the next stage. This collection and transfer is shown to be between adjoining stages but it may also be done between non-adjoining stages. Internally isolated arrays are achieved by operating SRO systems in the stages without bleed streams and residual solution carryover across membranes used in the stages. While internally connected arrays are achieved by operating SRO systems in the stages with bleed streams and by residual solution carryover across membranes used in the stages.

SRO array in FIG. 6E represents in one embodiment an internally isolated and externally isolated internal loops configuration of N stages, in another embodiment an internally isolated and externally connected loops configuration of N stages, in another embodiment an internally connected and externally isolated internal loops configuration of N stages and in another embodiment an internally connected and externally connected loops configuration of N stages.

Operation of the embodiment in FIG. 6E as an internally isolated and externally isolated internal loops configuration is as follows. All inflow to and outflow from process solution for every solution components between adjacent stages occurs through the membrane in SRO unit used in those stages. This array is useful for transfer of permeate solution between a solution at high osmotic pressure to another solution at low osmotic pressure through multiple passes whereby the permeate solution passes through multiple SRO membranes.

Operation of the embodiment in FIG. 6E as an internally isolated and externally connected internal loops configuration is as follows. It consists of N SRO stages from SRO 1 to SRO N. It consists of P SRO array inlet streams from inlet stream 1 to inlet stream P that transfer process solution to the array from external sources and M SRO array outlet streams from outlet stream 1 to outlet stream M that transfer process solution from the array to external sources. Through these external connections the process solution may be transferred continuously or intermittently.

Operation of the embodiment in FIG. 6E as an internally connected and externally isolated internal loops configuration is as follows. It consists of N SRO stages from SRO 1 to SRO N. Process solutions beyond adjacent stages may be connected by direct hydraulic means through bleed streams or residual solution carryover in the holding chambers. Bleed streams include feed solution and concentrate solution transfer from feed side solution to sweep side solution and sweep solution and diluate solution transfer from sweep side solution to feed side solution. SRO stage X is fed by feed stream F_{X}, sweep stream Sx and it produces concentrate C_{X}, diluate D_{X}. The bleed streams added include feed bleed FB_{X+1} from feed to stage above, diluate bleed DB_{X+2} from two stages above and concentrate bleed CB_{X-1} from one stage below. Feed bleed FB_{X}, concentrate bleed CB_{X}, diluate bleed DB_{X} are removed from SRO stage X. The individual SRO unit embodiments shown are those in FIG. 3G, SRO system with holding chambers without bleed streams. The said bleed streams are removed from and added outside the feed and sweep side circulation loops. It must be noted that other SRO unit embodiments shown in FIG. 3H with PRV and FIG. 3I with ERD may be equally applicable. Further certain hybrid embodiments containing holding chambers may also be used. In such embodiments, bleed streams as shown for transferring process solution between the two sides may be used for connecting internal loops in the array embodiment. This array may be used to transfer permeate solution from a stream at high osmotic pressure to a stream at low osmotic pressure. Residual solution carryover between stages may also be achieved using feed or sweep holding chambers and accumulators. Further the internally connected loops have the ability to compensate for unequal solute passage between stages, which makes this feature practically useful. However the internal hydraulic connection between loops compromises multiple pass feature of permeate solution, which may result in lower quality permeate solution. The internal hydraulic connection between loops as shown in FIG. 6E is an exemplary case of bleed stream connections. Different bleed stream connections between stages may be used including inter-stage connections beyond adjacent stages from higher or lower stages than those depicted.

Operation of the embodiment in FIG. 6E as an internally connected and externally connected internal loops configuration is as follows. It consists of P SRO array inlet streams from inlet stream 1 to inlet stream P that transfers process solution to the array from external sources and M SRO array outlet streams from outlet stream 1 to outlet stream M that transfers process solution from the array to external sources. Inlet and outlet streams 1 and 2 are connected to the terminal SRO stages. Other inlet and outlet streams are connected to the internal stages. This embodiment is useful for fractionation of multiple inlet streams into required outlet streams. The internally connected loops are able to compensate for difference between required and achieved solute passage through the membranes. This ability distinguishes it from the internally isolated array.

SRO array in FIG. 6K represents in one embodiment an internally isolated and externally isolated internal loops configuration of N stages, in another embodiment an internally isolated and externally connected loops configuration of N stages, in another embodiment an internally connected and externally isolated internal loops configuration of N stages and in another embodiment an internally connected and externally connected loops configuration of N stages.

Operation of the embodiment in FIG. 6K as an internally isolated and externally isolated internal loops configuration is as follows. Process solution may flow from one side of a stage to the same side of another stage and there is no direct hydraulic transport of process solution across the membrane. Further there is no direct hydraulic connection of process solution for internal stages.

Operation of the embodiment in FIG. 6K as an internally isolated and externally connected internal loops configuration is as follows. It consists of N SRO stages from SRO 1 to SRO N. It further consists of P SRO array inlet streams from inlet stream 1 to inlet stream P that transfer process solution to the array from external sources and M SRO array outlet streams from outlet stream 1 to outlet stream M that transfer process solution from the array to external sources. Through these external connections the process solution may be transferred continuously or intermittently.

Operation of the embodiment in FIG. 6K as an internally connected and externally isolated internal loops configuration is as follows. It consists of N SRO stages from SRO 1 to SRO N. Process solution may be transported across the membrane by direct hydraulic means through bleed streams and/or residual solution carryover in the holding chambers. Bleed streams include feed solution and concentrate solution transfer from feed side solution to sweep side solution and sweep solution and diluate solution transfer from sweep side solution to feed side solution. SRO stage X is fed by feed stream F_{X}, sweep stream Sx and it produces concentrate C_{X}, diluate D_{X}. The bleed streams added comprise feed bleed FB_{X-1} from stage level feed solution to stage X−1, diluate bleed DB_{X} from stage X, sweep bleed SB_{X} from stage level sweep solution to stage X and concentrate bleed CB_{X-1} from stage X−1. Feed bleed FB_{X}, concentrate bleed CB_{X}, diluate bleed DB_{X} and sweep bleed SB_{X} are removed from SRO stage X. The individual SRO unit embodiments shown are those in FIG. 3G, SRO system with holding chambers without bleed streams. The said bleed streams are removed from and added outside the feed and sweep side circulation loops. It must be noted that other SRO unit embodiments shown in FIG. 3H with PRV and FIG. 3I with ERD may be equally applicable. Further certain hybrid embodiments containing holding chambers may also be used. In such embodiments, bleed streams as shown for transferring process solution between the two sides may be used for connecting internal loops in the array embodiment. Residual solution carryover between stages may also be achieved using feed or sweep holding chambers and accumulators. The internal hydraulic connection between loops as shown in FIG. 6E is an exemplary case of bleed stream connections. Different bleed stream connections between stages may be used including inter-stage connections beyond adjacent stages from higher or lower stages than those depicted.

Operation of the embodiment in FIG. 6K as an internally connected and externally connected internal loops configuration is as follows. It consists of P SRO array inlet streams from inlet stream 1 to inlet stream P that transfers process solution to the array from external sources and M SRO array outlet streams from outlet stream 1 to outlet stream M that transfers process solution from the array to external sinks. Array inlet and outlet streams 1 and 2 are connected to the terminal SRO stages. Other inlet and outlet streams are connected to the internal stages.

FIG. 6F is a symbolic representation of externally isolated SRO arrays. SRO array inlet 1 and SRO array outlet 1 correspond to the inlet and outlet streams of the N^{th} stage connected externally. SRO array inlet 2 and SRO array outlet 2 correspond to the inlet and outlet streams of the 1^{st} stage connected externally. Since the array is externally isolated, there are no other inlet and outlet streams. It represents both internally isolated and internally connected array configurations with external isolation.

FIG. 6G is a symbolic representation of externally connected SRO arrays. SRO array inlet 1 and SRO array outlet 1 correspond to the inlet and outlet streams of the N^{th} stage connected externally. SRO array inlet 2 and SRO array outlet 2 correspond to the inlet and outlet streams of the 1^{st} stage connected externally. Other inlet and outlet streams correspond to external connections of internal loops. It represents both internally isolated and internally connected array configurations with externally connected streams. It has P inlet streams from inlet stream 1 to inlet stream P and M outlet stream from outlet stream 1 to outlet stream M.

FIG. 6H is an exemplary coupling of externally isolated SRO arrays at the terminal stages. The N^{th} stage is coupled to a forward osmosis system (FO system1). FO system 1 may be a single FO system or multiple FO systems in any permissible configuration. FO system1 has feed inlet and concentrate outlet streams. These streams flow on the feed side of the FO membrane. The FO system operates with a draw stream on the other side of the membrane which draws permeate solution from the solution on the feed side. As a result volume of solution on feed side of FO system reduces while volume of solution on draw side of FO system increases. The SRO array outlet 1 is used as draw inlet for FO system1. After removing permeate solution from the feed side solution the FO system1 draw outlet is returned to SRO array as SRO array inlet 1. The 1^{st} stage of SRO array is coupled to a reverse osmosis system (RO system 1). RO system 1 may be a single RO system or multiple RO systems in any permissible configuration. RO system 1 has feed inlet and concentrate outlet streams. These streams flow on the feed side of the RO membrane. SRO array outlet 2 is used as RO system1 feed inlet. Permeate solution is removed as RO system 1 permeate. This reduces volume of solution on feed side. The concentrate stream from RO system 1 is returned to SRO array as SRO array inlet 2. This coupled configuration enables removing permeate solution from the FO feed stream, which is at high osmotic pressure. Overall in this coupling of array with external systems, permeate solution is removed from the feed to forward osmosis systems, transferred to the SRO array and eventually removed through the reverse osmosis systems.

FIG. 6I is an exemplary coupling of externally connected SRO arrays at the terminal and internal stages. The N^{th} stage is coupled to a forward osmosis system (FO system 1) similar to the FO system1 in FIG. 6H above. The 1^{st} stage of SRO array is coupled to a reverse osmosis system (RO system 1) similar to the RO system 1 in FIG. 6H above. Further, SRO array outlet 3 from an internal stage is used as feed inlet to an electro dialysis system (ED system 1). The ED system 1 produces ED system 1 concentrate and ED system 1 diluate. The ED system 1 diluate is returned to the SRO array as SRO array inlet P-25. Further SRO array outlet M-30 from an internal stage is used as draw stream inlet to another forward osmosis system (FO system2). Similar to FO system1, FO system2 removes permeate solution from its feed (FO system2 feed inlet). This reduces volume of solution on feed side while volume of solution on draw side increases. FO system2 draw outlet is returned to the SRO array as SRO array inlet P-1. Further the embodiment has additional SRO array inlet and outlet streams not coupled. These streams may be present for instance when the application requires alteration in solution concentration between the inlet and outlet streams. In other variations all SRO array inlet and outlet streams may be coupled to another system.

The invention as described above results in a) Continuous batch separation using tanks; b) Continuous semi-batch separation using tanks c) Continuous semi-batch separation using holding chambers; d) Process for achieving separation using any combination of batch, semi-batch, continuous operation on the feed and/or sweep sides using SRO system configurations with any combination of continuous process solution supply/tanks/holding chambers on the feed and/or sweep sides; e) Batch and semi batch separation achieved through multiple pass without re-circulation. f) Batch and semi batch separation achieved through multiple pass with re-circulation; and g) Combining SRO systems in stages to form an array for achieving large extent of separation. Further the SRO systems in arrays may be staged either in space by using multiple physical units or staged in time by using fewer physical units than stages in an array and performing separation duty of different stages in same SRO systems. Separations as mentioned above refer to osmotically assisted separations.

The method and systems disclosed here when used for desalination extends the maximum achievable salt concentration of RO to at least about 300 g/L NaCl. Further it's among the most efficient technologies for extending this range. Particularly in the process configuration employed in this disclosure this separation is achieved in the most efficient way possible.

The disclosed process is distinct as it operates in multiple passes thereby achieving batch, semi-batch and continuous operation in the feed side circulation loops. The process has higher efficiency and corresponding gains in operating costs since the operating pressure threads closely with the thermodynamic limit. The process operates transiently at high pressures and recoveries and allows for a greater operational efficiency than a corresponding process operating in steady state in both circulation loops.

Without being bound to any particular theory, it is suggested herein that typically RO system recoveries are limited by maximum desired operating pressure and precipitation of sparingly soluble salts. At high recoveries the tendency for precipitation by sparingly soluble salts is high. In a steady state process, if equipment is operated at this condition, there is sufficient time for precipitation of these salts on the membrane to adversely affect operation and equipment. However in a transient process, the duration at this operating condition may be controlled so that the kinetics of the salt precipitation is slower than the duration for which high concentration conditions exist. This allows for gains in operational efficiency and equipment life. An additional benefit of operating a transient process is that the membrane is not exposed to high pressures at high recoveries continuously, thereby reducing the compaction rate of the membrane and possibly extending membrane life. In the steady state process, continuous exposure at such conditions leads to membrane compaction and corresponding reduction in flux. For zero liquid discharge applications the disclosed process will significantly enhance energy efficiency, reduce operation and investment costs.

The disclosed method and apparatus maximizes energy efficiency of zero liquid discharge operations in various industries requiring separation of solution into electrolytes and solvents such as in textiles and tanning industries. Its application extends to other water generating/utilising industries such as commercial seawater and brackish water desalination plants, pharmaceuticals, dairy, FMCG manufacturing, brewery, steel, foundry, or the like. Predominantly this involves separation of solutes from solvents such as salts from water. Particularly when the degree of separation is high and the process solution osmotic pressures are beyond conventional RO operation, the value addition of this process is significant. For example it may be used to extend existing RO based seawater desalination to zero discharge desalination or minimal discharge desalination.

Although the detailed description contains many specifics, these should not be construed as limiting the scope of the invention but merely as illustrating different examples and aspects of the invention. It should be appreciated that the scope of the invention includes other embodiments not discussed herein. Various other modifications, and changes which will be apparent to those skilled in the art may be made in the arrangement, operation and details of the apparatus and method of the present invention disclosed herein without departing from the spirit and scope of the invention as described here. While the invention has been disclosed with reference to certain embodiments, it will be understood by those skilled in the art that various changes may be made and equivalents may be substituted without departing from the scope of the invention. In addition, many modifications may be made to adapt to a particular situation the teachings of the invention without departing from its scope.

### EXAMPLES

### Example 1

### Single Stage Osmotically Assisted Separation of Sodium Chloride Solution

A non-standard dead end stirred cell set-up is used to hold the membrane and the feed solution under pressurized conditions and provide inlet and outlet connections to connect sweep side to other system components such as sweep circulation pump and sweep reservoir. The feed solution is contained in a closed cylindrical compartment and pneumatically connected to a source of compressed nitrogen gas. Pressure was applied to feed solution using compressed nitrogen gas. Turbulence was induced near the membrane on feed side using magnetic stirrer from IKA to simulate turbulent flow conditions on the feed side in order to limit feed side external concentration polarization near membrane. The sweep solution is held in a beaker and circulated on the sweep side using peristaltic pump from Ravel Hiteks. Applied pressure on feed solution varied from 1 bar to 70 bar. The membrane support is specifically designed for supporting the membrane for performing osmotically assisted reverse osmosis by providing space for sweep side solution circulation on the sweep side. The membrane is placed on a spacer fabric is which in-turn placed on a flow channel disc. The spacer fabric and flow channel disc constitute the membrane support. The spacer fabric distributes mechanical stress on the membrane from high pressure feed solution onto the flow channel disc. Further the spacer fabric is porous enough to permit mass transfer to occur between the sweep solution and the membrane on the sweep side. The flow channel disc transfers load to rest of the equipment while simultaneously allowing sweep stream to flow in and out on the sweep side. Standard seawater reverse osmosis membrane from Dow is used as the semi-permeable membrane. Geometric membrane area in hydraulic contact with feed side solution is approximately 11 cm2. Change in quantity of sweep and feed solutions were verified gravimetrically by mass weighment using weighing scale from Essae. Flux and recovery were calculated from change in mass of both feed and sweep solutions. Sign of flux is positive when mass of feed solution decreases and mass of sweep solution increases. This convention is followed in the flux values reported in Table 3 below. Initial quantities of feed and sweep solutions are also shown in Table 3. From results in Table 3 for osmotically assisted separation of solutions at different high osmotic pressures and within maximum of 70 bar applied pressure demonstrates the phenomena of osmotic assistance for separation.

TABLE 3
Osmotically assisted flow from feed solution to sweep
solution at different concentrations

| Feed solute | | | Average | Initial | Initial |
|---|---|---|---|---|---|
| concentration | Sweep solute | Total | flux | feed | sweep |
| (g/L) | concentration (g/L) | permeate (g) | achieved (mg/min) | solution (g) | solution (g) |
| 50 | 50 | 7.992 | 177.7 | 60.315 | 100.189 |
| 60 | 60 | 7.967 | 122.6 | 60.365 | 100.412 |
| 100 | 100 | 29.76 | 66.1 | 60.32 | 100.214 |
| 140 | 140 | 23.033 | 47.49 | 100.462 | 100.310 |
| 160 | 160 | 4.94 | 41.17 | 100.289 | 100.261 |
| 180 | 180 | 5.008 | 40.06 | 100.321 | 100.212 |

### Example 2

### Performance Comparison Between Continuous and Batch Osmotically Assisted Separation of Sodium Chloride Solution

A non-standard dead end stirred cell set-up is used to hold the membrane and the feed solution under pressurized conditions and provide inlet and outlet connections to connect sweep side to other system components such as sweep circulation pump and sweep reservoir. The feed solution is contained in a closed cylindrical compartment and pneumatically connected to a source of compressed nitrogen gas. Pressure was applied to feed solution using compressed nitrogen gas. Turbulence was induced near the membrane on feed side using magnetic stirrer from IKA to simulate turbulent flow conditions on the feed side in order to limit feed side external concentration polarization near membrane. The sweep solution is held in a beaker and circulated on the sweep side using peristaltic pump from Ravel Hiteks. Applied pressure on feed solution varied from 1 bar to 70 bar. The membrane support is specifically designed for supporting the membrane for performing osmotically assisted reverse osmosis by providing space for sweep side solution circulation on the sweep side. The membrane is placed on a spacer fabric is which in-turn placed on a flow channel disc. The spacer fabric and flow channel disc constitute the membrane support. The spacer fabric distributes mechanical stress on the membrane from high pressure feed solution onto the flow channel disc. Further the spacer fabric is porous enough to permit mass transfer to occur between the sweep solution and the membrane on the sweep side. The flow channel disc transfers load to rest of the equipment while simultaneously allowing sweep stream to flow in and out on the sweep side. Standard seawater reverse osmosis membrane from Dow is used as the semi-permeable membrane. Geometric membrane area in hydraulic contact with feed side solution is approximately 11 cm². Change in quantity of sweep and feed solutions were verified gravimetrically by mass weighment using weighing scale from Essae. Flux and recovery were calculated from change in mass of both feed and sweep solutions. Sign of flux is positive when mass of feed solution decreases and mass of sweep solution increases. This convention is followed in the flux values reported in Table. 4 below. A constant permeate solution flux was maintained in all the experiments. However flux between experiments differed and is shown in Table. 4 below.

TABLE 4
Batch operation of osmotically assisted reverse osmosis system

| | | | Initial | Initial |
|---|---|---|---|---|
| | | Average | feed | sweep |
| Feed solute | Sweep solute | flux | solution | solution |
| concentration | concentration | maintained | quantity | quantity |
| (g/L) | (g/L) | (mg/min) | (g) | (g) |
| 100 | 100 | 77.4 | 60.3 | 100.2 |
| 160 | 160 | 40.4 | 100.3 | 100.3 |

The increase in applied pressure versus recovery is clearly evident figure XX. This demonstrates the requirement of varying applied pressure with process recovery and hence the energetic benefit of batch and semi-batch processes over continuous process. The results of the batch experiment of osmotically assisted separation of 100 gpl feed solution using 100 gpl sweep solution is compared with an equivalent continuous process in Table. 5 below. An energy saving of about 27% is achieved at the said conditions. Although actual energy savings may be in this range, it must be noted that a number of assumptions have been made in this comparison. Firstly the equivalent continuous process is considered to produce the same total permeate within the same process time by applying the maximum hydraulic pressure used in the batch in a single stage. For the batch process the following is not taken into account, energy losses due to pumping and energy recovery in multiple passes and mixing of solutions at different concentrations between passes. For both continuous and batch processes pump efficiency is not considered. The continuous process may be split into stages to lower energy consumption at the cost of increased capital expenditure. Cost optimization will be needed to compare both systems at their optimum life cycle costs.

TABLE 5
Evaluation of energy performance of batch versus continuous process
for 100 gpl versus 100 gpl experiment

| Parameter | Continuous process | Batch process |
|---|---|---|
| Total permeate (g) | 4.318 | 4.32 |
| Total time (s) | 3300 | 3300 |
| applied pressure (bar) | 55 | 20 to 55 |
| Total energy (J) | 24.1 | 17.68 |
| Average power (mWh) | 7.29 | 5.36 |
| Specific energy (kWh/m3) | 1.689 | 1.241 |
| Energy saving | 27% | |

### Example 3

### Cascading Multi-Staged Osmotically Assisted Separation of Sodium Chloride Solution without Bleed Streams

In this example a multi staged osmotically assisted separation without bleed streams of sodium chloride solution was simulated by using the same semi-permeable membrane and apparatus sequenced in time. A supply stream at a concentration of 120 gpl is considered as feed to the system. In the first trial a feed side solution of 120 gpl was run against sweep side solution of 120 gpl to produce a first concentrate and a first diluate. Subsequently one set of trials further concentrated the first concentrate sequentially twice while another set of trials further diluted the first diluate sequentially twice. Overall a supply stream at a concentration of 120 gpl is considered as feed to the system. In first separation duty permeate solution transferred between a feed side solution at 120 gpl and a sweep side solution at 120 gpl. The resulting first concentrate from first trial was used as feed side solution in a second trial and osmotically assisted reverse osmosis was performed effecting transfer of permeate solution from the feed to sweep side. This was repeated for the resulting second concentrate from second trial, which was used as feed side solution in a third trial and osmotically assisted reverse osmosis was performed effecting transfer of permeate solution from the feed to sweep side. Resulting third concentrate from the third trial is considered as the final concentrate for this example.

Similarly first diluate from first trial was used as sweep side solution while system feed solution used in the first trial was used as feed side solution in a fourth trial and osmotically assisted reverse osmosis was performed effecting transfer of permeate solution from the feed to sweep side. Resulting fourth diluate from fourth trial was used as sweep side solution while system feed solution used in the first trial was used as feed side solution in a fifth trial and osmotically assisted reverse osmosis was performed effecting transfer of permeate solution from the feed to sweep side. Resulting fifth diluate from the fifth trial is considered as the final system diluate for this example.

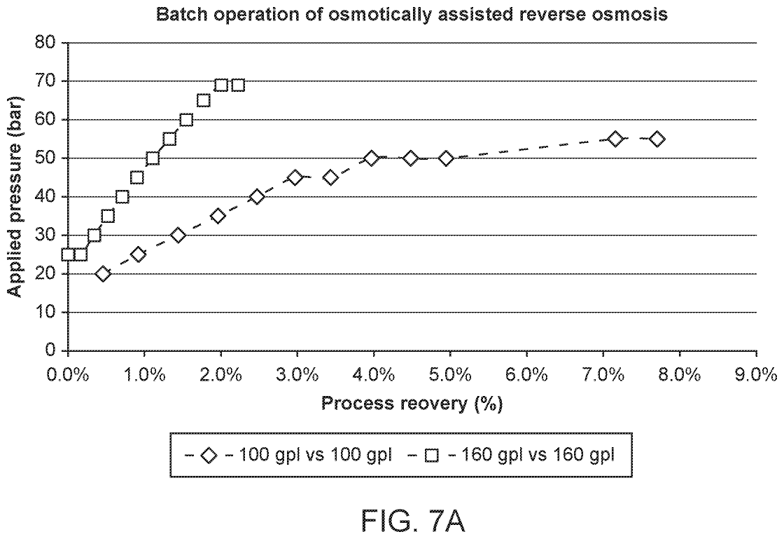

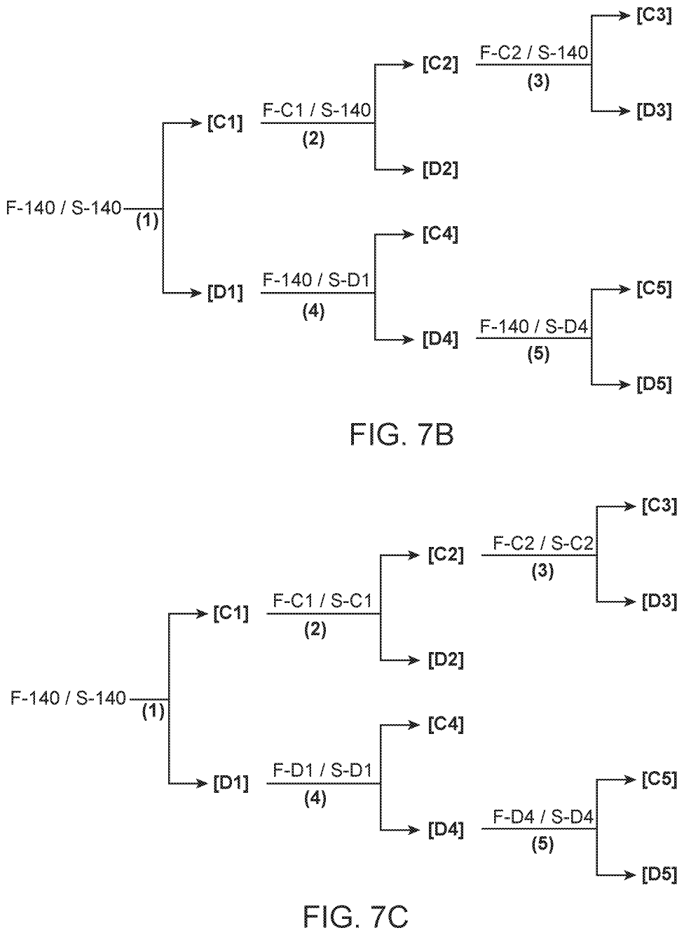

The second and third diluate produced in second and third trial may be processed in a similar method into final system concentrate and diluate. Similarly, the fourth and fifth concentrate produced in fourth and fifth trials respectively may be processed in a similar manner into final system concentrate and diluate. In this SRO array process, different solutions with similar concentrations may be mixed and processed together. This process is schematically illustrated in the FIG. 7B below.

A non-standard dead end stirred cell set-up is used to hold the membrane and the feed solution under pressurized conditions and provide inlet and outlet connections to connect sweep side to other system components such as sweep circulation pump and sweep reservoir. The feed solution is contained in a closed cylindrical compartment and pneumatically connected to a source of compressed nitrogen gas. Pressure was applied to feed solution using compressed nitrogen gas. Turbulence was induced near the membrane on feed side using magnetic stirrer from IKA to simulate turbulent flow conditions on the feed side in order to limit feed side external concentration polarization near membrane. The sweep solution is held in a beaker and circulated on the sweep side using peristaltic pump from Ravel Hiteks. Applied pressure on feed solution varied from 1 bar to 70 bar. The membrane support is specifically designed for supporting the membrane for performing osmotically assisted reverse osmosis by providing space for sweep side solution circulation on the sweep side. The membrane is placed on a spacer fabric is which in-turn placed on a flow channel disc. The spacer fabric and flow channel disc constitute the membrane support. The spacer fabric distributes mechanical stress on the membrane from high pressure feed solution onto the flow channel disc. Further the spacer fabric is porous enough to permit mass transfer to occur between the sweep solution and the membrane on the sweep side. The flow channel disc transfers load to rest of the equipment while simultaneously allowing sweep stream to flow in and out on the sweep side. Standard seawater reverse osmosis membrane from Dow is used as the semi-permeable membrane. Geometric membrane area in hydraulic contact with feed side solution is approximately 11 cm². Change in quantity of sweep and feed solutions were verified gravimetrically by mass weighment using weighing scale from Essae. Flux was calculated from change in mass of both feed and sweep solutions. Sign of flux is positive when mass of feed solution decreases and mass of sweep solution increases. This convention is followed in the flux values reported in Table 6 below.

TABLE 6
Osmotically assisted flow from feed solution to sweep solution at different
concentrations

| | | | | Average |
|---|---|---|---|---|
| | Feed solute | Sweep solute | Total | flux |
| Trial/experiment | concentration | concentration | permeate | achieved |
| no | (g/L) | (g/L) | (g) | (mg/min) |
| 1 | 120 | 120 | 4.1 | 54.667 |
| 2 | Concentrate | 120 | 2.189 | 48.644 |
| | from trial 1 | | | |
| 3 | Concentrate | 120 | 2.085 | 41.7 |
| | from trial 2 | | | |
| 4 | 120 | Diluate from | 2.39 | 47.8 |
| | | trial 1 | | |
| 5 | 120 | Diluate from | 1.967 | 43.711 |
| | | trial 4 | | |

### Example 4

### Multi-Staged Osmotically Assisted Batch Separation of Sodium Chloride Solution with Splitting of Feed Solutions Between Batches

In this example a multi staged osmotically assisted batch separation with bleed streams was simulated on a solution sodium chloride in water by using a single semi-permeable membrane and SRO unit sequenced in time. In the first trial a feed side solution of 120 gpl was run against sweep side solution of 120 gpl to produce a first concentrate and a first diluate. Subsequently one set of trials split the first concentrate sequentially twice while another set of trials split the first diluate sequentially twice. Overall a supply stream at a concentration of 120 gpl is considered as feed to the system. First separation duty involved permeate solution transfer between a feed side solution at 120 gpl and a sweep side solution at 120 gpl. The resulting first concentrate from first trial was used as both feed and sweep side solutions in a second trial and osmotically assisted reverse osmosis was performed effecting transfer of permeate solution from the feed to sweep side. This was repeated for the resulting second concentrate from second trial, which was used as both feed and sweep side solutions in a third trial and osmotically assisted reverse osmosis was performed effecting transfer of permeate solution from the feed to sweep side. Resulting third concentrate from the third trial is considered as the final concentrate for this example.

Similarly first diluate from first trial was used as both feed and sweep side solutions in a fourth trial and osmotically assisted reverse osmosis was performed effecting transfer of permeate solution from the feed to sweep side. Resulting fourth diluate from fourth trial was used as both feed and sweep side solutions in a fifth trial and osmotically assisted reverse osmosis was performed effecting transfer of permeate solution from the feed to sweep side. Resulting fifth diluate from the fifth trial is considered as the final system diluate for this example. The second and third diluate produced in second and third trial may be split in a similar method into final system concentrate and diluate. Similarly, the fourth and fifth concentrated produced in fourth and fifth trial respectively may be split in a similar manner into final system concentrate and diluate.

A non-standard dead end stirred cell set-up is used to hold the membrane and the feed solution under pressurized conditions and provide inlet and outlet connections to connect sweep side to other system components such as sweep circulation pump and sweep reservoir. The feed solution is contained in a closed cylindrical compartment and pneumatically connected to a source of compressed nitrogen gas. Pressure was applied to feed solution using compressed nitrogen gas. Turbulence was induced near the membrane on feed side using magnetic stirrer from IKA to simulate turbulent flow conditions on the feed side in order to limit feed side external concentration polarization near membrane. The sweep solution is held in a beaker and circulated on the sweep side using peristaltic pump from Ravel Hiteks. Applied pressure on feed solution varied from 1 bar to 70 bar. The membrane support is specifically designed for supporting the membrane for performing osmotically assisted reverse osmosis by providing space for sweep side solution circulation on the sweep side. The membrane is placed on a spacer fabric is which in-turn placed on a flow channel disc. The spacer fabric and flow channel disc constitute the membrane support. The spacer fabric distributes mechanical stress on the membrane from high pressure feed solution onto the flow channel disc. Further the spacer fabric is porous enough to permit mass transfer to occur between the sweep solution and the membrane on the sweep side. The flow channel disc transfers load to rest of the equipment while simultaneously allowing sweep stream to flow in and out on the sweep side. Standard seawater reverse osmosis membrane from Dow is used as the semi-permeable membrane. Geometric membrane area in hydraulic contact with feed side solution is approximately 11 cm². Change in quantity of sweep and feed solutions were verified gravimetrically by mass weighment using weighing scale from Essae. Flux was calculated from change in mass of both feed and sweep solutions. Sign of flux is positive when mass of feed solution decreases and mass of sweep solution increases. This convention is followed in the flux values reported in Table 7 below.

TABLE 7
Osmotically assisted flow from feed solution to sweep solution at different
concentrations

| | | | | Average |
|---|---|---|---|---|
| | Feed solute | Sweep solute | Total | flux |
| Trial/experiment | concentration | concentration | permeate | achieved |
| no | (g/L) | (g/L) | (g) | (mL/min) |
| 1 | 120 | 120 | 6.133 | 45.43 |
| 2 | Concentrate | Concentrate | 4.229 | 30.207 |
| | from trial 1 | from trial 1 | | |
| 3 | Concentrate | Concentrate | 1.923 | 48.075 |
| | from trial 2 | from trial 2 | | |
| 4 | Diluate from | Diluate from | 1.952 | 43.378 |
| | trial 1 | trial 1 | | |
| 5 | Diluate from | Diluate from | 1.999 | 44.422 |
| | trial 4 | trial 4 | | |

### Example 5

### SRO Array Examples Without Coupling to External Systems

In this example a multi staged osmotically assisted batch and semi batch separation in SRO arrays without coupling to external systems is depicted. In the first SRO array of externally connected internal loops, an inlet stream (stream [I3]) is split into two outlet streams, one of higher concentration (stream [O3]) and another of lower concentration (stream [O4]) than the inlet stream. In the second SRO array of externally connected internal loops, three inlet streams (streams [I1], [I3] and [I4]) are split into six outlet streams of different concentrations (streams [O2], [O3], [O4], [O5], [O6] and [O7]).

TABLE 8
Example values for first SRO array coupled to FO system(s).

| Description | UOM | Inlet 1 | Outlet 1 | Outlet 2 |
|---|---|---|---|---|
| SRO array, | | | | |
| Total flow | kg/hr | 100 | 60 | 40 |
| Water flow | kg/hr | 90 | 51.6 | 38.4 |
| Salt flow | kg/hr | 10 | 8.4 | 1.6 |
| Salinity | g/kg | 100 | 140 | 40 |

TABLE 9
Example values for first SRO array coupled to FO system(s).

| Description | | In- | In- | In- | Out- | Out- | Out- |
|---|---|---|---|---|---|---|---|
| SRO array, | UOM | let 1 | let 2 | let 3 | let 2 | let 3 | let 4 |
| Total flow | kg/hr | 50 | 120 | 300 | 50 | 150 | 100 |
| Water flow | kg/hr | 39 | 99.6 | 267 | 47.25 | 120 | 84 |
| Salt flow | kg/hr | 11 | 20.4 | 33 | 2.75 | 30 | 16 |
| Salinity | g/kg | 220 | 170 | 110 | 55 | 200 | 160 |
| | | Out- | Out- | Out- | | | |
| | | let 5 | let 6 | let 7 | | | |
| Total flow | kg/hr | 45 | 35 | 90 | | | |
| Water flow | kg/hr | 38.7 | 31.5 | 84.15 | | | |
| Salt flow | kg/hr | 6.3 | 3.5 | 5.85 | | | |
| Salinity | g/kg | 140 | 100 | 65.0 | | | |

### Example 6

### SRO Array Examples with Coupling to External Systems

In this example a multi staged osmotically assisted batch and semi batch separation in SRO arrays with coupling to external systems is depicted. In the first SRO array of externally connected internal loops, two inlet streams (streams I1 and I3) feed the SRO array while the array produces three outlet streams, (streams O1, O3 and O4). Streams O1 and I1 are coupled to a forward osmosis system (FO), where they are used as draw inlet and outlet streams respectively. Overall the work done by this SRO array may be described as follows. Feed stream inlet to FO is concentrated by using O1 as draw stream. Further the permeate solution drawn from FO system is used to dilute inlet stream I3 to produce outlet streams O3 and O4 of lower concentrations than I3.

In the second SRO array of externally connected internal loops, two inlet streams (streams I2 and I3) feed the SRO array while the array produces three outlet streams, (streams O2, O3 and O4). Streams I2 and O2 are coupled to a reverse osmosis system (RO). At RO, permeate solution is removed from feed stream O2 to RO system to produce concentrate stream I2 which is returned to the SRO array. Overall the work done by this SRO array may be described as follows. Inlet stream I3 to SRO array is concentrated to produce outlet streams O3 and O4 by removing permeate solution through the coupled RO system.

In the third SRO array of externally isolated internal loops, two inlet streams (streams I1 and I2) feed the SRO array while two outlet streams (streams O1 and O2) are produced from the SRO array. Streams I1 and O1 are coupled to forward osmosis system (FO). At FO, O1 is used as draw stream inlet whereby it draws permeate solution from FO feed stream to produce diluted outlet draw stream I1 which is returned to the SRO array. Streams I2 and O2 are coupled to reverse osmosis system (RO). At RO, permeate solution is removed from feed stream O2 to RO system to produce concentrate stream I2 which is returned to the SRO array. Overall the work done by this SRO array may be described as follows. Feed solution to FO is concentrated to the extent of permeate solution removed at the RO via the SRO array.

TABLE 10
Example values for first SRO array coupled to FO system(s).

| Description | UOM | Inlet 1 | Inlet 3 | Outlet 1 | Outlet 3 | Outlet 4 |
|---|---|---|---|---|---|---|
| SRO array | | | | | | |
| Total flow | kg/hr | 115.71 | 100 | 85.7 | 95 | 35.0 |
| Water flow | kg/hr | 115.66 | 90 | 85.7 | 87.4 | 32.6 |
| Salt flow | kg/hr | 21.43 | 10 | 21.4 | 7.6 | 2.4 |
| Salinity | g/kg | 185.3 | 100 | 250 | 80 | 74 |
| RO permeate | | | | | | |
| Total flow | kg/hr | 30 | | | | |
| Water flow | kg/hr | 29.99 | | | | |
| Salt flow | kg/hr | 0.015 | | | | |
| Salinity | g/kg | 0.5 | | | | |

TABLE 11
Example values for second SRO array coupled to RO system(s).

| Description | UOM | Inlet 2 | Inlet 3 | Outlet 2 | Outlet 3 | Outlet 4 |
|---|---|---|---|---|---|---|
| SRO array | | | | | | |
| Total flow | kg/hr | 78 | 100 | 120 | 30 | 28.0 |
| Water flow | kg/hr | 78.0 | 90 | 119.9 | 24.6 | 23.4 |
| Salt flow | kg/hr | 4.8 | 10 | 4.8 | 5.4 | 4.579 |
| Salinity | g/kg | 61.3 | 100 | 40 | 180 | 160 |
| RO permeate | | | | | | |
| Total flow | kg/hr | 42 | | | | |
| Water flow | kg/hr | 42.0 | | | | |
| Salt flow | kg/hr | 0.021 | | | | |
| Salinity | g/kg | 0.5 | | | | |

TABLE 12
Example values for third SRO array coupled to FO and RO systems.

| | | Inlet 1 | Inlet 2 | Outlet | Outlet 2 |
|---|---|---|---|---|---|
| Description | UOM | (Top) | (Bottom) | 1 (Top) | (Bottom) |
| Total flow | kg/hr | 125 | 300 | 100 | 325 |
| Water flow | kg/hr | 100 | 282 | 75 | 307 |
| Salt flow | kg/hr | 25 | 18 | 25 | 18 |
| Salinity | g/kg | 200 | 60 | 250 | 55.4 |

1. A method for pressure-driven liquid separation, the method comprising:
a. receiving, by a sweep reverse osmosis (SRO) system, a system level feed solution to a feed side of the SRO system and a system level sweep solution to a sweep side of the SRO system;
b. receiving, by the semi-permeable membrane, a pass level feed solution from the system level feed solution to a first side of the semi-permeable membrane, wherein the pass level feed solution has a first osmotic pressure;
c. receiving, by the semi-permeable membrane, a pass level sweep solution from the system level sweep solution to a second side of the semi-permeable membrane, wherein the pass level sweep solution has a second osmotic pressure;
d. exerting, by a pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level and feed level solution, wherein the pressurizing unit includes at least one of an energy recovery device (ERD), a high pressure pump, a booster pump, a piston, an hydraulic fluid and pneumatic fluid;
e. discharging, by the semipermeable membrane, a pass level concentrate solution from the first side of the semi-permeable membrane, on passing the permeate solution to the second side of the semipermeable membrane, wherein the discharged pass level concentrate solution acts as the pass level feed solution to any subsequent pass until a system level concentrate solution is generated;
f. discharging, by the semipermeable membrane, a pass level diluate solution from the second side of the semi-permeable membrane, on receiving the permeate solution from the first side of the semi permeable membrane, wherein the discharged pass level diluate solution acts as the pass level sweep solution to any subsequent pass until a system level diluate solution is generated;
g. removing, by the SRO system, the system level concentrate solution and the system level diluate solution; and
h. repeating by the SRO system steps (a-g) to continue with subsequent operation cycles.

2. The method as claimed in claim 1, wherein the feed side solution flows across the first side of the semipermeable membrane and the sweep side solution flows across the second side of the semipermeable membrane such that they are counter current, co-current or cross-current to each other.

3. The method as claimed in claim 1, wherein an energy recovery device(s) recovers energy exerted by the pressurizing unit.

4. The method as claimed in claim 1, wherein the method further comprises a circulation loop of the feed side solution flow and a circulation loop of the sweep side solution flow are hydraulically connected to transfer at least one of the feed side solution to the sweep side and the sweep side solution to the feed side to retain a desired solution composition.

5. The method as claimed in claim 1, wherein the method comprises adding an external process solution to at least one of the feed side solution and the sweep side solution, wherein the external solution comprises a system level feed solution and a system level sweep solution.

6. The method as claimed in claim 4, wherein the method comprises adding the external process solution to at least one of the feed side solution and the sweep side solution, wherein the external solution comprises the system level feed solution and the system level sweep solution.

7. The method as claimed in claim 1, wherein receiving the system level feed solution to the feed side of the SRO system and the system level sweep solution to the sweep side of the SRO system comprises:
receiving, by at least one feed side tank, the system level feed solution and supplying the pass level feed solution to the first side of the semi-permeable membrane, wherein the at least one feed side tank is part of the feed side of the SRO system; and
receiving, by at least one sweep side tank, the system level sweep solution and supplying the pass level sweep solution to the second side of the semi-permeable membrane, wherein the at least one sweep side tank is part of the sweep side of the SRO system.

8. The method as claimed in claim 1, wherein exerting the pressure on the first side of the semipermeable membrane comprises:
actuating a piston on a feed side solution that is hydraulically connected to the first side of the semipermeable membrane;
applying pressure through a hydraulic fluid in a hydraulic chamber of the at least one feed side tank with the feed side solution in a feed chamber of the feed side tank, wherein the at least one feed side tank comprises at least two chambers separated by at least one movable partition;
actuating a piston on the feed side solution present in one of a chamber of the feed side tank, wherein the feed side tank comprises at least two chambers separated by at least one movable partition;
applying pressure through a hydraulic fluid in direct hydraulic contact with the feed side solution in the at least one feed side tank;
applying pressure directly on the feed side solution by filling the at least one feed side tank completely with the feed side solution; and
applying pressure through the high-pressure pump, the ERD and the booster pump when using an unpressurized tank with at least one chamber and an unpressurized tank with at least one movable partition with at least two chambers.

9. The method as claimed in claim 1, wherein receiving the system level feed solution to the feed side of the SRO system and the system level sweep solution to the sweep side of the SRO system, comprises:
receiving a system level feed solution in at least one feed side holding chamber and supplying a pass level feed solution from the at least one feed side holding chamber to a feed side circulation loop;
receiving a system level sweep solution in at least one sweep side holding chamber and supplying pass level sweep solution from the at least one sweep side holding chamber to a sweep side circulation loop;
exerting, by the pressurizing unit, a pressure on the pass level feed solution on first side of the semipermeable membrane such that, the permeate solution from the pass level feed solution passes from the first side of the semipermeable membrane to the second side of the semipermeable membrane, wherein the permeate solution has a different osmotic pressure than the pass level feed solution;
discharging, by the semipermeable membrane, the pass level concentrate solution from the first side of the semi-permeable membrane, on passing the permeate solution to the second side of the semipermeable membrane, wherein the discharged pass level concentrate solution acts as the pass level feed solution to a subsequent pass until the system level concentrate solution is generated;
discharging, by the semipermeable membrane, the pass level diluate solution from second side of the semi-permeable membrane, on receiving the permeate solution from the first side of the semi permeable membrane, wherein the discharged pass level diluate solution acts as the pass level sweep solution to a subsequent pass until the system level diluate solution is generated;
adding an external process solution to the feed side circulation loop and removing a diluate solution from the sweep side circulation loop to maintain a required pressure in the feed side circulation loop and the sweep side circulation loop;
supplying the system level feed solution to the at least one feed side holding chamber for a next operation cycle while simultaneously displacing the system level concentrate solution of a previous operation cycle from the at least one feed holding chamber to an external sink;
supplying the system level sweep solution to the at least one sweep side holding chamber for the next operation cycle while simultaneously displacing the system level diluate solution of the previous operation cycle from the at least one sweep side holding chamber to the external sink;
initiating a solution change over sequence on a feed side circulation loop by hydraulically connecting at least one feed side holding chamber and the feed side circulation loop, when the pass level concentrate solution in the feed side circulation loop reaches concentration of the system level concentrate solution;
transporting the system level concentrate solution from the feed side circulation loop into the at least one feed side holding chamber thereby displacing the system level feed solution from the at least one feed side holding chamber to the feed side circulation loop, while achieving separation in a corresponding SRO unit during the entire solution change over sequence, wherein the SRO unit includes the semipermeable membrane;
hydraulically disconnecting the at least one feed side holding chamber from the feed side circulation loop and initiating a next semi batch process;
initiating a solution change over sequence on the sweep side circulation loop by hydraulically connecting the at least one sweep side holding chamber and the sweep side circulation loop, when the pass level diluate solution in the sweep side circulation loop reaches concentration of the system level diluate solution;
transporting the system level diluate solution from the sweep side circulation loop into the at least one sweep side holding chamber thereby displacing the system level sweep solution from the at least one sweep side holding chamber to the circulation loop, while achieving separation in the SRO unit during the entire solution change over sequence; and
hydraulically disconnecting the at least one sweep side holding chamber from the sweep side circulation loop and initiating the next semi batch process.

10. The method as claimed in claim 1, wherein receiving the system level feed solution to the feed side of the SRO system and the system level sweep solution to the sweep side of the SRO system comprises:
receiving by at least one feed side tank the system level feed solution and supplying the pass level feed solution to the first side of the semi-permeable membrane, wherein the at least one feed side tank is part of the feed side of the SRO system;
receiving the system level sweep solution in at least one sweep side holding chamber and supplying pass level sweep solution from the at least one sweep side holding chamber to the sweep side circulation loop;
exerting, by the pressurizing unit, a pressure on the pass level feed solution on the first side of the semipermeable membrane such that, the permeate solution from the pass level feed solution passes from the first side of the semipermeable membrane to the second side of the semipermeable membrane, wherein the permeate solution has a different osmotic pressure than the pass level feed solution;
discharging, by the semipermeable membrane, a pass level concentrate solution from the first side of the semi-permeable membrane, on passing the permeate solution to the second side of the semipermeable membrane, wherein the discharged pass level concentrate solution acts as the pass level feed solution in a subsequent pass until a system level concentrate solution is generated;
discharging, by the semipermeable membrane, a pass level diluate solution from second side of the semi-permeable membrane, on receiving the permeate solution from the first side of the semi permeable membrane, wherein the discharged pass level diluate solution acts as the pass level sweep solution in a subsequent pass until a system level diluate solution is generated;
removing diluate solution from the sweep side circulation loop to maintain a required pressure in the sweep side circulation loop;
supplying the system level sweep solution to the at least one sweep side holding chamber for the next operation cycle while simultaneously displacing the system level diluate solution of the previous operation cycle from the at least one sweep side holding chamber to an external sink;
initiating a solution change over sequence on the sweep side circulation loop by hydraulically connecting the at least one sweep side holding chamber and the sweep side circulation loop, when the pass level diluate solution in the sweep side circulation loop reaches concentration of the system level diluate solution;
transporting the system level diluate solution from the sweep side circulation loop into the at least one sweep side holding chamber thereby displacing the system level sweep solution from the at least one sweep side holding chamber to the circulation loop, while achieving separation in the SRO unit during the entire solution change over sequence; and
hydraulically disconnecting the at least one sweep side holding chamber from the sweep side circulation loop and initiating a next semi batch process.

11. The method as claimed in claim 1, wherein receiving the system level feed solution to the feed side of the SRO system and the system level sweep solution to the sweep side of the SRO system comprises:
receiving the system level feed solution in the at least one feed side holding chamber and supplying pass level feed solution from the at least one feed side holding chamber to the feed side circulation loop;
receiving by at least one sweep side tank the system level sweep solution and supplying the pass level sweep solution to the second side of semi-permeable membrane, wherein the at least one sweep side tank is part of the sweep side of the SRO system;
exerting, by the pressurizing unit, a pressure on the pass level feed solution on first side of the semipermeable membrane such that, the permeate solution from the pass level feed solution passes from the first side of the semipermeable membrane to the second side of the semipermeable membrane, wherein the permeate solution has a different osmotic pressure than the pass level feed solution;
discharging the pass level concentrate solution from the first side of the semi-permeable membrane on passing the permeate solution to the second side of the semipermeable membrane, wherein the discharged pass level concentrate solution acts as the pass level feed solution in a subsequent pass until the system level concentrate solution is generated;
discharging the pass level diluate solution from second side of the semi-permeable membrane on receiving the permeate solution from the first side of the semi permeable membrane, wherein the discharged pass level diluate solution acts as the pass level sweep solution in a subsequent pass until the system level diluate solution is generated;
adding an external process solution to the feed side circulation loop to maintain a required pressure in the feed side circulation loop;
supplying the system level feed solution to the at least one feed side holding chamber for the next operation cycle while simultaneously displacing the system level concentrate solution of a previous operation cycle from the at least one feed side holding chamber to an external sink;
initiating a solution change over sequence on the feed side circulation loop by hydraulically connecting at least one feed side holding chamber and the feed side circulation loop, when the pass level concentrate solution in the feed side circulation loop reaches concentration of the system level concentrate solution;
transporting the system level concentrate solution from the feed side circulation loop into the at least one feed side holding chamber thereby displacing the system level feed solution from the at least one feed side holding tank to the feed side circulation loop, while achieving separation in the SRO unit during the entire solution change over sequence; and
hydraulically disconnecting the at least one feed side holding chamber from the feed side circulation loop and initiating the next semi batch process.

12. The method as claimed in claim 1, wherein receiving the system level feed solution to the feed side of the SRO system and the system level sweep solution to the sweep side of the SRO system comprises:
receiving by at least one feed side tank the system level feed solution and supplying the pass level feed solution to the first side of semi-permeable membrane, wherein the at least one feed tank is part of the feed side of the SRO system;
receiving a system level sweep solution from an external source and supplying the pass level sweep solution to the sweep side circulation loop;
exerting, by a pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution;
discharging, by the semipermeable membrane, a pass level concentrate solution from the first side of the semi-permeable membrane on passing the permeate solution to the second side of the semipermeable membrane, wherein the discharged pass level concentrate solution acts as the pass level feed solution to a subsequent pass until a system level concentrate solution is generated;
discharging, by the semipermeable membrane, a pass level diluate solution from second side of the semi-permeable membrane on receiving the permeate solution from the first side of the semi permeable membrane, wherein the discharged pass level diluate solution acts as the pass level sweep solution to a subsequent pass until a system level diluate solution is generated; and
discharging a portion of the pass level diluate as the system level diluate to an external sink.

13. The method as claimed in claim 1, wherein receiving the system level feed solution to the feed side of the SRO system and the system level sweep solution to the sweep side of the SRO system comprises:
receiving the system level feed solution from the external source and supplying the pass level feed solution to the feed side circulation loop;
receiving by at least one sweep tank the system level sweep solution and supplying the pass level sweep solution to the second side of semi-permeable membrane, wherein the at least one sweep tank is part of the sweep side of the SRO system;
exerting a pressure on the pass level feed solution on first side of the semipermeable membrane such that, the permeate solution from the pass level feed solution passes from the first side of the semipermeable membrane to the second side of the semipermeable membrane, wherein the permeate solution has a different osmotic pressure than the pass level feed solution;
discharging the pass level concentrate solution from the first side of the semi-permeable membrane on passing the permeate solution to the second side of the semipermeable membrane, wherein the discharged pass level concentrate solution acts as the pass level feed solution in a subsequent pass until the system level concentrate solution is generated;
discharging the pass level diluate solution from second side of the semi-permeable membrane on receiving the permeate solution from the first side of the semi permeable membrane, wherein the discharged pass level diluate solution acts as the pass level sweep solution in a subsequent pass until the system level diluate solution is generated; and
discharging a portion of the pass level concentrate as the system level concentrate to the external sink.

14. The method as claimed in claim 1, wherein receiving the system level feed solution to the feed side of the SRO system and the system level sweep solution to the sweep side of the SRO system comprises:
receiving a system level feed solution in at least one feed side holding chamber and supplying the pass level feed solution from the holding chamber to a feed side circulation loop;
receiving a system level sweep solution from the external source and supplying the pass level sweep solution to the sweep side circulation loop;
exerting, by a pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution;
discharging, by the semipermeable membrane, a pass level concentrate solution from the first side of the semi-permeable membrane on passing the permeate solution to the second side of the semipermeable membrane, wherein the discharged pass level concentrate solution acts as the pass level feed solution in a subsequent pass until a system level concentrate solution is generated;
discharging, by the semipermeable membrane, a pass level diluate solution from second side of the semi-permeable membrane on receiving the permeate solution from the first side of the semi permeable membrane, wherein the discharged pass level diluate solution acts as the pass level sweep solution in a subsequent pass until a system level diluate solution is generated;
adding an external process solution to the feed side circulation loop to maintain a required pressure in the feed side circulation loop and discharging a portion of the pass level diluate as the system level diluate to an external sink;
supplying the system level feed solution to the feed side holding chamber for a next operation cycle while simultaneously displacing the system level concentrate solution of a previous operation cycle from the holding chamber to the external sink;
initiating the solution change over sequence on feed side circulation loop by hydraulically connecting at least one feed side holding chamber and the feed side circulation loop, when the pass level concentration solution in the feed side circulation loop reaches concentration of the system level concentrate solution;
transporting the system level concentrate solution from the feed side circulation loop into the feed side holding chamber thereby displacing the system level feed solution from the holding chamber to the circulation loop, while achieving separation in the SRO unit during the entire solution change over sequence;
hydraulically disconnecting the holding chamber from the feed side circulation loop and initiating a next semi batch process; and
discharging a portion of the pass level diluate solution as the system level diluate to an external sink.

15. The method as claimed in claim 1, wherein receiving the system level feed solution to the feed side of the SRO system and the system level sweep solution to the sweep side of the SRO system comprises:
receiving the system level feed solution from the external source and supplying the pass level feed solution to the feed side circulation loop;
receiving a system level sweep solution in at least one sweep side holding chamber and supplying the pass level sweep solution from the holding chamber to the sweep side circulation loop;
exerting, by the pressurizing unit, a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution;
discharging, by the semipermeable membrane, a pass level concentrate solution from the first side of the semi-permeable membrane on passing the permeate solution to the second side of the semipermeable membrane, wherein the discharged pass level concentrate solution acts as the pass level feed solution in a subsequent pass until a system level concentrate solution is generated;
discharging, by the semipermeable membrane, a pass level diluate solution from second side of the semi-permeable membrane on receiving the permeate solution from the first side of the semi permeable membrane, wherein the discharged pass level diluate solution acts as the pass level sweep solution in a subsequent pass until a system level diluate solution is generated;
discharging a portion of the pass level concentrate as the system level concentrate to the external sink and removing diluate solution from the sweep side circulation loop to maintain a required pressure in the feed side circulation loop and the sweep side circulation loop;
supplying the system level sweep solution to the sweep side holding chamber for the next operation cycle while simultaneously displacing the system level diluate solution of the previous operation cycle from the sweep side holding chamber to the external sink;
initiating a solution change over sequence on sweep side circulation loop by hydraulically connecting at least one sweep side holding chamber and the sweep side circulation loop, when the pass level diluate solution in the sweep side circulation loop reaches concentration of the system level diluate solution;
transporting the system level diluate solution from the sweep side circulation loop into the sweep side holding chamber thereby displacing the system level sweep solution from the sweep side holding chamber to the circulation loop, while achieving separation in the SRO unit during the entire solution change over sequence; and
hydraulically disconnecting the sweep side holding chamber from the sweep side circulation loop and initiating a next semi batch process.

16. The method as claimed in of claim 1, wherein the method further comprises:
a. supplying a stage level concentrate solution from a first separation stage as a stage level sweep solution to a second separation stage, wherein each of the separation stage comprises the SRO system, wherein the feed side and the sweep side of the SRO system is operated by at least one of at least one tank, at least one holding chamber, an external source and an external sink;
b. supplying a stage level sweep solution to the first separation stage from an external source and discharging the stage level diluate solution from the first separation stage to an external sink;
c. supplying a stage level diluate solution from the second separation stage as a stage level feed solution to the first separation stage;
d. supplying a stage level concentrate solution from the second separation stage as a stage level sweep solution to the third separation stage;
e. supplying a stage level diluate solution from the third separation as a stage level feed solution to the second separation stage; and
f. repeating the steps (a-e) till n^{th} separation stage, wherein the stage level feed solution to the n^{th} separation stage is supplied from an external source and stage level concentrate solution from the n^{th} separation stage is discharged to the external sink.

17. The method as claimed in claim 16, wherein the first separation stage, second separation stage, third separation stage to n^{th} separation stage are arranged in an array.

18. The method as claimed in claim 16, wherein a plurality of separation stages are arranged in the array such that the process solution is transported from one side of the semi permeable membrane to another side of the semi permeable membrane through a direct hydraulic connection or through a residual solution carryover.

19.-20. (canceled)

21. The method as claimed in claim 1, wherein the method comprises:
a. receiving by the first separation stage the stage level diluate solution from the second separation stage and receiving a process solution from an external source by the first separation stage, wherein each of the separation stage comprises the SRO system, wherein the feed side and the sweep side of the SRO system is operated by at least one of at least one tank, at least one holding chamber, an external source and an external sink;
b. combining by the first separation stage the stage level diluate from the second separation stage and the process solution from the external source and using as a stage level feed solution and the stage level sweep solution for the first separation stage;
c. discharging the stage level diluate solution from the first separation stage to an external sink and stage level concentrate solution from the first separation stage to the second separation stage;
d. receiving by the second separation stage the stage level diluate solution from the third separation stage and the stage level concentrate solution from the first separation stage;
e. combining by the second separation stage the stage level diluate solution from the third separation stage and the stage level concentrate solution from the first separation stage and used as a stage level feed solution and the stage level sweep solution for the second separation stage;
f. discharging stage level concentrate solution and stage level diluate solution from the second separation stage;
g. receiving by the third separation stage a stage level concentrate solution of the second separation stage and stage level diluate solution from the fourth separation stage and combining and supplying as a stage level feed solution and stage level sweep solution for the third separation stage; and
h. discharging stage level concentrate solution and stage level diluate solution from the third separation stage;
i. repeating the steps (a-h), till the n^{th} separation stage, wherein at least one of a stage level concentrate solution from n−1 stage and process solution from the external source are released;
j. supplying one of the stage level concentrate solution from the n−1th separation stage and a combination of the stage level concentrate solution from the n−1 th separation stage and the process solution from the external source as a stage level feed solution and stage level sweep solution for the nth separation stage; and
k. discharging stage level concentrate solution from the n^{th} separation stage to an external sink and discharging the stage level diluate solution from the n^{th} separation stage to the n−1 separation stage.

22. The method as claimed in claim 21, wherein the first separation stage, second separation stage, third separation stage to nth separation stage are arranged in an array.

23. (canceled)

24. The method as claimed in claim 1, wherein the method comprises:
a. supplying a stage level concentrate solution from a first separation stage as a stage level feed solution to a second separation stage, wherein each of the separation stage comprises the at least one SRO system;
b. supplying a stage level feed solution to the first separation stage from an external source and discharging the stage level diluate solution from the first separation stage to an external sink, wherein each of the separation stage comprises at least one SRO system, wherein the feed side and the sweep side of the SRO system is operated by one of at least one tank, at least one holding chamber, an external source and an external sink;
c. supplying a stage level diluate solution from the second separation stage as a stage level sweep solution to the first separation stage;
d. supplying a stage level concentrate solution from the second separation stage as a stage level feed solution to the third separation stage;
e. supplying a stage level diluate solution from the third separation as a stage level sweep solution to the second separation stage; and
f. repeating the steps (a-e) till n^{th} separation stage, wherein the stage level concentrate solution from the n−1 separation stage is supplied as stage level feed solution to the n^{th} separation stage and either a portion of the feed solution to the n^{th} separation stage or a portion of the concentrate solution from the n^{th} separation stage or both are supplied as stage level sweep solution to the n^{th} separation stage; further a portion of the concentrate solution from the n^{th} separation stage is discharged to an external sink and the stage level diluate solution from the n^{th} separation stage is supplied as stage level sweep solution to n−1 separation stage.

25. The method as claimed in claim 24, wherein the first separation stage, second separation stage, third separation stage to n^{th} separation stage are arranged in an array.

26. The method as claimed in claim 24, wherein a plurality of separation stages are arranged in the array such that the process solution is transported from one side of the semi permeable membrane to another side of the semi permeable membrane through a direct hydraulic connection or through a residual solution carryover.

27.-28 (canceled)

29. A sweep reverse osmosis (SRO) system for pressure-driven liquid separation, the SRO system comprising:
a. a feed side and a sweep side configured to:
receive a system level feed solution to a feed side of the SRO system and a system level sweep solution to a sweep side of the SRO system;
b. a semi-permeable membrane configured to:
receive a pass level feed solution from the system level feed solution to a first side of the semi-permeable membrane, wherein the pass level feed has a first osmotic pressure; and
receive a pass level sweep solution from the system level sweep to a second side of the semi-permeable membrane, wherein the pass level sweep has a second osmotic pressure;
c. a pressurizing unit configured to:
exert a pressure on the pass level feed solution on first side of the semipermeable membrane such that, a permeate solution from the pass level feed solution passes from the first side of the semipermeable membrane to the second side of the semipermeable membrane, wherein the permeate solution has a different osmotic pressure than the pass level feed solution, wherein the pressurizing unit includes at least one of an energy recovery device (ERD), a high pressure pump, a booster pump, a piston, an hydraulic fluid and a pneumatic fluid;
d. the semi-permeable membrane unit configured to:
discharge a pass level concentrate solution from the first side of the semi-permeable membrane on passing the permeate solution to the second side of the semipermeable membrane, wherein the discharged pass level concentrate solution acts as the pass level feed solution to any of its subsequent pass level feed until a system level concentrate solution is generated;
discharge a pass level diluate solution from second side of the semi-permeable membrane on receiving the permeate solution from the first side of the semi permeable membrane, wherein the discharged pass level diluate solution acts as the pass level sweep solution to any of its subsequent pass level sweep until a system level diluate solution is generated;
e. a feed side circulation pump and a sweep side circulation pump configured to:
remove the system level concentrate solution and the system level diluate solution; and
f. the SRO system configured to:
repeat steps (a-f) to continue with subsequent operation cycles.

30. The SRO system of claim 29, wherein the system further comprises:
at least one feed side holding chamber hydraulically connected to first side of the semipermeable membrane, configured to:
establish intermittent hydraulic communication with the first side of the semi permeable membrane for exchanging process solution with a feed side circulation loop;
receive system level feed solution from an external source; and
discharge the system level concentrate solution to an external sink;
at least one sweep side holding chamber hydraulically connected to the second side of the semipermeable membrane, configured to:
establish intermittent hydraulic communication with second side of the semipermeable membrane for exchanging process solution with sweep side circulation loop;
receive system level sweep solution from an external source; and
discharge the system level diluate solution to an external sink.

31. (canceled)

32. The SRO system as claimed in claim 29, wherein the SRO system comprises:
at least one feed side tank hydraulically connected to the first side of the semipermeable membrane is configured to:
receive the system level feed side solution, to store the process solution, to supply the pass level feed side solution to the first side of the semi permeable membrane, to collect the pass level concentrate solution from the first side of the semi permeable membrane, to collect pass level sweep side solution and to collect pass level diluate solution;
at least one sweep side tank hydraulically connected to the second side semi permeable membrane configured to:
receive the system level sweep side solution, to store the process solution, to supply the pass level sweep side solution to the second side of the semi permeable membrane, to collect pass level diluate solution from the second side of the semi permeable membrane, to collect the pass level feed solution and to collect pass level concentrate solution;
at least one external source configured to supply a process solution to the at least one feed side tank, and at least one sweep side tank.

33. The SRO system as claimed in claim 29, wherein the at least one feed side tank and the at least one sweep side tank comprises at least one of:
an unpressurized tank;
a piston pressurized tank;
a piston pressurized tank with at least two chambers separated by at least one movable partition;
an indirect hydraulically pressurized tank with at least two chambers separated by at least one movable partition;
a direct hydraulically pressurized tank;
a direct feed pressurized tank; and
an unpressurized tank with at least two chambers separated by at least one movable partition.

34. The SRO system as claimed in claim 29, wherein the system comprises:
at least one feed side tank hydraulically connected to the first side of the semi permeable membrane configured to:
receive the system level feed side solution, to store the process solution, to supply the pass level feed side solution to the first side of the semi permeable membrane, to collect the pass level concentrate solution from the first side of the semi permeable membrane, to collect pass level sweep side solution and to collect pass level diluate solution;
at least one sweep side holding chamber hydraulically connected to the second side of the semi permeable membrane configured to:
establish intermittent hydraulic communication with second side of the semipermeable membrane for exchanging process solution with sweep side circulation loop;
receive system level sweep solution from an external source;
discharge the system level diluate solution to an external sink; and
at least one external source configured to supply a process solution to the at least one feed side tank, at least one sweep side holding chamber and sweep side circulation loop.

35. The SRO system as claimed in claim 29, wherein the system comprises:
at least one feed side holding chamber hydraulically connected to first side of the semipermeable membrane, configured to:
establish intermittent hydraulic communication with the first side of the semi permeable membrane for exchanging process solution with a feed side circulation loop;
receive system level feed solution from an external source; and
discharge the system level concentrate solution to an external sink;
at least one sweep side tank hydraulically connected to the second side of semi permeable membrane configured to:
receive the system level sweep side solution, to store the process solution, to supply the pass level sweep side solution to the second side of the semi permeable membrane, to collect pass level diluate solution from the second side of the semi permeable membrane, to collect the pass level feed side solution and to collect pass level concentrate solution;
at least one external source configured to supply the process solution to the at least one feed side holding chamber, the feed side circulation loop and the at least one sweep side tank.

36. The SRO system as claimed in claim 29, wherein the system comprises:
at least one feed side tank hydraulically connected to the first side of the semi permeable membrane configured to: receive the system level feed side solution, to store the process solution, to supply the pass level feed side solution to the first side of the semi permeable membrane, to collect the pass level concentrate solution from the first side of the semi permeable membrane, to collect pass level sweep side solution and to collect pass level diluate solution;
at least one external source hydraulically connected to the second side of the semi permeable membrane configured to, supply system level sweep solution;
at least one external sink hydraulically connected to the second side of the semi permeable membrane configured to, remove the system level diluate solution; and
at least one external source configured to, supply the process solution to the at least one feed side tank and the sweep side circulation loop.

37. The SRO system as claimed in claim 29, wherein the system further comprises:
at least one external source hydraulically connected to the first side of the semi permeable membrane configured for, supplying the system level feed solution;
at least one external sink hydraulically connected to first side of the semi permeable membrane configured for, removing the system level concentrate solution;
at least one sweep side tank hydraulically connected to the second side semi permeable membrane configured to:
receive the system level sweep side solution, to store the process solution, to supply the pass level sweep side solution to the second side of the semi permeable membrane, to collect pass level diluate solution from the second side of the semi permeable membrane, to collect the feed side solution and to collect pass level concentrate solution; and
at least one external source configured to supply the process solution to the feed side circulation loop and the at least one sweep side tank.

38. The SRO system as claimed in claim 29, wherein the system further comprises:
at least one feed side holding chamber hydraulically connected to the first side of the semipermeable membrane, configured to:
establish intermittent hydraulic communication with the first side of the semi permeable membrane for exchanging process solution with a feed side circulation loop;
receive system level feed solution from an external source; and
discharge the system level concentrate solution to an external sink;
at least one external source hydraulically connected to the second side of the semipermeable membrane for supplying system level sweep solution;
at least one external sink hydraulically connected to the second side of the semipermeable membrane for removing system level diluate solution; and
at least one external source configured to supply the process solution to the at least one feed side holding chamber, the feed side circulation loop and the sweep side circulation loop.

39. The SRO system as claimed in claim 29, wherein the system comprises:
at least one external source hydraulically connected to the first side of the semipermeable membrane for supplying system level feed solution;
at least one external sink hydraulically connected to the first side of the semipermeable membrane for removing system level concentrate solution;
at least one sweep side holding chamber hydraulically connected to the second side of the semi permeable membrane configured to:
establish intermittent hydraulic communication with second side of the semipermeable membrane for exchanging process solution with sweep side circulation loop;
receive system level sweep solution from an external source;
discharge the system level diluate solution to an external sink; and
at least one external source configured to supply the process solution to the feed side circulation loop, the at least one sweep side holding chamber and the sweep side circulation loop.

40. The SRO system as claimed in claim 33, wherein the unpressurized tank with the at least two chambers separated by the at least one movable partition, is configured to:
supply from one of the at least two chambers the at least one of the pass level feed solution and the pass level sweep solution to the first side of the semipermeable membrane and the second side of the semipermeable membrane respectively; and
collect at least one of the pass level concentrate solution and the pass level diluate solution from the first side of the semipermeable membrane and the second side of the semipermeable membrane respectively in one of the at least two chambers.

41. (canceled)

42. The SRO system as claimed in claim 33, wherein the indirect hydraulically pressurized tank with the at least two chambers separated by the at least one movable partition, configured to:
supply from one of the at least two chamber the pass level feed solution to the first side of the semi permeable membrane; and
collect the pass level concentrate solution from the first side of the semi permeable membrane in one of the at least two chambers.

43.-59. (canceled)
